(19) United States
(12) Patent Application Publication
(10) Pub. No.: US 2026/0110574 A1
(43) Pub. Date: Apr. 23, 2026

(54) PHOTONIC COMPUTING

(71) Applicant: Artilux, Inc., Menlo Park, CA (US)

(72) Inventors: Neil Y. Na, San Jose, CA (US); Andrew I. Shieh, Taipei (TW); Chung-Chih Lin, Hsinchu County (TW); Yen-Cheng Lu, Hsinchu County (TW)

(21) Appl. No.: 19/340,203

(22) Filed: Sep. 25, 2025

Related U.S. Application Data
(62) Division of application No. 19/238,278, filed on Jun. 13, 2025.
Application No. 19/238,278 is a division of application No. 19/201,182, filed on May 7, 2025.
(60) Provisional application No. 63/645,968, filed on May 13, 2024.
(60) Provisional application No. 63/648,719, filed on May 17, 2024.
(60) Provisional application No. 63/650,908, filed on May 22, 2024.
(60) Provisional application No. 63/710,030, filed on Oct. 22, 2024.

(51) Int. Cl. G01J 1/44; G06E 1/00

(52) U.S. Cl. CPC G01J 1/44; G06E 1/00; G01J 2001/4473

(57) ABSTRACT

Methods, circuits, devices, systems and techniques for photonic computing are provided. In one aspect, a photonic system includes a plurality of photodetectors and a control circuitry coupled to the plurality of photodetectors. The plurality of photodetectors are configured to detect at least one modulated optical signal, the at least one modulated optical signal representing one or more input elements of an input matrix of a mathematical function, the plurality of photodetectors being configured to be modulated based on weight elements of a weight matrix of the mathematical function. The control circuitry is configured to generate electrical outputs based on outputs of the plurality of photodetectors, the electrical outputs representing a computation result of the mathematical function corresponding to a multiplication of the input matrix and the weight matrix.

### CROSS-REFERENCE TO RELATED APPLICATIONS

This is a divisional application of U.S. application Ser. No. 19/238,278, filed on Jun. 13, 2025, which is a divisional application of U.S. application Ser. No. 19/201,182, filed on May 7, 2025, which claims the benefit of U.S. Provisional Application No. 63/645,968, filed May 13, 2024, U.S. Provisional Application No. 63/648,719, filed May 17, 2024, U.S. Provisional Application No. 63/650,908, filed May 22, 2024, and U.S. Provisional Application No. 63/710,030, filed Oct. 22, 2024. The disclosures of the prior applications are considered part of and are incorporated by reference in the disclosure of this application.

### TECHNICAL FIELD

The present disclosure is directed to photonic computing.

### BACKGROUND

A neural network is a computational model designed to recognize patterns and solve complex problems by learning from data, and can be used in applications such as artificial intelligence, image processing, natural language process, and many more. Neural network computation relies on matrix operations to process data through layers of interconnected nodes. In electronic systems, these operations are executed using transistors and memory units, which can lead to bottlenecks due to heat generation, power consumption, and bandwidth limitation.

### SUMMARY

The present disclosure describes methods, circuits, devices, systems and techniques for photonic computing, e.g., photonically implementing mathematical operations in neural networks.

One aspect of the present disclosure features a method for performing computations using a photonic system, the method including: modulating at least one input optical signal with input information associated with an input matrix of a mathematical function to generate at least one modulated input optical signal each having an optical intensity corresponding to an input element of the input matrix; generating first modulated optical signals based on each of the at least one the modulated input optical signal; modulating the first modulated optical signals with respective weight information associated with a weight matrix of the mathematical function to generate second modulated optical signals; detecting each of the second modulated optical signals by a corresponding photodetector of a plurality of photodetectors; and generating, by a control circuitry, electrical outputs based on outputs of the plurality of photodetectors, the electrical outputs representing a computation result of the mathematical function corresponding to a multiplication of the input matrix and the weight matrix, where an activation function of the mathematical function is implemented by at least one of the control circuitry or the plurality of photodetectors.

In some implementations, the input matrix includes an N-by-1 input matrix, the weight matrix includes an M-by-N weight matrix, and the computation result includes an M-by-1 matrix, where each of M and N is an integer.

In some implementations, the plurality of photodetectors include M photodetectors, the first modulated optical signals include M first modulated optical signals, and the second modulated optical signals include M second modulated optical signals. The method includes: during each of N time periods, modulating the at least one input optical signal with a respective intensity corresponding to a respective element of N elements in the N-by-1 input matrix, modulating the M first modulated optical signals based on a respective group of M weights in the M-by-N weight matrix corresponding to the respective element to generate the M second modulated optical signals, and accumulating a respective result by each of the M photodetectors detecting a respective second modulated optical signal of the M second modulated optical signals, the respective result corresponding to a multiplication of the respective element and a corresponding weight of the respective group of M weights; and generating a respective output by each of the M photodetectors representing a sum of N respective results over the N time periods.

In some implementations, the mathematical function further includes an M-by-1 bias matrix, and where the method further includes: during an additional time period different from the N time periods, modulating the input optical signal with an intensity corresponding to a normalized value of 1, modulating the M first modulated optical signals respectively based on M bias values of the M-by-1 bias matrix, and accumulating a respective bias result by each of the M photodetectors detecting a corresponding second modulated optical signal, the respective bias result corresponding to a multiplication of the value of 1 and a corresponding bias value of the M bias values, where the respective output by each of the M photodetectors represents a sum of the N respective results over the N time periods and the respective bias result for the additional time period.

In some implementations, generating the electrical outputs based on the outputs of the plurality of photodetectors using the control circuitry includes: generating each of the electrical outputs based on the respective output of a corresponding photodetector of the M photodetectors, the electrical output corresponding to an element of the computation result α(Σⱼ₌₁^{N} Wᵢ(j)I(j)+bᵢ), where α represents the activation function of the mathematical function, Wᵢ(j) represents a weight element Wᵢⱼ in the M-by-N weight matrix, I(j) represents a jth element in the N-by-1 input matrix, bᵢ represents a bias value in the M-by-1 bias matrix, where i is an integer in a range from 1 to M, and j is an integer in a range from 1 to N.

In some implementations, the at least one input optical signal includes N input optical signals, where modulating the at least one input optical signal with the input information associated with the input matrix of the mathematical function to generate the at least one modulated input optical signal includes: modulating each of the N input optical signals to have a respective intensity based on a respective element of N elements in the N-by-1 input matrix to generate a respective modulated input optical signal of N modulated input optical signals, generating N groups of M first modulated optical signals using the N modulated input optical signals, and for each group of the N groups of M first modulated optical signals, modulating the respective M first modulated optical signals based on a respective group of M weights in the M-by-N weight matrix to generate a respective group of M second modulated optical signals.

In some implementations, the plurality of photodetectors includes N×M photodetectors, and generating the electrical outputs includes: for each of M groups, adding outputs of corresponding N photodetectors of the N×M photodetectors to generate M electrical outputs representing the multiplication of the input matrix and the weight matrix.

In some implementations, the plurality of photodetectors includes M photodetectors, and the method includes: detecting, by each of the M photodetectors, a respective second modulated optical signal from each of N groups of M second modulated optical signals to generate a respective result, the respective result corresponding to a multiplication of a corresponding element of the N elements in the N-by-1 input matrix and a corresponding weight in the M-by-N weight matrix; and generating a respective output by each of the M photodetectors by accumulating a sum of N respective results based on N respective second modulated optical signals from the N groups of M second modulated optical signals.

In some implementations, the mathematical function further includes an M-by-1 bias matrix, and the respective intensity corresponds to a normalized value in a range from 0 to 1. The at least one input optical signal includes an additional input optical signal different from the N input optical signals, and the method further includes: modulating the additional input optical signal with an intensity corresponding to a value of 1, generating additional M first modulated optical signals based on the additional input optical signal, modulating the additional M first modulated optical signals respectively based on M bias values in the M-by-1 bias matrix to generation additional M second modulated optical signals, and generating a respective bias result by a corresponding photodetector of the M photodetectors detecting a corresponding additional second modulated optical signal, the respective bias result corresponding to a multiplication of the value of 1 and a corresponding bias value of the M bias values. The respective output is generated by each of the M photodetectors by accumulating the respective bias result, together with the N respective results.

In some implementations, each of the N input optical signals has a respective wavelength, at least two of respective wavelengths of the N input optical signals being different.

In some implementations, each of the N input optical signals has a same wavelength.

In some implementations, the at least one modulated input optical signal includes a first modulated input optical signal and a second modulated input optical signal, and the plurality of photodetectors include a plurality of balanced photodetectors. The method includes: generating a first plurality of first modulated optical signals based on the first modulated input optical signal, modulating the first plurality of first modulated optical signals with the respective weight information associated with the weight matrix of the mathematical function to generate a first plurality of second modulated optical signals as positive modulated optical signals; generating a second plurality of first modulated optical signals based on the second modulated input optical signal, modulating the second plurality of first modulated optical signals with the respective weight information associated with the weight matrix of the mathematical function to generate a second plurality of second modulated optical signals as negative modulated optical signals, a number of the positive modulated optical signals being identical to a number of the negative modulated optical signals; detecting, by each of the plurality of balanced photodetectors, (i) a corresponding positive modulated optical signal of the positive modulated optical signals and (ii) a corresponding negative modulated optical signal of the negative modulated optical signals; and generating the electrical outputs based on outputs of the plurality of balanced photodetectors.

In some implementations, the method further includes: generating, by a variable optical splitter, the first modulated input optical signal and the second modulated input optical signal based on an initial input optical signal and the input information associated with the input matrix, where the first modulated input optical signal has a first intensity, and the second modulated input optical signal has a second intensity, and where the first intensity and the second intensity are determined based on the input information.

In some implementations, the method further includes: modulating, by a first optical modulator, a first input optical signal with first input information to generate the first modulated input optical signal with a first intensity; and modulating, by a second optical modulator, a second input optical signal with second input information to generate the first modulated input optical signal with a second intensity, where the first input information and the second input information are determined based on the input information associated with the input matrix.

In some implementations, the first intensity represents a first normalized value in a range from 0 to 1, the second intensity represents a second normalized value in the range from 0 to 1, and a difference between the first intensity and the second intensity corresponds to a third normalized value in a range from −1 to 1.

In some implementations, each of the plurality of photodetectors includes a nonlinear phototransistor configured based on the activation function of the mathematical function, and the control circuitry is configured to generate the electrical outputs based on the outputs of the plurality of photodetectors.

In some implementations, each of the plurality of photodetectors includes a photodiode configured to have a linear photon-response, and the control circuitry is configured to generate the electrical outputs based on the outputs of the plurality of photodetectors and the activation function of the mathematical function.

In some implementations, the control circuitry is configured to store the input information associated with the input matrix and the weight information associated with the weight matrix.

In some implementations, the method includes: performing a first computation of the mathematic function between a first layer and a second layer of a neural network using the photonic system, where the first layer is represented by the input matrix, and the second layer is represented by the computation result; and performing a second computation of a second mathematical function between the second layer and a third layer of the neural network using the photonic system, where performing the second computation includes: modulating the at least one input optical signal with second input information that is generated based on the computation result, where the first layer, the second layer, and the third layer are sequential to one another in the neural network.

Another aspect of the present disclosure features a photonic system for computation configured to perform the method according to any one of the implementations as disclosed above.

Another aspect of the present disclosure features a photonic system for computation, including: a first intensity modulator configured to modulate a first input optical signal with first input information associated with an input matrix of a mathematical function to generate a first modulated input optical signal; a first optical splitter coupled to the first intensity modulator and configured to generate first modulated optical signals based on the first modulated input optical signal; a plurality of first weight modulators coupled to the first optical splitter, where each of the plurality of first weight modulators is configured to modulate a respective first modulated optical signal of the first modulated optical signals with respective weight information associated with a weight matrix of the mathematical function to generate a respective second modulated optical signal of second modulated optical signals; a plurality of photodetectors, where each of the plurality of photodetectors is coupled to a respective first weight modulator of the plurality of first weight modulators and configured to detect a corresponding second modulated optical signal from the respective first weight modulator; and a control circuitry coupled to the plurality of photodetectors and configured to generate electrical outputs based on outputs of the plurality of photodetectors, the electrical outputs representing a computation result of the mathematical function corresponding to a multiplication of the input matrix and the weight matrix, where an activation function of the mathematical function is implemented by at least one of the control circuitry or the plurality of photodetectors.

In some implementations, each of the plurality of photodetectors includes a nonlinear phototransistor configured based on the activation function of the mathematical function, and the control circuitry is configured to generate the electrical outputs based on the outputs of the plurality of photodetectors.

In some implementations, the control circuitry is configured to store the input information associated with the input matrix and the weight information associated with the weight matrix, where the first intensity modulator is coupled to the control circuitry and configured to receive the input information associated with the input matrix from the control circuitry, and where each of the plurality of first weight modulators is coupled to the control circuitry and configured to receive the respective weight information associated with the weight matrix from the control circuitry.

In some implementations, the mathematical function further includes a bias matrix, and the control circuitry is configured to store bias information of the bias matrix, where the first input information corresponds to a normalized value in a range from 0 to 1, and where the first intensity modulator is configured to modulate the first input optical signal having an intensity corresponding to a value of 1, each of the plurality of first weight modulators is configured to modulate a corresponding first modulated optical signal based on corresponding bias information of a corresponding bias value in the bias matrix from the control circuitry, and each of the plurality of photodetectors is configured to generate a respective bias result by detecting a second modulated optical signal from the respective first weight modulator, the respective bias result corresponding to a multiplication of the value of 1 and the corresponding bias value.

In some implementations, the input matrix includes an N-by-1 input matrix, the weight matrix includes an M-by-N weight matrix, the bias matrix includes an M-by-1 bias matrix, and the computation result includes an M-by-1 matrix, where each of M and N is an integer, and each of the electrical outputs is generated based on a respective output of a corresponding photodetector of the plurality of photodetectors, the electrical output corresponding to an element of the computation result

$$α ( {Σ}_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, b(i) represents a bias value in the M-by-1 bias matrix, where i is an integer in a range from 1 to M, and j is an integer in a range from 1 to N.

In some implementations, the first intensity modulator, the first optical splitter, the plurality of first weight modulators form a photonic sub-system, and the photonic system includes a plurality of photonic sub-systems including the photonic sub-system, and each of the plurality of photonic sub-systems is coupled to the control circuitry and configured to perform respective operations based on a corresponding first input optical signal of a plurality of first input optical signals.

In some implementations, the input matrix includes an N-by-1 input matrix, the weight matrix includes an M-by-N weight matrix, the mathematical function includes an M-by-1 bias matrix, the plurality of photonic sub-systems includes (N+1) subsystems, and the computation result includes an M-by-1 matrix, where each of M and N is an integer. Each of the electrical outputs is based on (N+1) second modulated optical signals respectively from the (N+1) subsystems, each electrical output corresponding to an element of the computation result

$$α ( {Σ}_{j = 1}^{N} {W}_{i} ( j ) I ( j ) + {b}_{i} ) ,$$

where α represents the nonlinearity of the mathematical function, Wᵢ(j) represents a weight element Wᵢⱼ in the M-by-N weight matrix, I(j) represents a jth element in the N-by-1 input matrix, b(i) represents a bias value in the M-by-1 bias matrix, where i is an integer in a range from 1 to M, and j is an integer in a range from 1 to N.

In some implementations, the plurality of photodetectors include M photodetectors, each of the M photodetectors being coupled to a respective first optical modulator from each of the (N+1) subsystems and configured to detect a corresponding second modulated optical signal from the respective first optical modulator to generate a corresponding output, and to accumulate corresponding outputs of respective first optical modulators from the (N+1) subsystems.

In some implementations, the photonic system further includes: a second intensity modulator configured to modulate a second input optical signal with second input information associated with the input matrix of the mathematical function to generate a second modulated input optical signal.

In some implementations, the first intensity modulator includes a variable optical splitter configured to generate, based on the first input optical signal, the first modulated input optical signal representing first input information and a second modulated input optical signal representing second input information, and the first input information and the second input information are associated with a corresponding element of the input matrix of the mathematical function.

In some implementations, the photonic system further includes: a second optical splitter configured to receive the second modulated input optical signal and to generate third modulated optical signals based on the second modulated input optical signal; and a plurality of second weight modulators coupled to the second optical splitter, where each of the plurality of second weight modulators is configured to modulate a respective third modulated optical signal of the third modulated optical signals with the respective weight information associated with the weight matrix of the mathematical function to generate a respective fourth modulated optical signal of fourth modulated optical signals, where each of the plurality of photodetectors is coupled to a respective second weight modulator of the plurality of second weight modulators and configured to detect a corresponding fourth modulated optical signal from the respective second weight modulator, and where each of the plurality of photodetectors includes a balanced photodetector, and the corresponding second modulated optical signal is detected as a positive modulated optical signal by a positive portion of the balanced photodetector, and the corresponding fourth modulated optical signal is detected as a negative modulated optical signal by a negative portion of the balanced photodetector.

In some implementations, the balanced photodetector includes a nonlinear phototransistor configured based on the activation function of the mathematical function, and the control circuitry is configured to generate the electrical outputs based on the outputs of the plurality of photodetectors.

In some implementations, the balanced photodetector includes a photodiode configured to have a linear photon-response, and the control circuitry is configured to generate the electrical outputs based on the outputs of the plurality of photodetectors and the activation function of the mathematical function.

In some implementations, at least part of the photonic system is integrated in a photonic chip, and the control circuitry is integrated in an electrical chip, and the photonic chip and the electrical chip are integrated in a chip package.

In some implementations, at least one of the first intensity modulator, the first optical splitter, the plurality of first weight modulators, or the plurality of photodetectors is integrated in the photonic chip.

In some implementations, at least one of the first intensity modulator, the first optical splitter, the plurality of first weight modulators, or the plurality of photodetectors includes an optical waveguide structure integrated in the photonic chip.

Another aspect of the present disclosure features a method for performing computations using a photonic system. The method includes: receiving, by a first intensity modulator, an input optical signal; modulating, by the first intensity modulator and based on an N-by-1 input matrix of a mathematical function, the input optical signal to generate a first modulated optical signal, the first modulated optical signal being configured to represent one of N input elements in the N-by-1 input matrix or a reference bias; splitting, by an optical splitter, the first modulated optical signal to at least M first split modulated optical signals for M optical pathways; for each of the M optical pathways: modulating, by a respective first weight modulator and based on at least one of a respective 1-by-N weight matrix of an M-by-N weight matrix of the mathematical function or a respective bias element of an M-by-1 bias matrix of the mathematical function, a corresponding one of the M first split modulated optical signals to generate a respective second modulated optical signal configured to represent at least one of a weight element of the respective 1-by-N weight matrix or the respective bias element; and detecting, by a respective nonlinear phototransistor, the respective second modulated optical signal; and generating, by respective nonlinear phototransistors for the M optical pathways, electrical outputs representing a computation output of the mathematical function applied to a sum of (i) a multiplication between the M-by-N weight matrix and the N-by-1 input matrix and (ii) the M-by-1 bias matrix.

In some implementations, the first modulated optical signal is generated to represent each of the N input elements and the reference bias in a respective time period of multiple time periods.

In some implementations, the N input elements and the reference bias are represented by a plurality of first modulated optical signals.

Another aspect of the present disclosure features a method for performing computations using a photonic system. The method includes: receiving, by a variable optical splitter, an input optical signal; modulating, by the variable optical splitter and based on an N-by-1 input matrix of a mathematical function, the input optical signal to generate a first modulated optical signal and a second modulated optical signal, each of the first modulated optical signal and the second modulated optical signal being configured to represent one of N input elements of the N-by-1 input matrix or a reference bias; splitting, by a first optical splitter, the first modulated optical signal to at least M first split modulated optical signals corresponding to M first optical pathways; splitting, by a second optical splitter, the second modulated optical signal to at least M second split modulated optical signals corresponding to M second optical pathways; for each of the M first optical pathways: modulating, by a respective first weight modulator and based on a respective 1-by-N weight matrix of an M-by-N weight matrix of the mathematical function or a respective bias element of an M-by-1 bias matrix of the mathematical function, a corresponding one of the M first split modulated optical signals to generate a respective positive modulated optical signal that represents a weight element in the respective 1-by-N weight matrix or the respective bias element; for each of the M second optical pathways: modulating, by a respective second weight modulator and based on the respective 1-by-N weight matrix of the M-by-N weight matrix or the respective bias element, a corresponding one of the M second split modulated optical signals to generate a respective negative modulated optical signal that represents the weight element in the respective 1-by-N weight matrix or the respective bias element; detecting, by each of M balanced photodetectors, (i) a corresponding positive modulated optical signal of M positive modulated optical signals from the M first optical pathways and (ii) a corresponding negative modulated optical signal of M negative modulated optical signals from the M second optical pathways; and generating, by a control circuitry, electrical outputs representing a computation output of the mathematical function applied to a sum of (i) a multiplication between the M-by-N weight matrix and the N-by-1 input matrix and (ii) the M-by-1 bias matrix.

Another aspect of the present disclosure features a method for performing computations using a photonic system, including: receiving, by a first input optical modulator, a first input optical signal; receiving, by a second input optical modulator, a second input optical signal; modulating, by the first input optical modulator and based on an N-by-1 input matrix of a mathematical function, the first input optical signal to generate a first modulated optical signal configured to represent one of N input elements of the N-by-1 input matrix or a reference bias; modulating, by the second input optical modulator and based on the N-by-1 input matrix, the second input optical signal to generate a second modulated optical signal configured to represent each of the N input elements of the N-by-1 input matrix or the reference bias; splitting, by a first optical splitter, the first modulated optical signal to at least M first split modulated optical signals corresponding to M first optical pathways; splitting, by a second optical splitter, the second modulated optical signal to at least M second split modulated optical signals corresponding to M second optical pathways; for each of the M first optical pathways: modulating, by a respective first weight modulator and based on a respective 1-by-N weight matrix of an M-by-N weight matrix of the mathematical function or a respective bias element of an M-by-1 bias matrix of the mathematical function, a corresponding one of the M first split modulated optical signals to generate a respective positive modulated optical signal that represents a weight element in the respective 1-by-N weight matrix or the respective bias element; for each of the M second optical pathways: modulating, by a respective second weight modulator and based on the respective 1-by-N weight matrix of the M-by-N weight matrix or the respective bias element, a corresponding one of the M second split modulated optical signals to generate a respective negative modulated optical signal that represents the weight element in the respective 1-by-N weight matrix or the respective bias element; detecting, by each of M balanced photodetectors, (i) a corresponding positive modulated optical signal of M positive modulated optical signals from the M first optical pathways and (ii) a corresponding negative modulated optical signal of M negative modulated optical signals from the M second optical pathways; and generating, by a control circuitry, electrical outputs representing a computation output of the mathematical function applied to a sum of (i) a multiplication between the M-by-N weight matrix and the N-by-1 input matrix and (ii) the M-by-1 bias matrix.

In some implementations, each of M balanced photodetectors includes a nonlinear balanced photoresistor configured based on an activation function of the mathematical function.

In some implementations, each of M balanced photodetectors includes a balanced photodiode, and the control circuitry is configured to generate the electrical outputs based on an activation function of the mathematical function.

In some implementations, the first modulated optical signal is generated to represent each of the N input elements and the reference bias in a respective time period of multiple time periods.

In some implementations, the N input elements and the reference bias are respectively represented by a plurality of first modulated optical signals and a plurality of second modulated optical signals over multiple wavelengths or multiple optical pathways.

Another aspect of the present disclosure features a photonic system configured to perform the method of any one of the implementations as disclosed above.

Another aspect of the present disclosure features a method, including: detecting at least one modulated optical signal using a plurality of photodetectors, the at least one modulated optical signal representing one or more input elements of an input matrix of a mathematical function, the plurality of photodetectors being modulated based on weight elements of a weight matrix of the mathematical function; and generating electrical outputs based on outputs of the plurality of photodetectors using a control circuitry, the electrical outputs representing a computation result of the mathematical function corresponding to a multiplication of the input matrix and the weight matrix.

In some implementations, an activation function of the mathematical function is implemented by at least one of the control circuitry or the plurality of photodetectors.

In some implementations, each of the plurality of photodetectors includes a nonlinear phototransistor configured based on the activation function, and the control circuitry is configured to generate the electrical outputs based on the outputs of the plurality of photodetectors.

In some implementations, each of the plurality of photodetectors includes a photodiode configured to have a linear photo-response, and the control circuitry is configured to generate the electrical outputs based on the outputs of the plurality of photodetectors and the activation function.

In some implementations, the method further includes at least one of modulating at least one optical source with input information corresponding to the input matrix to generate the at least one modulated optical signal, or modulating at least one input optical signal with input information corresponding to the input matrix by at least one optical modulator to generate the at least one modulated optical signal.

In some implementations, the at least one optical source includes a laser source or a light-emitting diode, and where modulating the at least one optical source with the input information includes: modulating a bias voltage applied to the laser source or the light-emitting diode based on the input matrix.

In some implementations, a bias voltage applied to each of the plurality of photodetectors is modulated with respective weight information corresponding to the weight matrix of the mathematical function.

In some implementations, the method further includes: directing the at least one modulated optical signal to at least part of the plurality of photodetectors in free space.

In some implementations, the at least one modulated optical signal is uniformly illuminated on the plurality of photodetectors.

In some implementations, the method further includes: directing, by an optical diffuser, the least one modulated optical signal to uniformly illuminate the plurality of photodetectors.

In some implementations, the at least one modulated optical signal is concentratedly illuminated on individual photodetectors of the plurality of photodetectors.

In some implementations, the method further includes: directing, by an optical dot projector, the at least one modulated optical signal to generate illumination dots respectively on the individual photodetectors.

In some implementations, the input matrix includes an N-by-1 input matrix, the weight matrix includes an M-by-N weight matrix, and the computation result includes an M-by-1 matrix, where each of M and N is an integer.

In some implementations, the plurality of photodetectors include N groups of M photodetectors, and the method includes: during each of N time periods, generating the at least one modulated optical signal with a respective intensity corresponding to a respective input element in the N-by-1 input matrix, directing the at least one modulated optical signal to illuminate at least part of the plurality of photodetectors, modulating a group of the N groups of M photodetectors based on a corresponding group of M weights in the M-by-N weight matrix corresponding to the respective input element, and generating a respective result by each of the group of M photodetectors detecting the at least one modulated optical signal, the respective result corresponding to a multiplication of the respective input element and a corresponding weight element of the corresponding group of M weights; and after the N time periods, generating M electrical outputs by the control circuitry, where each of the M electrical outputs is based on a sum of N respective results from the N groups of M photodetectors.

In some implementations, the mathematical function further includes an M-by-1 bias matrix. The method further includes: during an additional time period different from the N time periods, generating the at least one modulated optical signal having an intensity corresponding to a normalized value of 1, modulating an additional group of M photodetectors in the plurality of photodetectors respectively based on M bias values in the M-by-1 bias matrix, and accumulating a respective bias result by each of the additional group of M photodetectors by detecting the at least one modulated optical signal, the respective bias result corresponding to a multiplication of the value of 1 and a corresponding bias value of the M bias values, where each of the M electrical outputs is based on the sum of N respective results from the N groups of M photodetectors and the respective bias result from an additional photodetector in the additional group of M photodetectors modulated during the additional time period.

In some implementations, the electrical output corresponds to an element of the computation result

$$α ( {Σ}_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, b(i) represents a bias value in the M-by-1 bias matrix, where i is an integer in a range from 1 to M, and j is an integer in a range from 1 to N.

In some implementations, during each of the N time periods, a corresponding group of the N groups of M photodetectors is turned on, and other groups of the N groups of M photodetectors in the plurality of photodetectors are turned off.

In some implementations, the at least one modulated optical signal includes N modulated optical signals, where the plurality of photodetectors include N groups of M photodetectors. The method includes: generating the N modulated optical signals each having an optical intensity representing a respective input element in the N-by-1 input matrix; for each of the N modulated optical signals corresponding to the respective element, directing the modulated optical signal to a respective group of the N groups of M photodetectors, modulating the respective group of M photodetectors based on a corresponding group of M weight elements in the M-by-N weight matrix corresponding to the respective input element, and generating a respective result by each of the respective group M photodetectors detecting the modulated optical signal, the respective result corresponding to a multiplication of the respective input element and a corresponding weight element of the corresponding group of M weights; and generating M electrical outputs by the control circuitry, where each of the M electrical outputs is based on a sum of N respective results from the N groups of M photodetectors.

In some implementations, the mathematical function further includes an M-by-1 bias matrix, and the respective intensity corresponds to a normalized value in a range from 0 to 1, and where the plurality of photodetectors further include an additional group of M photodetectors, the at least one modulated optical signal includes an additional modulated optical signal different from the N modulated optical signals, and the method further includes: generating the additional modulated optical signal having an optical intensity corresponding to a normalized value of 1, modulating the additional group of M photodetectors in the plurality of photodetectors array respectively based on M bias values in the M-by-1 bias matrix, and generating a respective bias result by each of the additional group of M photodetectors detecting the additional modulated optical signal, the respective bias result corresponding to a multiplication of the value of 1 and a corresponding bias value of the M bias values, and each of the electrical outputs is generated based on the sum of the N respective results from the group of N photodetectors and the respective bias result from a corresponding additional photodetector in the additional group of M photodetectors.

In some implementations, the electrical output corresponds to an element of the computation result

$$α ( {Σ}_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, where i is an integer in a range from 1 to M, and j is an integer in a range from 1 to N.

In some implementations, each of the N modulated optical signals has a respective wavelength, at least two of respective wavelengths of the N modulated optical signals being different.

In some implementations, each of the N modulated optical signals has a same wavelength.

In some implementations, the at least one modulated optical signal includes a first modulated optical signal and a second modulated optical signal, and the plurality of photodetectors include balanced photodetectors each including a pair of photodetectors electrically coupled with balanced connections. The method includes: directing the first modulated optical signal to generate first illumination dots respectively on first photodetectors of the balanced photodetectors, and directing the second modulated optical signal to generate second illumination dots on second photodetectors of the balanced photodetectors, where a first illumination dot of the first illumination dots on a first photodetector of a corresponding balanced photodetector represents a positive modulated optical signal, and a second illumination dot of the second illumination dots on a second photodetector of the corresponding balanced photodetector represents a negative modulated optical signal, and where the corresponding balanced photodetector generates a corresponding output based on the positive modulated optical signal and the negative modulated optical signal.

In some implementations, the positive modulated optical signal has a first intensity based on first input information from the control circuitry, and the negative modulated optical signal has a second intensity based on second input information from the control circuitry, and where the first input information and the second input information are determined based on input information associated with an input element of the input matrix, and the balanced photodetector is modulated based on weight information of a weight element in the weight matrix corresponding to the input element, and the corresponding output corresponds to a multiplication of the input element and the weight element.

In some implementations, the first intensity corresponds to a first normalized value in a range from 0 to 1, the second intensity corresponds to a second normalized value in the range from 0 to 1, and a difference between the first intensity and the second intensity corresponds to a normalized value in a range from −1 to 1.

In some implementations, the first modulated optical signal and the second modulated optical signal are directed by at least one optical dot projector to respectively generate the first illumination dots and the second illumination dots.

In some implementations, a photodetector of the plurality of photodetector includes a multi-tap photodetector.

In some implementations, the multi-tap photodetector includes a silicon (Si)-based photodetector or a germanium (Ge)-based photodetector.

In some implementations, the multi-tap photodetector includes one or more transistors as one or more corresponding taps.

In some implementations, the multi-tap photodetector includes a first tap having a first control terminal and a first output terminal, a second tap having a second control terminal and a second output terminal, and the control circuitry is coupled to the multi-tap photodetector and configured to generate an electrical output based on a difference of a first output from the first output terminal of the first tap and a second output from the second output terminal of the second tap.

In some implementations, the first tap and the second tap of the multi-tap photodetector are configured to control flows of photocarriers generated by the multi-tap photodetector. The method includes: generating the first output by controlling the first tap of the multi-tap photodetector to guide, based on a first demodulation contrast, a first portion of the photocarriers to the first output terminal, and generating the second output by controlling the second tap of the multi-tap photodetector to guide, based on a second demodulation contrast, a second portion of the photocarriers to the second output terminal.

In some implementations, the method includes performing a complementary measurement during a time period using the multi-tap photodetector, and performing the complementary measurement includes: during a first sub-time period of the time period, modulating an input optical signal to have a first intensity such that when detected, first photocarriers corresponding to a first normalized photocurrent response R in a range from 0 to 1 are generated, modulating the first control terminal of the first tap with a first control signal corresponding to a first normalized demodulation contrast C_{D} in a range from 0 to 1, modulating the second control terminal of the second tap with a second control signal corresponding to a second normalized demodulation contrast (1−C_{D}), and generating a first measurement output based on a first difference between the first output from the first output terminal of the first tap and the second output from the second output terminal of the second tap; during a second sub-time period of the time period, modulating the input optical signal to have a second intensity such that when detected, second photocarriers corresponding to a second normalized photocurrent response (1−R) are generated, modulating the first control terminal of the first tap with the second control signal corresponding to the second normalized demodulation contrast (1−C_{D}), modulating the second control terminal of the second tap with the first control signal corresponding to the first normalized demodulation contrast C_{D}, and generating a second measurement output based on a second difference between the first output from the first output terminal of the first tap and the second output from the second output terminal of the second tap, where the first sub-time period and the second sub-time period are adjacent in the time period; and
generating, by the control circuitry, the electrical output based on a sum of the first measurement output from the first sub-time period and the second measurement output from the second sub-time period, the electrical output representing a multiplication of a particular weight element of the weight matrix and a particular input element of the input matrix, where the particular weight is in a normalized weight range from −1 to 1, and the particular input element is in a normalized input range from −1 to 1, where the first intensity and the second intensity are determined based on the particular input element of the input matrix, and the first control signal and the second control signal are determined based on the particular weight of the weight matrix.

In some implementations, the first measurement output and the second measurement output each includes dark current information representing dark currents associated with the multi-tap photodetector, and where the sum of the first measurement output and the second measurement output includes no such dark current information.

In some implementations, the first control terminal is modulated by a first voltage during the first sub-time period and a second voltage during the second sub-time period, and the second control terminal is modulated by the second voltage during the first sub-time period and the first voltage during the second sub-time period.

In some implementations, the first control signal and the second control signal have a peak amplitude that is equal with a phase difference of “pi”.

In some implementations, while the input optical signal is modulated to have the first intensity during the first sub-time period, the first control signal has the peak amplitude during a first portion of the first sub-time period, and the second control signal has the peak amplitude during a second portion of the first sub-time period, and while the input optical signal is modulated to have the second intensity during the second sub-time period, the second control signal has the peak amplitude during the first portion of the second sub-time period, and the first control signal has the peak amplitude during the second portion of the second sub-time period.

In some implementations, the method includes performing a symmetric measurement using the multi-tap photodetector by: performing a first complementary measurement during a first time period to generate a first result, performing a second complementary measurement during a second time period to generate a second result, and generating the electrical output based on a difference of the first result and the second result.

In some implementations, performing the first complementary measurement includes: during a first sub-time period of the first time period, modulating an input optical signal to have a first intensity such that when detected, first photocarriers corresponding to a first normalized photocurrent response R in a range from 0 to 1 are generated, modulating the first control terminal of the first tap with a first control signal corresponding to a first normalized demodulation contrast C_{D}′ in a range from 0 to 1, modulating the second control terminal of the second tap with a second control signal corresponding to a second normalized demodulation contrast (1−C_{D}′), and generating a first measurement output based on a first difference between the first output from the first output terminal of the first tap and the second output from the second output terminal of the second tap; during a second sub-time period of the first time period, modulating the input optical signal to have a second intensity such that when detected, second photocarriers corresponding to a second normalized photocurrent response (1−R) are generated, modulating the first control terminal of the first tap with a third control signal corresponding to a third normalized demodulation contrast (1−C_{D}″) in the range from 0 to 1, modulating the second control terminal of the second tap with a fourth control signal corresponding to a fourth normalized demodulation contrast C_{D}″, and generating a second measurement output based on a second difference between the first output from the first output terminal of the first tap and the second output from the second output terminal of the second tap. Performing the second complimentary measurement includes: during a first sub-time period of the second time period, modulating the input optical signal to have a third intensity such that when detected, third photocarriers corresponding to the first normalized photocurrent response R are generated, modulating the first control terminal of the first tap with the third control signal corresponding to the third normalized demodulation contrast (1-C_{D}″), modulating the second control terminal of the second tap with the fourth control signal corresponding to the fourth normalized demodulation contrast C_{D}″, and generating a third measurement output based on a third difference between the first output from the first output terminal of the first tap and the second output from the second output terminal of the second tap; during a second sub-time period of the second time period, modulating the input optical signal to have a fourth intensity corresponding to the second normalized photocurrent response (1−R), modulating the first control terminal of the first tap with the first control signal corresponding to the first normalized demodulation contrast C_{D}′, modulating second control terminal of the second tap with the second control signal corresponding to the second normalized demodulation contrast (1−C_{D}′), and generating a fourth measurement output based on a fourth difference between the first output from the first output terminal of the first tap and the second output from the second output terminal of the second tap; and generating, by the control circuitry, the electrical output based on the first measurement output, the second measurement output, the third measurement output, and the fourth measurement output, where the first intensity, the second intensity, the third intensity, and the fourth intensity are determined based on a particular input element of the input matrix, and the first control signal, the second control signal, the third control signal, and the fourth control signal are determined based on a particular weight of the weight matrix.

In some implementations, the first measurement output, the second measurement output, the third measurement output, and the fourth measurement output each includes dark current information representing dark currents associated with the multi-tap photodetector, and a difference between a first sum of the first measurement output and the second measurement output for the first complementary measurement and a second sum of the third measurement output and the fourth measurement output for the second complementary measurement includes no such dark current information.

In some implementations, the first output terminal is coupled to a first capacitor, and the first output from the first output terminal of the first tap corresponds to first electrical charges stored in the first capacitor, and the second output terminal is coupled to a second capacitor, and the second output from the second output terminal of the second tap corresponds to second electrical charges stored in the second capacitor.

Another aspect of the present disclosure features a method for performing computations using a photonic system, including: generating, by an optical source, a modulated input optical signal representing one of N input elements of an N-by-1 input matrix and a reference bias of a mathematical function, where N is an integer; directing, by an optical diffuser, the modulated input optical signal towards an optical detector array; modulating, based on at least a subset of an M-by-N weight matrix and an M-by-1 bias matrix of the mathematical function, the optical detector array, where M is an integer; and generating, by a control circuitry, electrical outputs based on outputs of the optical detector array, the electrical outputs representing a computation result of an activation function of the mathematical function applied to a sum of (i) a multiplication between the M-by-N weight matrix and the N-by-1 input matrix and (ii) the M-by-1 bias matrix.

Another aspect of the present disclosure features a method for performing computations using a photonic system, including: generating, by an optical source, a modulated input optical signal representing one of N input elements of an N-by-1 input matrix and a reference bias of a mathematical function, where N is an integer; directing, by an optical dot projector, the modulated input optical signal towards an optical detector array; modulating, based on at least a subset of an M-by-N weight matrix and an M-by-1 bias matrix of the mathematical function, the optical detector array, where M is an integer; and generating, by a control circuitry, electrical outputs based on outputs of the optical detector array, the electrical outputs representing a computation result of an activation function of the mathematical function applied to a sum of (i) a multiplication between the M-by-N weight matrix and the N-by-1 input matrix and (ii) the M-by-1 bias matrix.

Another aspect of the present disclosure features a method for performing computations using a photonic system, including: generating, by a first optical source, a first modulated input optical signal representing one of N input elements of an N-by-1 input matrix and a reference bias of a mathematical function, where N is an integer; generating, by a second optical source, a second modulated input optical signal representing the one of the N input elements of the N-by-1 input matrix and the reference bias; directing, by an optical dot projector, the first modulated input optical signal and the second modulated input optical signal towards an optical detector array; modulating, based on at least a subset of an M-by-N weight matrix and an M-by-1 bias matrix of the mathematical function, the optical detector array, where N is an integer; and generating, by a control circuitry, electrical outputs based on outputs of the optical detector array, the electrical outputs representing a computation result of an activation function of the mathematical function applied to a sum of (i) a multiplication between the M-by-N weight matrix and the N-by-1 input matrix and (ii) the M-by-1 bias matrix.

In some implementations, the optical detector array includes a plurality of photodetectors each having two taps for controlling flows of photo-generated carriers.

Another aspect of the present disclosure features a method for performing computations using a photonic system, including: during a first time period, generating first photo-generated carriers by a photodetector including a first control terminal, a second control terminal, a first collection terminal, and a second collection terminal; receiving, by the first control terminal, a first control signal for guiding a first portion of the first photo-generated carriers to the first collection terminal; receiving, by the second control terminal, a second control signal for guiding a second portion of the first photo-generated carriers to the second collection terminal; during a second time period: generating second photo-generated carriers by the photodetector; receiving, by the first control terminal, a third control signal for guiding a first portion of the second photo-generated carriers to the first collection terminal; receiving, by the second control terminal, a fourth control signal for guiding a second portion of the second photo-generated carriers to the second collection terminal; and determining, by a circuitry based on carriers collected by the first collection terminal and the second collection terminal, an output representing a multiplication product between a first number and a second number, where the first photo-generated carriers and the second photo-generated carriers are associated with the first number, and where the first control signal, the second control signal, the third control signal, and the fourth control signal are associated with the second number.

In some implementations, the first control signal and the second control signal have different amplitudes.

In some implementations, the first control signal and the fourth control signal have substantially a same amplitude, and where the second control signal and the third control signal have substantially a same amplitude.

In some implementations, the first control signal and the second control signal are complementary in time, and where the third control signal and the fourth control signal are complementary in time.

In some implementations, the method further includes: storing the first portion of the first photo-generated carriers and the first portion of the second photo-generated carriers in a first capacitor; and storing the second portion of the first photo-generated carriers and the second portion of the second photo-generated carriers in a second capacitor.

Another aspect of the present disclosure features a method for performing computations using a photonic system, including: during a first time period, generating, by an optical source, a first modulated input optical signal having a first intensity; directing, by an optical element, the first modulated input optical signal towards an optical detector array including an optical detector having a first tap and a second tap for controlling flows of first photocarriers generated by the first modulated input optical signal; controlling the first tap of the optical detector to guide, with a first demodulation contrast, a first portion of the first photocarriers; and controlling the second tap of the optical detector to guide, with a second demodulation contrast, a second portion of the first photocarriers; during a second time period, generating, by the optical source, a second modulated input optical signal having a second intensity; directing, by the optical element, the second modulated input optical signal towards the optical detector having the first tap and the second tap for controlling flows of second photocarriers generated by the second modulated input optical signal; controlling the first tap of the optical detector to guide, with a third demodulation contrast, a first portion of the second photocarriers; and controlling the second tap of the optical detector to guide, with a fourth demodulation contrast, a second portion of the second photocarriers; and determining, by circuitry and based on carriers collected from the optical detector, an output representing a multiplication product between two numbers.

In some implementations, the first intensity is associated with a first photocurrent response R, where the second intensity is associated with a second photocurrent response (1-R), and the first demodulation contrast and the fourth demodulation contrast are associated with a demodulation contrast C, and where the second demodulation contrast and the third demodulation contrast are associated with a demodulation contrast (1−C).

In some implementations, the method further includes: during a third time period, generating, by the optical source, a third modulated input optical signal having the first intensity; directing, by the optical element, the third modulated input optical signal towards the optical detector to generate third photocarriers; controlling the first tap of the optical detector to guide, with a fifth demodulation contrast, a first portion of the third photocarriers; and controlling the second tap of the optical detector to guide, with a sixth demodulation contrast, a second portion of the third photocarriers; during a fourth time period, generating, by the optical source, a fourth modulated input optical signal having the second intensity; directing, by the optical element, the fourth modulated input optical signal towards the optical detector to generate fourth photocarriers; controlling the first tap of the optical detector to guide, with a seventh demodulation contrast, a first portion of the fourth photocarriers; and controlling the second tap of the optical detector to guide, with an eighth demodulation contrast, a second portion of the fourth photocarriers. Determining the output representing the multiplication product between the two numbers further includes determining, by the circuitry and based on the first portion and the second portion of the first photocarriers, the first portion and the second portion of the second photocarriers, the first portion and the second portion of the third photocarriers, and the first portion and the second portion of the fourth photocarriers, an output representing the multiplication product between the two numbers.

In some implementations, the first intensity is associated with a first photocurrent response R, where the second intensity is associated with a second photocurrent response (1-R), and the first demodulation contrast and the seventh demodulation contrast are associated with a demodulation contrast C′, where the second demodulation contrast and the eighth demodulation contrast are associated with a demodulation contrast (1−C′), where the third demodulation contrast and the fifth demodulation contrast are associated with a demodulation contrast (1−C″), and where the fourth demodulation contrast and the sixth demodulation contrast are associated with a demodulation contrast C″.

Another aspect of the present disclosure features a method including: directing a particular modulated optical signal of at least one modulated optical signal to a group of M photodetectors of a plurality of photodetectors, where the particular modulated optical signal has an intensity associated with a particular input element of an input matrix of a mathematical function, the input matrix including an N-by-1 input matrix; modulating the group of M photodetectors respectively with a group of M weight elements in a weight matrix corresponding to the particular input element, the weight matrix including an M-by-N weight matrix; generating a result by the group of M photodetectors detecting the particular modulated optical signal, the result corresponding to a multiplication of the particular input element and the group of M weights; and generating electrical outputs based on outputs of the plurality of photodetectors using a control circuitry, the electrical outputs representing a computation result of the mathematical function corresponding to a multiplication of the input matrix and the weight matrix, the computation result including an M-by-1 matrix, where each of M and N is an integer.

In some implementations, the at least one modulated optical signal includes N modulated optical signals, where the plurality of photodetectors includes N groups of M photodetectors, and the method includes: directing each of the N modulated optical signals to a respective group of M photodetectors, where the modulated optical signal has a respective intensity associated with a respective input element of N input elements in the input matrix; modulating the N groups of M photodetectors with corresponding N groups of M weights in the M-by-N weight matrix; and generating a respective result by each of the respective group of M photodetectors detecting the respective modulated optical signal, the respective result corresponding to a multiplication of the respective input element and the respective group of M weights.

In some implementations, each of the electrical outputs represents a sum of N respective results from N photodetectors of the N groups, where each of the N respective results represents a multiplication of a corresponding input element in the N-by-1 input matrix by a corresponding weight element in the M-by-N weight matrix.

In some implementations, the mathematical function further includes an M-by-1 bias matrix, and the respective intensity corresponds to a normalized value in a range from 0 to 1, and the at least one modulated optical signal includes an additional modulated optical signal different from the N modulated optical signals, where the plurality of photodetectors further includes an additional group of M photodetectors. The method further includes: generating the additional modulated optical signal with an intensity corresponding to a normalized value of 1, directing the additional modulated optical signal to the additional group of M photodetectors, modulating the additional group of M photodetectors based on M bias values in the M-by-1 bias matrix, and generating a respective bias result by each of M photodetectors in the additional group detecting the additional modulated optical signal, the respective bias results corresponding to a multiplication of the value of 1 and the M bias values, and each of the electrical outputs represents the sum of the N respective results from the N photodetectors of the N groups and the respective bias result from a corresponding photodetector in the additional group.

In some implementations, the electrical output corresponds to an element of the computation result

$$α ( {Σ}_{j = 1}^{N} {W}_{i} ( j ) I ( j ) + {b}_{i} ) ,$$

where α represents the activation function, Wᵢ(j) represents a weight element Wᵢⱼ in the M-by-N weight matrix, I(j) represents the jth input element in the N-by-1 input matrix, bᵢ represents the ith bias element in the M-by-1 bias matrix, where i is an integer in a range from 1 to M, and j is an integer in a range from 1 to N.

In some implementations, each of the N modulated optical signals has a respective wavelength, at least two of respective wavelengths of the N modulated optical signals being different.

In some implementations, each of the N modulated optical signals has a same wavelength.

In some implementations, the method further includes: generating each of the N modulated optical signals by at least one of modulating a respective optical source of a plurality of optical sources based on the respective input element of the input matrix or modulating an input optical signal based on the respective input element of the input matrix by a respective optical modulator.

In some implementations, the method includes: directing, in parallel, the N modulated optical signals respectively to the N groups of M photodetectors.

In some implementations, directing each of the N modulated optical signals to the respective group of M photodetectors includes: directing, by at least one optical element, the modulated optical signal to illuminate the respective group of M photodetectors.

In some implementations, the at least one optical element includes at least one of an optical diffuser, an optical dot projector, an elliptical/circular lens, or a microlens array, and where the plurality of photodetectors include a microlens array.

In some implementations, the plurality of photodetectors includes M groups of N photodetectors, each group of N photodetectors being arranged together in a respective area.

In some implementations, the at least one modulated optical signal includes N modulated optical signals each representing respective input elements of the input matrix, and the method includes: directing the N modulated optical signals to each group of N photodetectors, the group of N photodetectors being modulated based on a corresponding group of N weights in the M×N weight matrix, where each of the N modulated optical signals is associated with a respective input element of N elements in the input matrix and directed to a corresponding photodetector in the group of N photodetectors, and where the corresponding photodetector is modulated based on a weight element corresponding to the respective input element in the corresponding group of N weights; generating a respective result by the corresponding photodetector in the group of N photodetectors, the respective result corresponding to a multiplication of the respective element and the weight corresponding to the respective element in the group of N weights; and generating a respective electrical output by the control circuitry based on a sum of N respective results from the group of N photodetectors.

In some implementations, the mathematical function further includes an M-by-1 bias matrix, and the respective intensity corresponds to a normalized value in a range from 0 to 1, where the at least one modulated optical signal includes an additional modulated optical signal different from the N modulated optical signals, and the method further includes: generating an additional modulated optical signal with an intensity corresponding to a normalized value of 1, modulating an additional photodetector in the plurality of photodetectors array based on a respective bias value corresponding to the group of N weights in the M-by-1 bias matrix, and generating a respective bias result by the additional photodetector detecting the additional modulated optical signal, the bias result corresponding to a multiplication of the value of 1 and the respective bias value, and the respective electrical output is generated based on the sum of the N respective results from the group of N photodetectors and the respective bias result from the additional photodetector, and where the group of N photodetectors and the additional photodetector are arranged in a same area.

In some implementations, the respective electrical output corresponds to an element of the computation result

$$α ( {Σ}_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, where i is an integer in a range from 1 to M, and j is an integer in a range from 1 to N.

In some implementations, directing the N modulated optical signals to each group of N photodetectors includes: sequentially directing, by an optical element, the N modulated optical signals to each group of N photodetectors.

In some implementations, directing the N modulated optical signals to each group of N photodetectors includes: directing, by at least one optical element, each of the N modulated optical signals to a respective photodetector of each group of N photodetectors.

In some implementations, the at least one optical element includes at least one of an optical diffuser, an optical dot projector, an elliptical/circular lens, or a microlens array, and where the plurality of photodetectors include a microlens array.

In some implementations, the method further includes: generating each of the N modulated optical signals by at least one of modulating a respective optical source of a plurality of optical sources based on the respective input element of the N input elements in the input matrix, or modulating an input optical signal based on the respective input element of the N input elements in the input matrix by a respective optical modulator of a plurality of optical modulators.

In some implementations, each of the N modulated optical signals has a respective wavelength, at least two of respective wavelengths of the N modulated optical signals being different.

In some implementations, each of the N modulated optical signals has a same wavelength.

Another aspect of the present disclosure features a method for performing computations using a photonic system, the method including: generating, by a plurality of optical sources, modulated input optical signals representing (i) input elements of an input matrix and (ii) a reference bias; modulating, based on at least a subset of a weight matrix and a bias matrix, an optical detector array; and generating, by a control circuitry, electrical outputs based on outputs of the optical detector array, the electrical outputs representing a computation output for a sum of (i) a multiplication between the weight matrix and the input matrix and (ii) the bias matrix.

In some implementations, the method further includes: coupling a subset of optical detectors of the optical detector array to a readout line; and providing the electrical outputs associated with the subset of optical detectors of the optical detector array to the readout line.

In some implementations, the method further includes: directing, by an optical element, the modulated input optical signals towards the optical detector array.

Another aspect of the present disclosure features a method including: detecting at least one modulated optical signal using a plurality of photodetectors, the at least one modulated optical signal representing one or more input elements of an input matrix of a mathematical function, the plurality of photodetectors being modulated based on weight elements of a weight matrix of the mathematical function; and generating electrical outputs based on outputs of the plurality of photodetectors using a control circuitry, the electrical outputs representing a computation result of the mathematical function corresponding to a multiplication of the input matrix and the weight matrix, where the control circuitry includes a digital-to-analog converter (DAC) circuit having an output electrically coupled to a plurality of devices including one of (i) a plurality of optical sources, (ii) a plurality of optical modulators, or (iii) a subset of the plurality of photodetectors, where the output provides a modulation signal configured to modulate the plurality of devices, and where the modulation signal represents (i) a particular input element of the input matrix or (ii) a particular weight element of the weight matrix.

In some implementations, the modulation signal represents the particular weight element of the weight matrix, where the output of the DAC circuit is electrically coupled to the subset of the plurality of photodetectors, where an input element in the input matrix includes multiple values, where a number of the subset of the plurality of photodetectors correspond to a number of the multiple values in the input element. The method includes: modulating multiple optical sources or optical modulators respectively with first electrical signals from the control circuitry to generate multiple modulated optical signals, where each of the multiple modulated optical signals represents a respective value of the multiple values of the particular input element in the input matrix; directing the multiple modulated optical signals respectively to the subset of the plurality of photodetectors, each of the subset of the plurality of photodetectors being modulated by the modulation signal; and generating outputs by the subset of the plurality of photodetectors, an output from each photodetector of the multiple photodetectors corresponding to a multiplication of the particular weight element in the weight matrix and the respective value of the input element.

In some implementations, the control circuitry includes an analog-to-digital converter (ADC) circuit, and the method includes: converting, by the ADC circuit, the outputs from the subset of the plurality of photodetectors into corresponding digital values; and generating, by the control circuitry, a digital result corresponding to a multiplication of the input matrix and the weight matrix.

In some implementations, the plurality of photodetectors includes multiple photodetector arrays, and the output of the DAC circuit is electrically coupled to each of the multiple photodetector arrays.

In some implementations, the plurality of optical sources or the plurality of optical modulators are formed on separate substrates.

In some implementations, the plurality of optical sources or the plurality of optical modulators, the plurality of photodetectors, the control circuitry, one or more processing units, and one or more memory units are integrated on an interposer.

In some implementations, the modulation signal represents the particular input element of the input matrix, where the output of the DAC circuit is electrically coupled to the plurality of optical sources or the plurality of optical modulators. The method includes: modulating the plurality of optical sources or the plurality of optical modulators with the modulation signal from the control circuitry to generate multiple modulated optical signals each representing the particular input element of the input matrix; directing the multiple modulated optical signals respectively to the subset of photodetectors of the plurality of photodetectors, each of the subset of photodetectors being modulated based on a respective weight element in the weight matrix corresponding to the particular input element in the input matrix; and generating outputs by the subset of photodetectors, the outputs from the subset of photodetectors corresponding to a multiplication of the particular input element and the weight elements associated with the particular input element.

In some implementations, the method includes: generating, by the DAC circuit at the output, the modulation signal based on a digital value corresponding to the particular input element of the input matrix.

In some implementations, the control circuitry includes an analog-to-digital converter (ADC) circuit, and the method includes: converting, by the ADC circuit, the outputs from the subset of the plurality of photodetectors into corresponding digital values; and generating, by the control circuitry, a digital result corresponding to a multiplication of the input matrix and the weight matrix.

In some implementations, directing the multiple modulated optical signals respectively to the subset of the plurality of photodetectors includes: directing, by at least one optical element, the multiple modulated optical signals respectively to the subset of the plurality of photodetectors, where the at least one optical element includes an optical diffuser, an optical dot projector, an elliptical/circular lens, or a microlens array, and the subset of the plurality of photodetectors include a microlens array.

In some implementations, the plurality of photodetectors form a photodetector array, and the subset of the plurality of photodetectors are formed in a same area of the photodetector array.

In some implementations, each of the plurality of optical sources or the plurality of optical modulators is formed on a same substrate.

In some implementations, the plurality of optical sources or plurality of optical modulators, the plurality of photodetectors, the control circuitry, one or more processors, one or more memory devices are integrated on an interposer.

Another aspect of the present disclosure features a method for computations using a photonic system, including: modulating at least one optical source or optical modulator with at least one first electrical signal from a control circuitry to generate at least one modulated optical signal based on an input element in an input matrix of a mathematical function; detecting the at least one modulated optical signal by at least one photodetector of a plurality of photodetectors based on second electrical signals from the control circuitry, the second electrical signals being based on a weight element in a weight matrix of the mathematical function, the weight element corresponding to the input element, where each of the second electrical signals is associated with a respective digit of a multi-digit weight value that represents the weight element in the weight matrix; and generating electrical outputs based on outputs of the plurality of photodetectors using the control circuitry, the electrical outputs representing a computation result of the mathematical function corresponding to a multiplication of the input matrix and the weight matrix.

In some implementations, detecting the at least one modulated optical signal by the at least one photodetector of the plurality of photodetectors based on the second electrical signals includes: modulating the at least one photodetector based on the second electrical signals.

In some implementations, the multi-digit weight value is a binary number, and where each of the second electrical signals represents a respective digit value of the binary number.

In some implementations, the at least one optical source or optical modulator includes multiple optical sources or multiple optical modulators, the at least one modulated optical signal includes multiple modulated optical signals, and the at least one photodetector includes multiple photodetectors. The method further includes: directing each of the multiple modulated optical signals associated with a corresponding digit value of the binary number to a respective group of one or more photodetectors of the multiple photodetectors, the respective group of one or more photodetectors being modulated based on the corresponding digit value, and generating a respective output by the respective group of one or more photodetectors detecting the modulated optical signal; and generating a sum based on the outputs of the groups of one or more photodetectors of the multiple photodetectors, the sum corresponding to a multiplication of the input element in the input matrix and the weight element in the weight matrix.

In some implementations, each group of one or more photodetectors of the multiple photodetectors are associated with a power-factor of a binary number, where the groups of one or more photodetectors of the multiple photodetectors have one or more properties that are different from one another, where the one or more properties include an optical fill factor, a number of photodetectors, a number of activated photodetectors, a bias associated with a photodetector gain, or a number of activated gate circuitry that control a flow of outputs from the one or more photodetectors.

In some implementations, the plurality of photodetectors include multiple photodetector arrays, and each group of one or more photodetectors of the multiple photodetectors are in a same photodetector array or in different photodetector arrays.

In some implementations, the binary number includes multiple digit values associated with multiple power-factors, and modulating the at least one optical source or optical modulator with the at least one first electrical signal includes: during each of multiple time periods, modulating the at least one optical source or optical modulator with the at least one first electrical signal to generate the at least one modulated optical signal based on (i) the input element and (ii) a respective digit value of the multiple digit values.

In some implementations, the multi-digit weight value is provided by a digital-to-analog converter (DAC) circuit.

Another aspect of the present disclosure features a method including: modulating at least one optical source or optical modulator based on an input matrix of a mathematical function to generate at least one modulated optical signal; modulating at least one of the at least one modulated input optical signal or a plurality of photodetectors based on a weight matrix of the mathematical function; detecting the at least one modulated optical signal using a plurality of photodetectors; and generating electrical outputs based on outputs of the plurality of photodetectors using a control circuitry, the electrical outputs representing a computation result of the mathematical function corresponding to a multiplication of the input matrix and the weight matrix, where an activation function of the mathematical function is implemented by at least one of the control circuitry or the plurality of photodetectors.

Another aspect of the present disclosure features a photonic system configured to perform a method according to any one of the implementations as disclosed above.

Another aspect of the present disclosure features a photonic system for computation, including: a plurality of photodetectors configured to be modulated with weight information associated with a weight matrix of a mathematical function; at least one optical source or optical modulator configured to generate at least one modulated optical signal with input information associated with an input matrix of the mathematical function; and a control circuitry coupled to the plurality of photodetectors and configured to generate electrical outputs based on outputs of the plurality of photodetectors, the electrical outputs representing a computation result of the mathematical function corresponding to a multiplication of the input matrix and the weight matrix.

In some implementations, at least one of the control circuitry or the plurality of photodetectors is configured to implement an activation function of the mathematical function.

In some implementations, each of the plurality of photodetectors includes a nonlinear phototransistor configured based on the activation function, and the control circuitry is configured to generate the electrical outputs based on the outputs of the plurality of photodetectors.

In some implementations, each of the plurality of photodetectors includes a photodiode configured to have a linear photo-response, and the control circuitry is configured to generate the electrical outputs based on the outputs of the plurality of photodetectors and the activation function.

In some implementations, the photonic system further includes at least one of: at least one optical source configured to be modulated with the input information associated with the input matrix to generate the at least one modulated optical signal, or at least one input optical signal configured to be modulated with the input information associated with the input matrix by at least one optical modulator to generate the at least one modulated optical signal.

In some implementations, the at least one optical source includes a laser source or a light-emitting diode, and a bias voltage applied to the laser source or the light-emitting diode is configured to be modulated based on the input information associated with the input matrix.

In some implementations, a bias voltage applied to each of the plurality of photodetectors is configured to be modulated with respective weight information associated with the weight matrix of the mathematical function.

In some implementations, the photonic system further includes at least one optical element configured to direct the at least one modulated optical signal to at least part of the plurality of photodetectors in free space.

In some implementations, the at least one optical element is configured to direct the at least one modulated optical signal to uniformly illuminate the plurality of photodetectors.

In some implementations, the at least one optical element includes an optical diffuser.

In some implementations, the at least one optical element is configured to direct the at least one modulated optical signal to concentratedly illuminate individual photodetectors of the plurality of photodetectors.

In some implementations, the at least one optical element includes an optical dot projector configured to direct the at least one modulated optical signal to generate illumination dots respectively on the individual photodetectors.

In some implementations, the input matrix includes an N-by-1 input matrix, the weight matrix includes an M-by-N weight matrix, and the computation result includes an M-by-1 matrix, where each of M and N is an integer.

In some implementations, the plurality of photodetectors include N groups of M photodetectors, and the photonic system is configured to perform operations including: during each of N time periods, generating the at least one modulated optical signal with a respective intensity corresponding to a respective input element in the N-by-1 input matrix, directing the at least one modulated optical signal to illuminate at least part of the plurality of photodetectors, modulating a group of the N groups of M photodetectors based on a corresponding group of M weights in the M-by-N weight matrix corresponding to the respective input element, and generating a respective result by each of the group of M photodetectors detecting the at least one modulated optical signal, the respective result corresponding to a multiplication of the respective input element and a corresponding weight element of the corresponding group of M weights; and after the N time periods, generating M electrical outputs by the control circuitry, where each of the M electrical outputs is based on a sum of N respective results from the N groups of M photodetectors.

In some implementations, the mathematical function further includes an M-by-1 bias matrix, and the operations further include: during an additional time period different from the N time periods, generating the at least one modulated optical signal having an intensity corresponding to a normalized value of 1, modulating an additional group of M photodetectors in the plurality of photodetectors respectively based on M bias values in the M-by-1 bias matrix, and accumulating a respective bias result by each of the additional group of M photodetectors by detecting the at least one modulated optical signal, the respective bias result corresponding to a multiplication of the value of 1 and a corresponding bias value of the M bias values, where each of the M electrical outputs is based on the sum of N respective results from the N groups of M photodetectors and the respective bias result from an additional photodetector in the additional group of M photodetectors modulated during the additional time period.

In some implementations, the electrical output corresponds to an element of the computation result

$$α ( {Σ}_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, b(i) represents a bias value in the M-by-1 bias matrix, where i is an integer in a range from 1 to M, and j is an integer in a range from 1 to N.

In some implementations, during each of the N time periods, a corresponding group of the N groups of M photodetectors is turned on, and other groups of the N groups of M photodetectors in the plurality of photodetectors are turned off.

In some implementations, the at least one modulated optical signal includes N modulated optical signals, where the plurality of photodetectors include N groups of M photodetectors, and the photonic system is configured to perform operations including: generating the N modulated optical signals each having an optical intensity representing a respective input element in the N-by-1 input matrix; for each of the N modulated optical signals corresponding to the respective element, directing the modulated optical signal to a respective group of the N groups of M photodetectors, modulating the respective group of M photodetectors based on a corresponding group of M weight elements in the M-by-N weight matrix corresponding to the respective input element, and generating a respective result by each of the respective group M photodetectors detecting the modulated optical signal, the respective result corresponding to a multiplication of the respective input element and a corresponding weight element of the corresponding group of M weights; and generating M electrical outputs by the control circuitry, where each of the M electrical outputs is based on a sum of N respective results from the N groups of M photodetectors.

In some implementations, the mathematical function further includes an M-by-1 bias matrix, and the respective intensity corresponds to a normalized value in a range from 0 to 1, and where the plurality of photodetectors further include an additional group of M photodetectors, the at least one modulated optical signal includes an additional modulated optical signal different from the N modulated optical signals, and the operations further include: generating the additional modulated optical signal having an optical intensity corresponding to a normalized value of 1, modulating the additional group of M photodetectors in the plurality of photodetectors array respectively based on M bias values in the M-by-1 bias matrix, and generating a respective bias result by each of the additional group of M photodetectors detecting the additional modulated optical signal, the respective bias result corresponding to a multiplication of the value of 1 and a corresponding bias value of the M bias values, and each of the electrical outputs is generated based on the sum of the N respective results from the group of N photodetectors and the respective bias result from a corresponding additional photodetector in the additional group of M photodetectors.

In some implementations, the electrical output corresponds to an element of the computation result

$$α ( {Σ}_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, where i is an integer in a range from 1 to M, and j is an integer in a range from 1 to N.

In some implementations, each of the N modulated optical signals has a respective wavelength, at least two of respective wavelengths of the N modulated optical signals being different.

In some implementations, each of the N modulated optical signals has a same wavelength.

In some implementations, the at least one modulated optical signal includes a first modulated optical signal and a second modulated optical signal, and the plurality of photodetectors include balanced photodetectors each including a pair of photodetectors electrically coupled with balanced connections. The photonic system is configured to: direct the first modulated optical signal to generate first illumination dots respectively on first photodetectors of the balanced photodetectors, and direct the second modulated optical signal to generate second illumination dots on second photodetectors of the balanced photodetectors, where a first illumination dot of the first illumination dots on a first photodetector of a corresponding balanced photodetector represents a positive modulated optical signal, and a second illumination dot of the second illumination dots on a second photodetector of the corresponding balanced photodetector represents a negative modulated optical signal, and where the corresponding balanced photodetector generates a corresponding output based on the positive modulated optical signal and the negative modulated optical signal.

In some implementations, the positive modulated optical signal has a first intensity based on first input information from the control circuitry, and the negative modulated optical signal has a second intensity based on second input information from the control circuitry, and where the first input information and the second input information are determined based on input information associated with an input element of the input matrix, and the balanced photodetector is modulated based on weight information of a weight element in the weight matrix corresponding to the input element, and the corresponding output corresponds to a multiplication of the input element and the weight element.

In some implementations, the first intensity corresponds to a first normalized value in a range from 0 to 1, the second intensity corresponds to a second normalized value in the range from 0 to 1, and a difference between the first intensity and the second intensity corresponds to a normalized value in a range from −1 to 1.

In some implementations, the first modulated optical signal and the second modulated optical signal are directed by at least one optical dot projector to respectively generate the first illumination dots and the second illumination dots.

In some implementations, a photodetector of the plurality of photodetector includes a multi-tap photodetector.

In some implementations, the multi-tap photodetector includes a silicon (Si)-based photodetector or a germanium (Ge)-based photodetector.

In some implementations, the multi-tap photodetector includes one or more transistors as one or more corresponding taps.

In some implementations, the multi-tap photodetector includes a first tap having a first control terminal and a first output terminal, a second tap having a second control terminal and a second output terminal, and the control circuitry is coupled to the multi-tap photodetector and configured to generate an electrical output based on a difference of a first output from the first output terminal of the first tap and a second output from the second output terminal of the second tap.

In some implementations, the first tap and the second tap of the multi-tap photodetector are configured to control flows of photocarriers generated by the multi-tap photodetector, and the photonic system is configured to perform operations including: generating the first output by controlling the first tap of the multi-tap photodetector to guide, based on a first demodulation contrast, a first portion of the photocarriers to the first output terminal, and generating the second output by controlling the second tap of the multi-tap photodetector to guide, based on a second demodulation contrast, a second portion of the photocarriers to the second output terminal.

In some implementations, the operations include performing a complementary measurement during a time period using the multi-tap photodetector, and performing the complementary measurement includes: during a first sub-time period of the time period, modulating an input optical signal to have a first intensity such that when detected, first photocarriers corresponding to a first normalized photocurrent response R in a range from 0 to 1 are generated, modulating the first control terminal of the first tap with a first control signal corresponding to a first normalized demodulation contrast C_{D} in a range from 0 to 1, modulating the second control terminal of the second tap with a second control signal corresponding to a second normalized demodulation contrast (1−C_{D}), and generating a first measurement output based on a first difference between the first output from the first output terminal of the first tap and the second output from the second output terminal of the second tap; during a second sub-time period of the time period, modulating the input optical signal to have a second intensity such that when detected, second photocarriers corresponding to a second normalized photocurrent response (1−R) are generated, modulating the first control terminal of the first tap with the second control signal corresponding to the second normalized demodulation contrast (1−C_{D}), modulating the second control terminal of the second tap with the first control signal corresponding to the first normalized demodulation contrast C_{D}, and generating a second measurement output based on a second difference between the first output from the first output terminal of the first tap and the second output from the second output terminal of the second tap, where the first sub-time period and the second sub-time period are adjacent in the time period; and generating, by the control circuitry, the electrical output based on a sum of the first measurement output from the first sub-time period and the second measurement output from the second sub-time period, the electrical output representing a multiplication of a particular weight element of the weight matrix and a particular input element of the input matrix, where the particular weight is in a normalized weight range from −1 to 1, and the particular input element is in a normalized input range from −1 to 1, where the first intensity and the second intensity are determined based on the particular input element of the input matrix, and the first control signal and the second control signal are determined based on the particular weight of the weight matrix.

In some implementations, the first measurement output and the second measurement output each includes dark current information representing dark currents associated with the multi-tap photodetector, and where the sum of the first measurement output and the second measurement output includes no such dark current information.

In some implementations, the first control terminal is modulated by a first voltage during the first sub-time period and a second voltage during the second sub-time period, and the second control terminal is modulated by the second voltage during the first sub-time period and the first voltage during the second sub-time period.

In some implementations, the first control signal and the second control signal have a peak amplitude that is equal with a phase difference of “pi”.

In some implementations, while the input optical signal is modulated to have the first intensity during the first sub-time period, the first control signal has the peak amplitude during a first portion of the first sub-time period, and the second control signal has the peak amplitude during a second portion of the first sub-time period, and while the input optical signal is modulated to have the second intensity during the second sub-time period, the second control signal has the peak amplitude during the first portion of the second sub-time period, and the first control signal has the peak amplitude during the second portion of the second sub-time period.

In some implementations, the photonic system is configured to perform operations including performing a symmetric measurement using the multi-tap photodetector by: performing a first complementary measurement during a first time period to generate a first result, performing a second complementary measurement during a second time period to generate a second result, and generating the electrical output based on a difference of the first result and the second result.

In some implementations, performing the first complementary measurement includes: during a first sub-time period of the first time period, modulating an input optical signal to have a first intensity such that when detected, first photocarriers corresponding to a first normalized photocurrent response R in a range from 0 to 1 are generated, modulating the first control terminal of the first tap with a first control signal corresponding to a first normalized demodulation contrast C_{D}′ in a range from 0 to 1, modulating the second control terminal of the second tap with a second control signal corresponding to a second normalized demodulation contrast (1−C_{D}′), and generating a first measurement output based on a first difference between the first output from the first output terminal of the first tap and the second output from the second output terminal of the second tap; during a second sub-time period of the first time period, modulating the input optical signal to have a second intensity such that when detected, second photocarriers corresponding to a second normalized photocurrent response (1−R) are generated, modulating the first control terminal of the first tap with a third control signal corresponding to a third normalized demodulation contrast (1−C_{D}″) in the range from 0 to 1, modulating the second control terminal of the second tap with a fourth control signal corresponding to a fourth normalized demodulation contrast C_{D}″, and generating a second measurement output based on a second difference between the first output from the first output terminal of the first tap and the second output from the second output terminal of the second tap, where performing the second complimentary measurement includes: during a first sub-time period of the second time period, modulating the input optical signal to have a third intensity such that when detected, third photocarriers corresponding to the first normalized photocurrent response R are generated, modulating the first control terminal of the first tap with the third control signal corresponding to the third normalized demodulation contrast (1-C_{D}″), modulating the second control terminal of the second tap with the fourth control signal corresponding to the fourth normalized demodulation contrast C_{D}″, and generating a third measurement output based on a third difference between the first output from the first output terminal of the first tap and the second output from the second output terminal of the second tap; during a second sub-time period of the second time period, modulating the input optical signal to have a fourth intensity corresponding to the second normalized photocurrent response (1−R), modulating the first control terminal of the first tap with the first control signal corresponding to the first normalized demodulation contrast C_{D}′, modulating second control terminal of the second tap with the second control signal corresponding to the second normalized demodulation contrast (1−C_{D}′), and generating a fourth measurement output based on a fourth difference between the first output from the first output terminal of the first tap and the second output from the second output terminal of the second tap; and generating, by the control circuitry, the electrical output based on the first measurement output, the second measurement output, the third measurement output, and the fourth measurement output, where the first intensity, the second intensity, the third intensity, and the fourth intensity are determined based on a particular input element of the input matrix, and the first control signal, the second control signal, the third control signal, and the fourth control signal are determined based on a particular weight of the weight matrix.

In some implementations, the first measurement output, the second measurement output, the third measurement output, and the fourth measurement output each includes dark current information representing dark currents associated with the multi-tap photodetector, and a difference between a first sum of the first measurement output and the second measurement output for the first complementary measurement and a second sum of the third measurement output and the fourth measurement output for the second complementary measurement includes no such dark current information.

In some implementations, the first output terminal is coupled to a first capacitor, and the first output from the first output terminal of the first tap corresponds to first electrical charges stored in the first capacitor, and the second output terminal is coupled to a second capacitor, and the second output from the second output terminal of the second tap corresponds to second electrical charges stored in the second capacitor.

Another aspect of the present disclosure features a photonic system, including: a plurality of photodetectors; at least one optical element; and a control circuitry coupled to the plurality of photodetectors, where the at least one optical element is configured to direct a particular modulated optical signal of at least one modulated optical signal to a group of M photodetectors of the plurality of photodetectors, where the particular modulated optical signal has an intensity associated with a particular input element of an input matrix of a mathematical function, the input matrix including an N-by-1 input matrix, where the group of M photodetectors modulated respectively with a group of M weight elements in a weight matrix corresponding to the particular input element, the weight matrix including an M-by-N weight matrix, where the group of M photodetectors is configured to generate a result by detecting the particular modulated optical signal, the result corresponding to a multiplication of the particular input element and the group of M weights, and where the control circuitry is configured to generate electrical outputs based on outputs of the plurality of photodetectors, the electrical outputs representing a computation result of the mathematical function corresponding to a multiplication of the input matrix and the weight matrix, the computation result including an M-by-1 matrix, where each of M and N is an integer.

In some implementations, the at least one modulated optical signal includes N modulated optical signals, where the plurality of photodetectors includes N groups of M photodetectors. The photonic system is configured to: direct, by the at least one optical element, each of the N modulated optical signals to a respective group of M photodetectors, where the modulated optical signal has a respective intensity associated with a respective input element of N input elements in the input matrix; modulate the N groups of M photodetectors with corresponding N groups of M weights in the M-by-N weight matrix; and generate a respective result by each of the respective group of M photodetectors detecting the respective modulated optical signal, the respective result corresponding to a multiplication of the respective input element and the respective group of M weights.

In some implementations, each of the electrical outputs represents a sum of N respective results from N photodetectors of the N groups, where each of the N respective results represents a multiplication of a corresponding input element in the N-by-1 input matrix by a corresponding weight element in the M-by-N weight matrix.

In some implementations, the mathematical function further includes an M-by-1 bias matrix, and the respective intensity corresponds to a normalized value in a range from 0 to 1, the at least one modulated optical signal includes an additional modulated optical signal different from the N modulated optical signals, where the plurality of photodetectors further includes an additional group of M photodetectors, and the photonic system is configured to: generate the additional modulated optical signal with an intensity corresponding to a normalized value of 1, direct the additional modulated optical signal to the additional group of M photodetectors, modulate the additional group of M photodetectors based on M bias values in the M-by-1 bias matrix, and generate a respective bias result by each of M photodetectors in the additional group detecting the additional modulated optical signal, the respective bias results corresponding to a multiplication of the value of 1 and the M bias values, and each of the electrical outputs represents the sum of the N respective results from the N photodetectors of the N groups and the respective bias result from a corresponding photodetector in the additional group.

In some implementations, the electrical output corresponds to an element of the computation result

$$α ( {Σ}_{j = 1}^{N} {W}_{i} ( j ) I ( j ) + {b}_{i} ) ,$$

where α represents the activation function, Wᵢ(j) represents a weight element Wᵢⱼ in the M-by-N weight matrix, I(j) represents the jth input element in the N-by-1 input matrix, bᵢ represents the ith bias element in the M-by-1 bias matrix, here i is an integer in a range from 1 to M, and j is an integer in a range from 1 to N.

In some implementations, each of the N modulated optical signals has a respective wavelength, at least two of respective wavelengths of the N modulated optical signals being different.

In some implementations, each of the N modulated optical signals has a same wavelength.

In some implementations, the photonic system further includes a plurality of optical sources or optical modulators, where each optical source or optical modulator is configured to generate a respective modulated optical signal of the N modulated optical signals based on the respective input element of the input matrix.

In some implementations, the at least one optical element is configured to direct, in parallel, the N modulated optical signals respectively to the N groups of M photodetectors.

In some implementations, the at least one optical element includes at least one of an optical diffuser, an optical dot projector, an elliptical/circular lens, or a microlens array, and where the plurality of photodetectors include a microlens array.

In some implementations, the plurality of photodetectors includes M groups of N photodetectors, each group of N photodetectors being arranged together in a respective area.

In some implementations, the at least one modulated optical signal includes N modulated optical signals each representing respective input elements of the input matrix, and the photonic system is configured to perform operations including: directing the N modulated optical signals to each group of N photodetectors, the group of N photodetectors being modulated based on a corresponding group of N weights in the M×N weight matrix, where each of the N modulated optical signals is associated with a respective input element of N elements in the input matrix and directed to a corresponding photodetector in the group of N photodetectors, and where the corresponding photodetector is modulated based on a weight element corresponding to the respective input element in the corresponding group of N weights; generating a respective result by the corresponding photodetector in the group of N photodetectors, the respective result corresponding to a multiplication of the respective element and the weight corresponding to the respective element in the group of N weights; and generating a respective electrical output by the control circuitry based on a sum of N respective results from the group of N photodetectors.

In some implementations, the mathematical function further includes an M-by-1 bias matrix, and the respective intensity corresponds to a normalized value in a range from 0 to 1, and the at least one modulated optical signal includes an additional modulated optical signal different from the N modulated optical signals, and the operations further include: generating an additional modulated optical signal with an intensity corresponding to a normalized value of 1, modulating an additional photodetector in the plurality of photodetectors array based on a respective bias value corresponding to the group of N weights in the M-by-1 bias matrix, and generating a respective bias result by the additional photodetector detecting the additional modulated optical signal, the bias result corresponding to a multiplication of the value of 1 and the respective bias value, and the respective electrical output is generated based on the sum of the N respective results from the group of N photodetectors and the respective bias result from the additional photodetector, and where the group of N photodetectors and the additional photodetector are arranged in a same area.

In some implementations, the respective electrical output corresponds to an element of the computation result

$$α ( {Σ}_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, where i is an integer in a range from 1 to M, and j is an integer in a range from 1 to N.

In some implementations, directing the N modulated optical signals to each group of N photodetectors includes: sequentially directing, by an optical element, the N modulated optical signals to each group of N photodetectors.

In some implementations, directing the N modulated optical signals to each group of N photodetectors includes: directing, by the at least one optical element, each of the N modulated optical signals to a respective photodetector of each group of N photodetectors.

In some implementations, the at least one optical element includes at least one of an optical diffuser, an optical dot projector, an elliptical/circular lens, or a microlens array, and where the plurality of photodetectors include a microlens array.

In some implementations, the photonic system further includes a plurality of optical sources or optical modulators. Each of the N modulated optical signals is generated by at least one of modulating a respective optical source of the plurality of optical sources based on the respective input element of the N input elements in the input matrix, or modulating an input optical signal based on the respective input element of the N input elements in the input matrix by a respective optical modulator of the plurality of optical modulators.

In some implementations, each of the N modulated optical signals has a respective wavelength, at least two of respective wavelengths of the N modulated optical signals being different.

In some implementations, each of the N modulated optical signals has a same wavelength.

Another aspect of the present disclosure features a photonic system, including: a plurality of photodetectors; and a control circuitry coupled to the plurality of photodetectors, where the plurality of photodetectors are configured to detect at least one modulated optical signal, the at least one modulated optical signal representing one or more input elements of an input matrix of a mathematical function, the plurality of photodetectors being configure to be modulated based on weight elements of a weight matrix of the mathematical function, where the control circuitry is configured to generate electrical outputs based on outputs of the plurality of photodetectors, the electrical outputs representing a computation result of the mathematical function corresponding to a multiplication of the input matrix and the weight matrix, and where the control circuitry includes a digital-to-analog converter (DAC) circuit having an output electrically coupled to a plurality of devices including one of (i) a plurality of optical sources, (ii) a plurality of optical modulators, or (iii) a subset of the plurality of photodetectors, where the output provides a modulation signal configured to modulate the plurality of devices, and where the modulation signal represents (i) a particular input element of the input matrix or (ii) a particular weight element of the weight matrix.

In some implementations, the modulation signal represents the particular weight element of the weight matrix, where the output of the DAC circuit is electrically coupled to the subset of the plurality of photodetectors, where an input element in the input matrix includes multiple values, and where a number of the subset of the plurality of photodetectors correspond to a number of the multiple values in the input element, and the photonic system further includes: multiple optical sources or optical modulators configured to be modulated respectively with first electrical signals from the control circuitry to generate multiple modulated optical signals, where each of the multiple modulated optical signals represents a respective value of the multiple values of the particular input element in the input matrix, and at least one optical element configured to direct the multiple modulated optical signals respectively to the subset of the plurality of photodetectors, each of the subset of the plurality of photodetectors being modulated by the modulation signal, where the subset of the plurality of photodetectors is configured to generate outputs each corresponding to a multiplication of the particular weight element in the weight matrix and the respective value of the input element.

In some implementations, the control circuitry includes an analog-to-digital converter (ADC) circuit configured to convert the outputs from the subset of the plurality of photodetectors into corresponding digital values, and the control circuitry is configured to generate a digital result corresponding to a multiplication of the input matrix and the weight matrix.

In some implementations, the plurality of photodetectors includes multiple photodetector arrays, and the output of the DAC circuit is electrically coupled to each of the multiple photodetector arrays.

In some implementations, the plurality of optical sources or the plurality of optical modulators are formed on separate substrates.

In some implementations, the plurality of optical sources or plurality of optical modulators, the plurality of photodetectors, the control circuitry, one or more processing units, and one or more memory units are integrated on an interposer.

In some implementations, the modulation signal represents the particular input element of the input matrix, where the output of the DAC circuit is electrically coupled to the plurality of optical sources or the plurality of optical modulators, and the photonic system is configured to perform operations including: modulating the plurality of optical sources or the plurality of optical modulators with the modulation signal from the control circuitry to generate multiple modulated optical signals each representing the particular input element of the input matrix; directing the multiple modulated optical signals respectively to the subset of photodetectors of the plurality of photodetectors, each of the subset of photodetectors being modulated based on a respective weight element in the weight matrix corresponding to the particular input element in the input matrix; and generating outputs by the subset of photodetectors, the outputs from the subset of photodetectors corresponding to a multiplication of the particular input element and the weight elements associated with the particular input element.

In some implementations, the DAC circuit is configured to generate, at the output, the modulation signal based on a digital value corresponding to the particular input element of the input matrix.

In some implementations, the control circuitry includes an analog-to-digital converter (ADC) circuit configured to convert the outputs from the subset of the plurality of photodetectors into corresponding digital values, and the control circuitry is configured to generate a digital result corresponding to a multiplication of the input matrix and the weight matrix.

In some implementations, the photonic system further includes at least one optical element configured to direct the multiple modulated optical signals respectively to the subset of the plurality of photodetectors, where the at least one optical element includes an optical diffuser, an optical dot projector, an elliptical/circular lens, or a microlens array, and the subset of the plurality of photodetectors include a microlens array.

In some implementations, the plurality of photodetectors form a photodetector array, and the subset of the plurality of photodetectors are formed in a same area of the photodetector array.

In some implementations, each of the multiple optical sources or the multiple optical modulators is formed on a same substrate.

In some implementations, the multiple optical sources or multiple optical modulators, the plurality of photodetectors, the control circuitry, one or more processors, one or more memory devices are integrated on an interposer.

Another aspect of the present disclosure features a method for performing computations using a photonic system, the method including: providing, by a first output of a digital-to-analog circuitry to a plurality of photodetectors, first input electrical signals representing a first weight value of a weight matrix of a mathematic function; providing, by a plurality of outputs of the digital-to-analog circuitry to a plurality of optical emitters, second input electrical signals representing input elements of an input matrix of the mathematical function; generating, by the plurality of optical emitters and based on the second electrical signals, optical signals towards the plurality of photodetectors to perform matrix computations; generating, by the plurality of photodetectors in response to receiving the optical signals, output electrical signals representing results of the matrix computations; and providing, by the plurality of photodetectors to an analog-to-digital circuitry, the output electrical signals.

Another aspect of the present disclosure features a photonic system configured to perform the method of any one of the implementations as disclosed above.

In some implementations, each of the plurality of photodetectors is formed in a different pixel array.

In some implementations, each of the plurality of optical emitters is formed on a different substrate.

In some implementations, the plurality of photodetectors are formed in a pixel array.

In some implementations, the plurality of optical emitters are formed on a substrate.

In some implementations, the plurality of photodetectors, the plurality of optical emitters, the digital-to-analog circuitry, the analog-to-digital circuitry, one or more processors, and one or more memory elements are formed on an interposer.

Another aspect of the present disclosure features a method for performing computations using a photonic system, the method including: providing, by a first output of a digital-to-analog converter (DAC) circuitry to a plurality of optical emitters, first input electrical signals representing a first input value of an input matrix of a mathematic function; providing, by a plurality of outputs of the digital-to-analog circuitry to a plurality of photodetectors, second input electrical signals representing weight elements of a weight matrix of the mathematical function; generating, by the plurality of optical emitters and based on the first input electrical signals, optical signals towards the plurality of photodetectors to perform matrix computations; generating, by the plurality of photodetectors in response to receiving the optical signals, output electrical signals representing results of the matrix computations; and providing, by the plurality of photodetectors to an analog-to-digital circuitry, the output electrical signals.

Another aspect of the present disclosure features a photonic system, including: a plurality of photodetectors each configured to represent a respective place value in a binary format having a plurality of digits; and a plurality of modulation elements each configured to control, based on a corresponding digit value or place value in a binary number having the binary format, one or more of (i) optical signals received by a corresponding photodetector of the plurality of photodetectors or (ii) electrical signals generated by the corresponding photodetector of the plurality of photodetectors.

In some implementations, each of the plurality of photodetectors has a respective optical fill factor that represents the corresponding place value.

In some implementations, each of the plurality of photodetectors includes a respective number of grouped pixels that represents the corresponding place value.

In some implementations, each of the plurality of photodetectors has a respective conversion gain that represents the corresponding place value.

In some implementations, the plurality of modulation elements include spatial light modulators.

In some implementations, the plurality of modulation elements include gating circuitry configured to control a flow of the electrical signals generated by plurality of photodetectors.

In some implementations, an optical source or an optical emitter can include a laser source such as an edge-emitting laser (EEL) or a Vertical-Cavity Surface-Emitting Laser (VCSEL), or a light emitting diode (LED). In some implementations, an array of optical sources or optical emitters can include, e.g., a VCSEL array, a LED array, or a Micro-LED array. An optical signal from the optical source or optical emitter can have a wavelength in the visible (e.g., wavelength range from 380 nm to 780 nm, or any similar wavelength range as defined by a particular application), the near-infrared (NIR, e.g., wavelength range from 780 nm to 1000 nm, or any similar wavelength range as defined by a particular application), the shortwave infrared (SWIR, e.g., wavelength range from 1000 nm to 3000 nm, or any similar wavelength range as defined by a particular application), and/or the mid-wave infrared (MIR, e.g., wavelength range from 3000 nm to 5000 nm, or any similar wavelength range as defined by a particular application).

In some implementations, a photodetector includes a photodiode, a lock-in Photodiode (LIPD), an avalanche photodiode (APD), a single-photon avalanche diode (SPAD), or a phototransistor. The photodetector can include a germanium (Ge)-based absorption region formed in/on a silicon substrate, a silicon-based absorption region, an III-V compound material based absorption region, and/or a quantum dots based absorption region. The photodetector can have one-tap or multi-taps (e.g., two-taps, four-taps, eight-taps) configuration. The photodetector can be a nonlinear photodetector such as a phototransistor, or a photodiode, LIPD, APD, or SPAD configured to have a linear photo-response.

In some implementations, as a nonlinear photodetector, a phototransistor is implemented based on Si or Ge homojunctions, e.g., for visible, near infrared (NIR), and short-wave infrared (SWIR) light. In some implementations, a phototransistor is implemented based on Ge/Si as heterojunction separate absorption and multiplication (SAM) or separate absorption, charge, and multiplication (SACM), e.g., for NIR or SWIR light. In some implementations, a phototransistor is implemented based on InGaAs/InP as heterojunction SAM or SCAM, e.g., for NIR or SWIR light.

In some implementations, as a linear photodetector, an APD is configured to be operated in a linear or Geiger mode. The photodiode, LIPD, APD, or SPAD can be implemented based on Si or Ge homojunctions (e.g., for visible/NIR/SWIR light), Ge/Si as heterojunction SAM or SACM (e.g., for NIR or SWIR light), or InGaAs/InP as heterojunction SAM or SCAM (e.g., for NIR or SWIR light).

In some implementations, a processing unit includes a central processing unit (CPU), a graphics processing unit (GPU), a multi-core Processor, a data processing unit (DPU), a tensor processing unit (TPU), a quantum processing unit (QPU), an Application Specific Integrated Circuit (ASIC), a Field Programmable Gate Array (FPGA), a microprocessor, or a combination thereof.

In some implementations, a memory unit or device includes a high bandwidth memory (HBM), a Dynamic random-access memory (DRAM), a Static random-access memory (SRAM), NAND flash memory, a NOR flash memory, a Phase-change memory (PCM), a Resistive Random-Access Memory (ReRAM), a Ferroelectric RAM (FRAM), Magnetoresistive Random Access Memory (MRAM), a capacitor based memory, a latch/flip-flop based memory, a floating-gate based memory, any other memory devices, or a combination thereof.

In some implementations, the control circuitry includes a Complementary Metal-Oxide-Semiconductor (CMOS) device. In some implementations, the control circuitry includes at least one of a processing unit, a memory unit, a transimpedance amplifier (TIA) and/or an Analog Front-End (AFE) in analog-to-analog domain, an analog-to-digital converter (ADC) and/or a time-to-digital converter (TDC) or a time digitizer (TD) in time-to-digital domain, and/or a Digital-to-Analog Converter (DAC) and/or a Light-emitting/Laser Diode Diver (LDD) circuit in digital-to-analog domain, a normalized circuit, a nonlinearity circuit if the nonlinearity is done at a circuit level, or any combination thereof.

In the present disclosure, M and m represent a same integer, and N and n represent a same integer. M can be smaller than, identical to, or greater than N. i is an integer in a range from 1 to m, and j is an integer in a range from 1 to n.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1A illustrates an example of a neural network having multiple layers.

FIG. 1B illustrates an example mathematical function between two adjacent layers of the neural network of FIG. 1A and example physical implementations.

FIGS. 2A-2B illustrate example photonic computing implementations for a neural network using photodetectors for nonlinearity generation.

FIGS. 3A-3B illustrate example photonic computing implementations for a neural network using electrical circuits for nonlinearity generation.

FIG. 4A is a schematic diagram of an example unipolar photonic computing system using single photodetectors.

FIG. 4B illustrates an example time-based photonic computing implementation using the photonic computing system of FIG. 4A.

FIG. 4C illustrates an example space-based photonic computing implementation using the photonic computing system of FIG. 4A.

FIG. 5A is a schematic diagram of an example bipolar photonic computing system using balanced photodetectors.

FIG. 5B is a schematic diagram of another example bipolar photonic computing system using balanced photodetectors.

FIG. 6A is a schematic diagram of an example single nonlinear phototransistor (NPT).

FIG. 6B is a schematic diagram of an example balanced nonlinear phototransistor (balanced NPT).

FIG. 7 is a schematic diagram of an example photonic computing system with a photodetector array modulated based on a weight matrix.

FIG. 8 is a schematic diagram of another example photonic computing system with a photodetector array modulated based on a weight matrix.

FIG. 9 is a schematic diagram of another example photonic computing system with an array of balanced photodetectors modulated based on a weight matrix.

FIG. 10 illustrates an example multi-tap photodetector.

FIG. 11A illustrates an example complimentary measurement using a multi-tap photodetector with amplitude modulation for photonic computing.

FIG. 11B illustrates another example complimentary measurement using a multi-tap photodetector with phase modulation for photonic computing.

FIG. 12A illustrates a scheme of an example complimentary measurement with photo-current response using a multi-tap photodetector.

FIG. 12B illustrates a scheme of an example complimentary measurement with dark current compensation using a multi-tap photodetector.

FIG. 13A illustrates a scheme of an example symmetric measurement with photo-current response using a multi-tap photodetector.

FIG. 13B illustrates a scheme of an example symmetric measurement with dark current compensation using a multi-tap photodetector.

FIG. 14A is a schematic diagram of an example system with an example digital-to-analog converter (DAC) sharing scheme for photonic computing.

FIG. 14B is a schematic diagram of an example system with another example digital-to-analog converter (DAC) sharing scheme for photonic computing.

FIG. 15 illustrates an example DAC scheme using binary DAC.

FIG. 16A is a schematic diagram of an example photonic computing system with area illumination for parallel computation.

FIG. 16B is a schematic diagram of an example photonic computing system with array illumination for parallel computation.

FIGS. 17A-17C are flowcharts of example processes for photonic computing.

Like reference numbers and designations in the various drawings indicate like elements. It is also to be understood that the various exemplary implementations shown in the figures are merely illustrative representations and are not necessarily drawn to scale.

### DETAILED DESCRIPTION

Reference will now be made in detail to implementations, examples of which are illustrated in the accompanying drawings. In the following detailed description, numerous specific details are set forth to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the implementations.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description.

Implementations of the present disclosure are described herein according to the following general outline:
I. General Overview
II. Example Neural Network with Photonic Computing Implementations
III. Example Unipolar and Bipolar Photonic Computing Systems
IV. Photonic Computing with Example Normal Incident Photodetectors
V. Photonic Computing with Example Multi-Tap Photodetectors
VI. Example digital-to-analog converter (DAC) Schemes
   1) DAC Sharing Schemes
   2) Binary DAC Scheme
VII. Example Photonic Computing Systems with Spatial-Spatial Mapping
VIII. Example Processes for Photonic Computing

### I. General Overview

Implementations of the present disclosure provide methods, circuits, devices, systems and techniques for photonic computing, e.g., in neural networks. Photonic computing leverages light to transmit and process information. Unlike electronic systems that use electrons and suffer from heat dissipation and bandwidth limitations, photonic computing systems offer inherent advantages, including but not limited to: massive parallelism, high-speed signal propagation at the speed of light, and reduced energy consumption. These properties make photonic computing a promising platform for accelerating neural network computations, where matrix multiplications and data-intensive operations dominate.

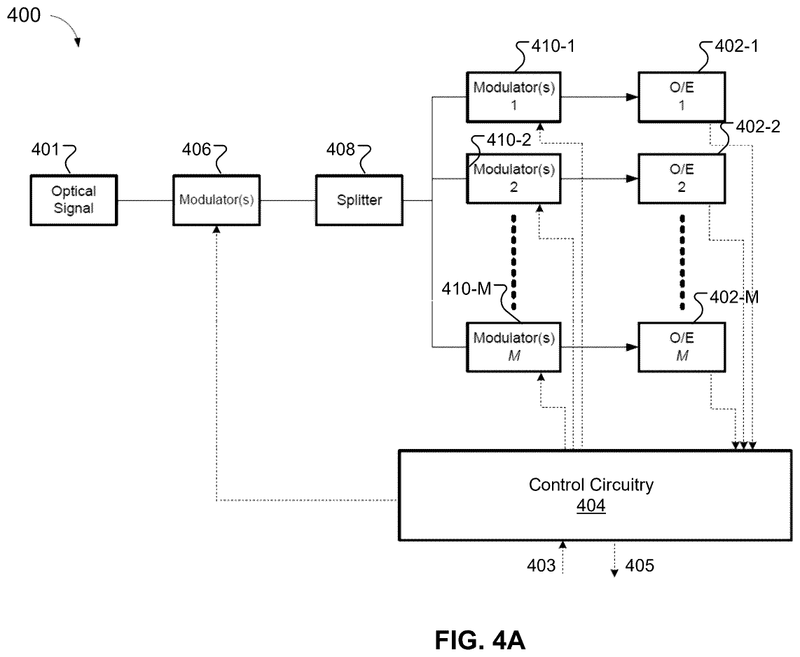

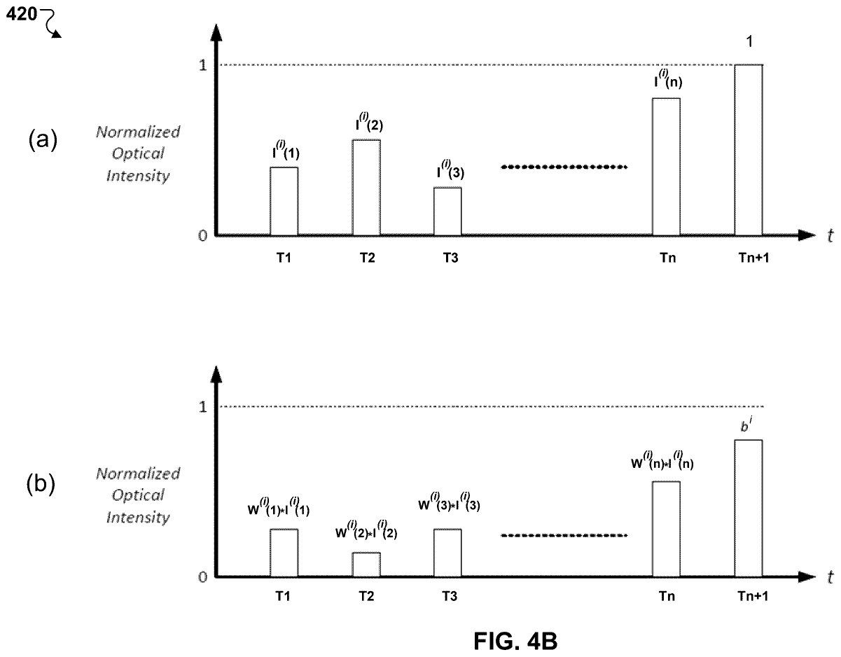

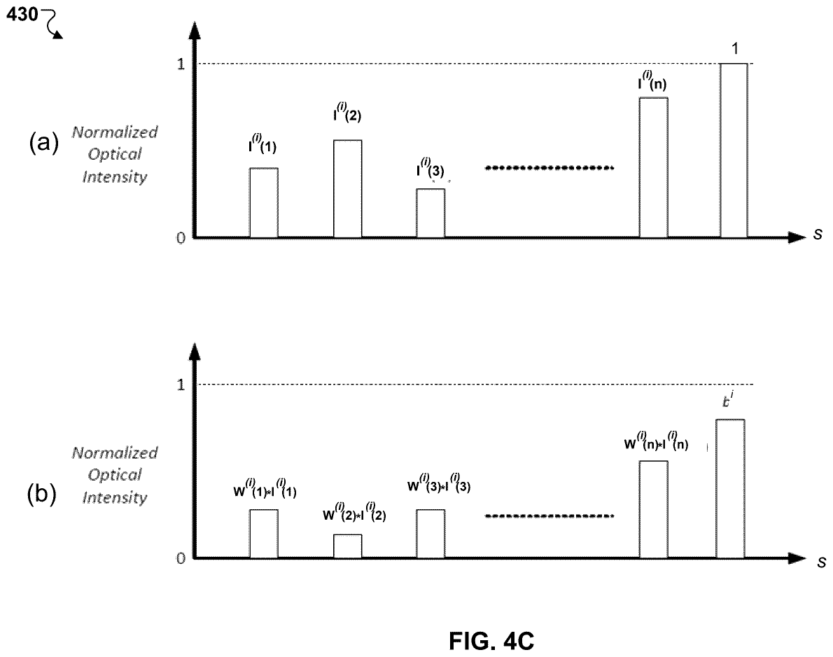

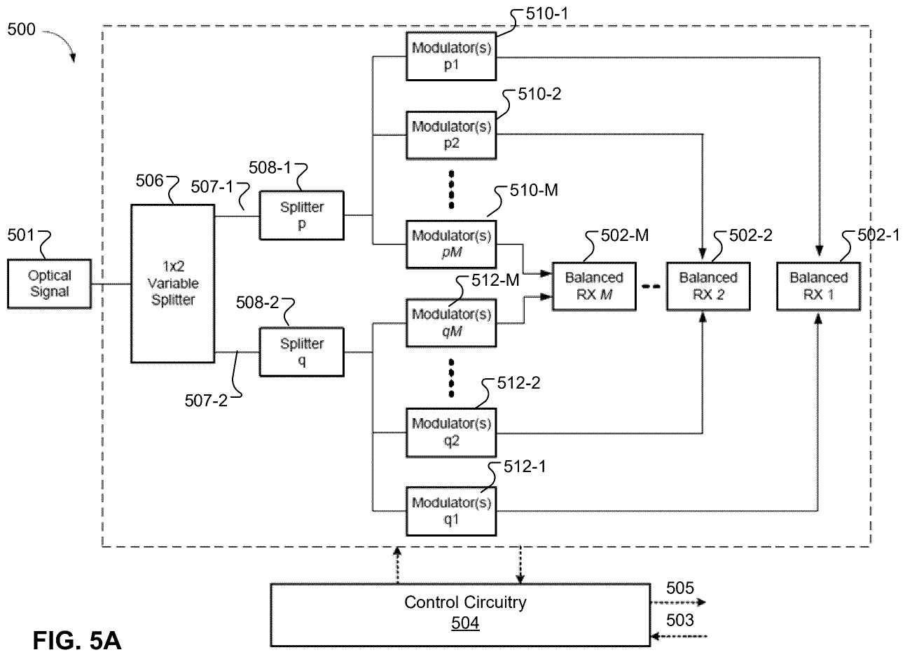

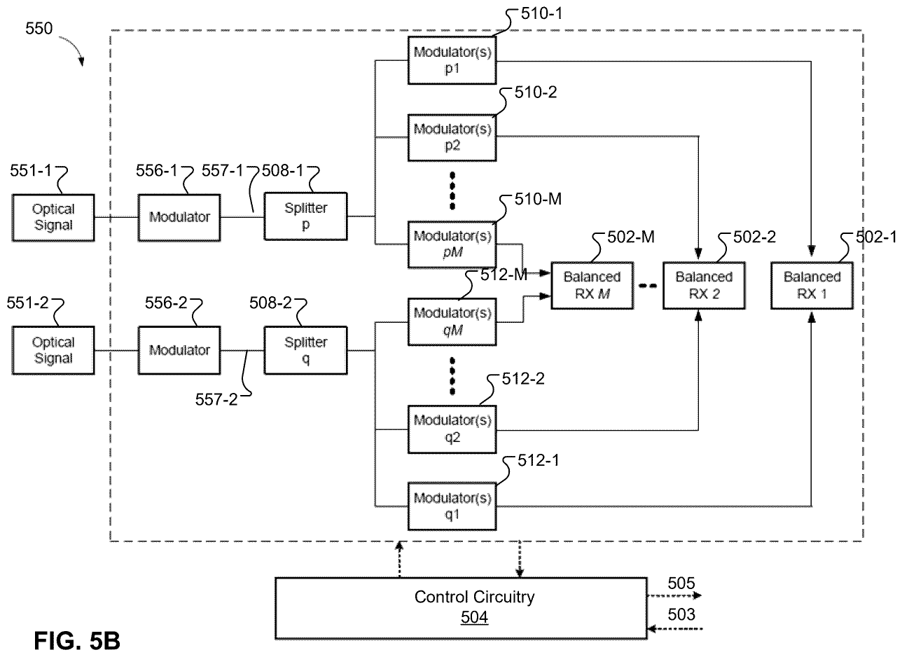

In a photonic computing process performed by a photonic computing system, an optical signal or an optical source (such as optical lasers) can be modulated with input information associated with an input matrix of a mathematical function to generate at least one modulated optical signal. In some implementations, e.g., as illustrated with further details with respect to FIGS. 4A, 5A, 5B, the at least one modulated optical signal can be further modulated with weight information associated with a weight matrix of the mathematical function to generate at least one second modulated optical signal that can be detected by photodetectors. The photodetectors can convert detected optical signals to electrical signals that may be further processed by a control circuitry to generate electrical outputs. The electrical outputs can represent a computation result of the mathematical function corresponding to a multiplication of the input matrix and the weight matrix.

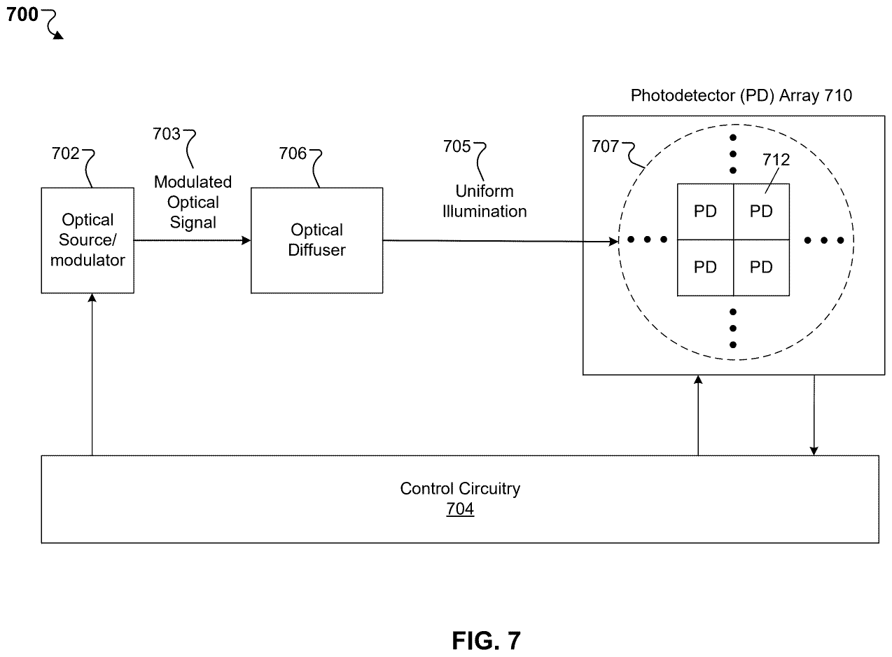

In some implementations, e.g., as illustrated with further details with respect to FIGS. 7-9, 14A-14B, 16A-16B, instead of further modulating optical signals using the weight information of the weight matrix, the photodetectors can be modulated based on the weight matrix of the mathematical function and then used to detect the at least one modulated optical signal representing one or more input elements in the input matrix to generate electrical signals that can be processed by the control circuitry to generate corresponding electrical results that represent the computation result of the mathematical function.

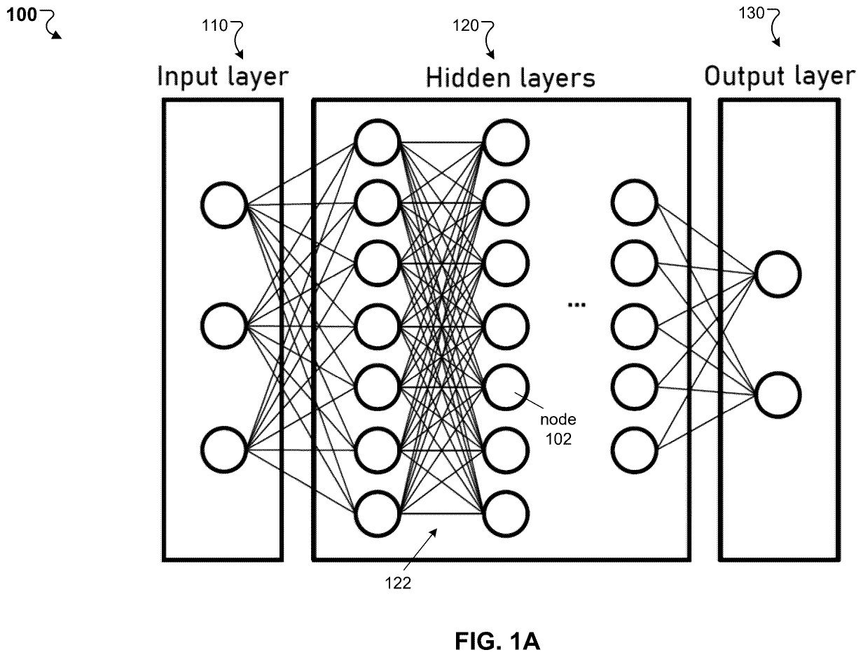

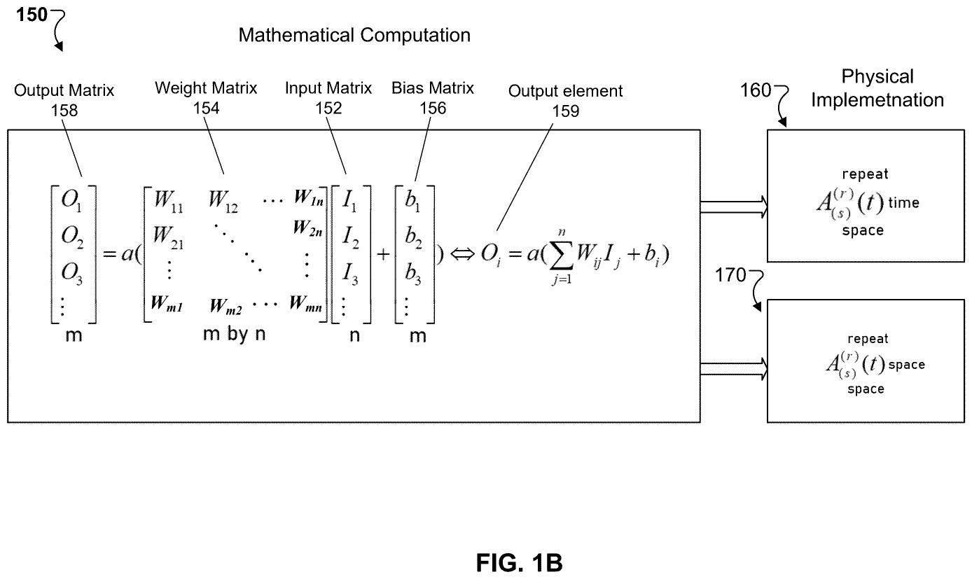

In some implementations, to complete the computation of multiplying the input matrix (e.g., N-by-1 input matrix) and the weight matrix (e.g., M-by-N weight matrix), the photonic computing process can utilize temporal degrees of freedom, e.g., as illustrated with further details with respect to FIGS. 1B, 4B, spatial degrees of freedom, e.g., as illustrated with further details with respect to FIGS. 1B, 4C, 16A, 16B, or a combination thereof. For each photonic computing process, respective input information associated with corresponding input elements in the input matrix and respective weight information associated with corresponding groups of weight elements in the weight matrix can be modulated into corresponding optical signals and/or photodetectors.

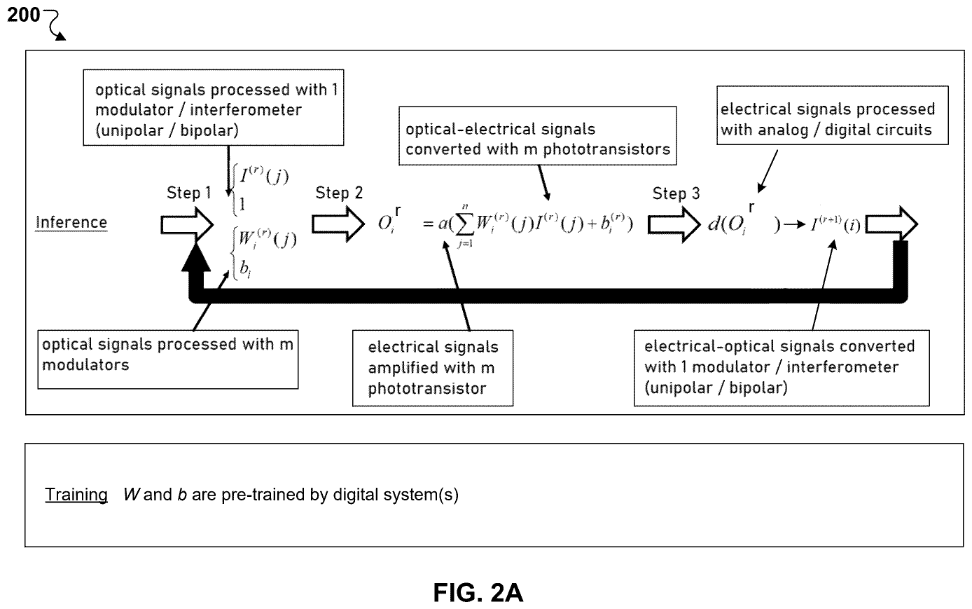

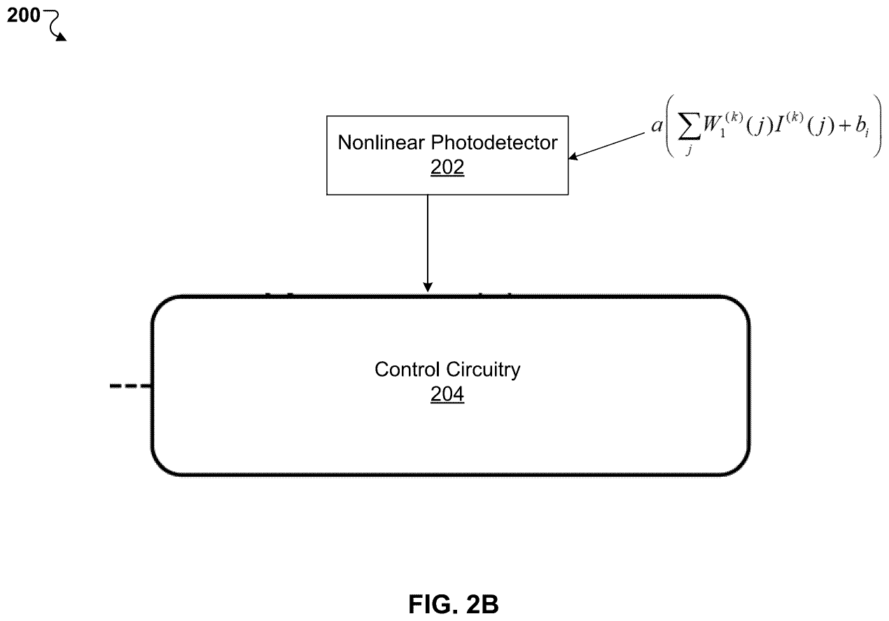

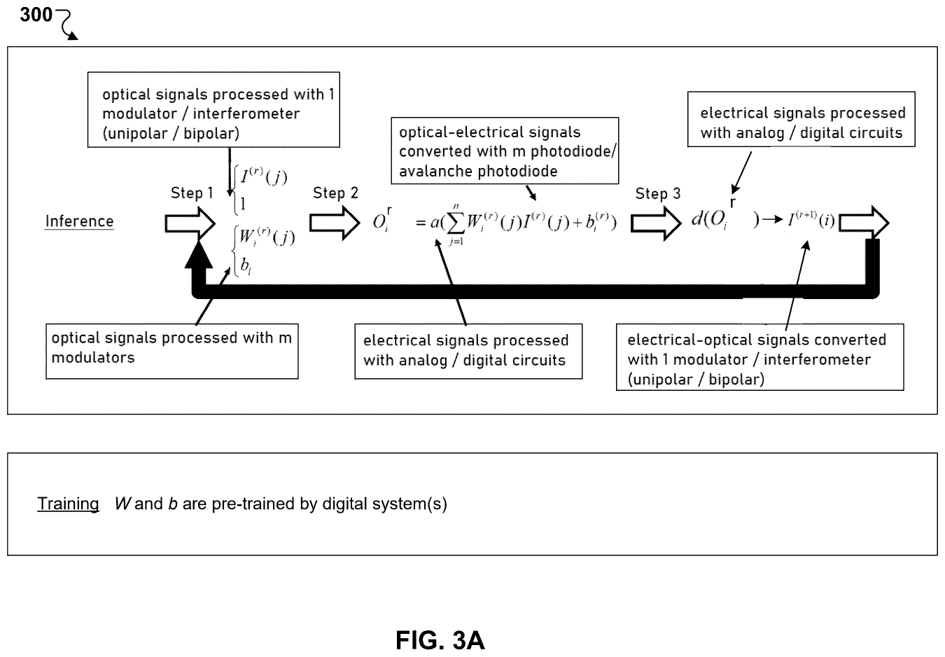

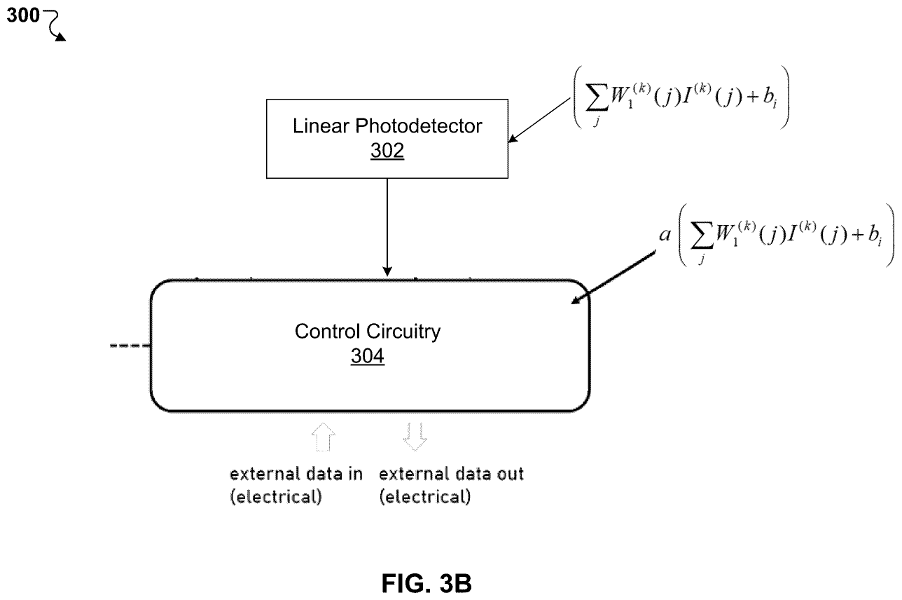

In some implementations, an activation function of the mathematical function is implemented by the photodetectors. The activation function can include nonlinearity or a nonlinear function (e.g., a ReLU function, a Sigmoid function, etc.). For example, as illustrated with further details with respect to FIGS. 2A-2B, each of the photodetectors can include a nonlinear phototransistor configured based on the activation function of the mathematical function, and the control circuitry is configured to generate the electrical outputs based on the outputs of the nonlinear phototransistors. In some implementations, the activation function of the mathematical function is implemented by the control circuitry. For example, as illustrated with further details with respect to FIGS. 3A-3B, each of the photodetectors can include a photodiode, LIPD, APD, or SPAD configured to have a linear photo-response, and the control circuitry is configured to generate the electrical outputs based on the outputs of the plurality of photodetectors and the activation function of the mathematical function.

In some implementations, to increase a range of input elements of the input matrix, e.g., from a normalized range [0, 1] to another normalized range [−1, 1], a pair of modulated optical signals representing a same input element of the input matrix can be generated and detected by a balanced photodetector, e.g., as illustrated with further details with respect to FIGS. 5A, 5B, 6B and 9. The balanced photodetector can be configured to have a linear photo-response or a nonlinear photo-response.

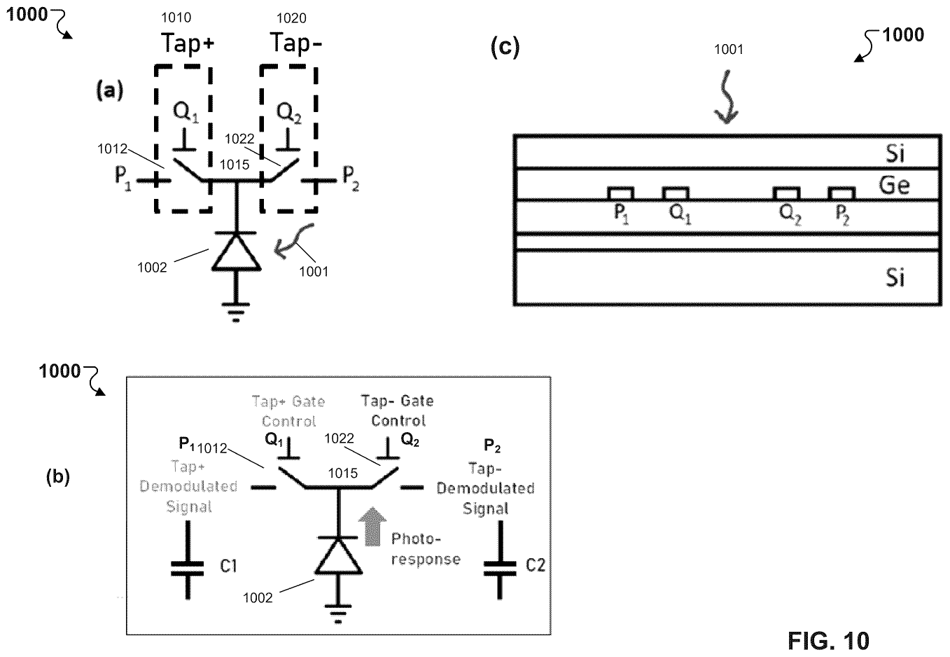

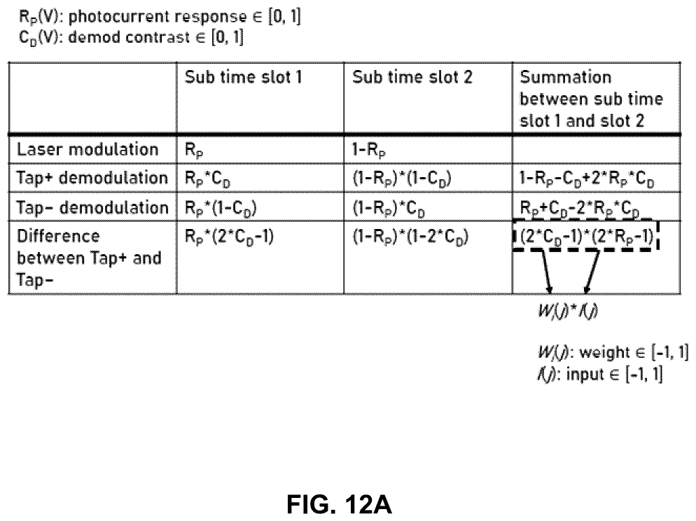

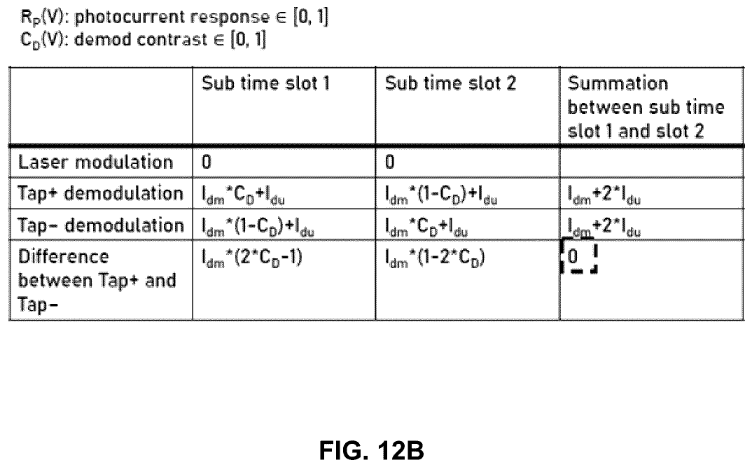

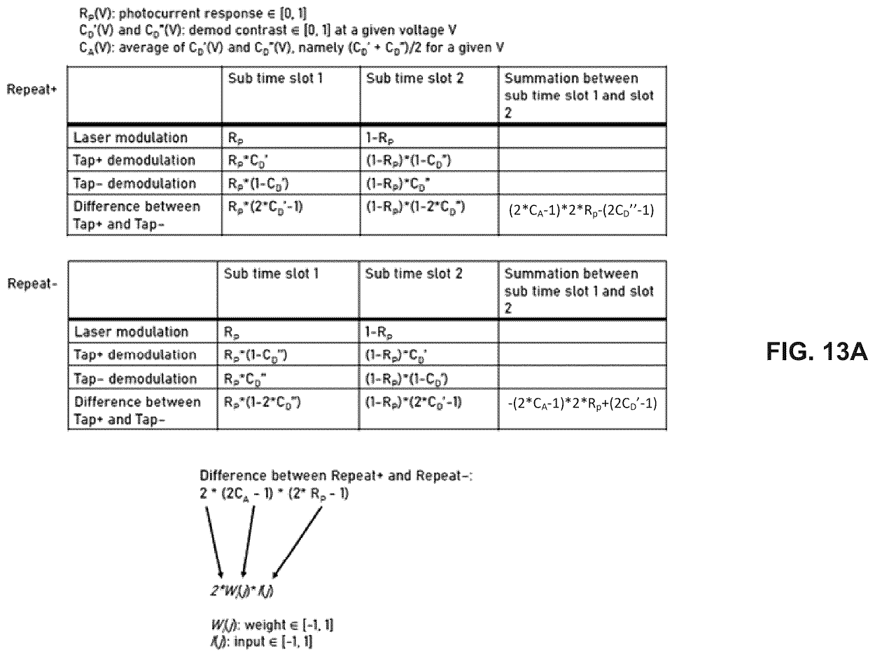

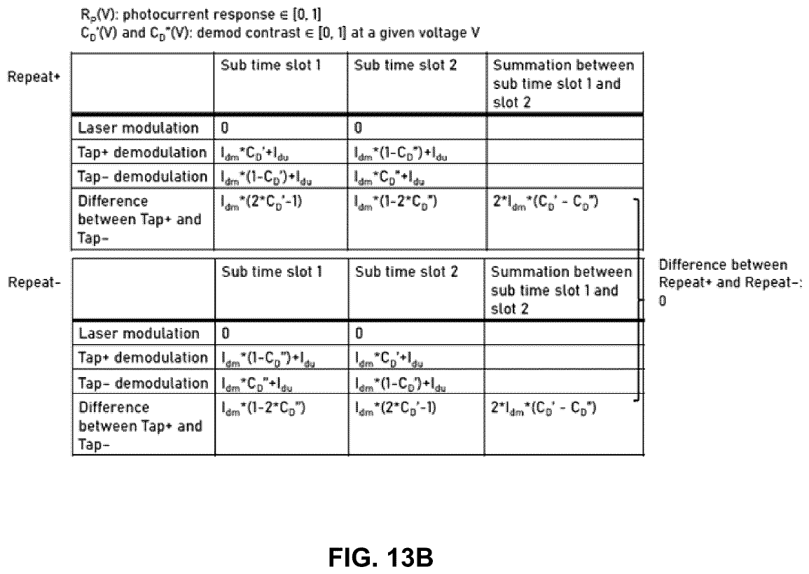

In some implementations, a multi-tap photodetector can be used to detect an individual modulated optical signal during sequential time slots, e.g., as illustrated with further details with respect to FIGS. 10 to 16B, which can increase a range of input elements of the input matrix (e.g., I(j) with a normalized value in [−1, 1]) and/or a range of weight elements of the weight matrix (e.g., Wᵢ(j) with a normalized value in [−1, 1]), e.g., as illustrated in FIG. 12A. Moreover, dark current information can be cancelled out by a complementary measurement in the sequential time slots, e.g., as illustrated in FIGS. 12B and 13B, such that an output obtained by the multi-tap photodetector based on the complementary measurement can include no such dark current information. Further, a symmetric measurement (e.g., including multiple complementary measurements) can be performed using the multi-tap photodetector to address any asymmetry between different taps of the multi-tap photodetector, e.g., as illustrated with further details with respect to FIGS. 13A-13B.

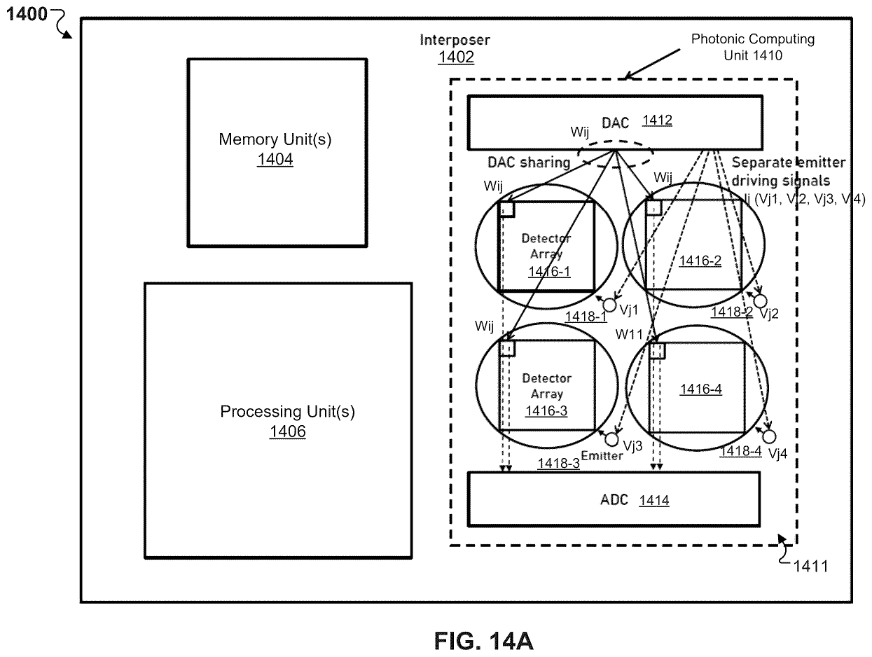

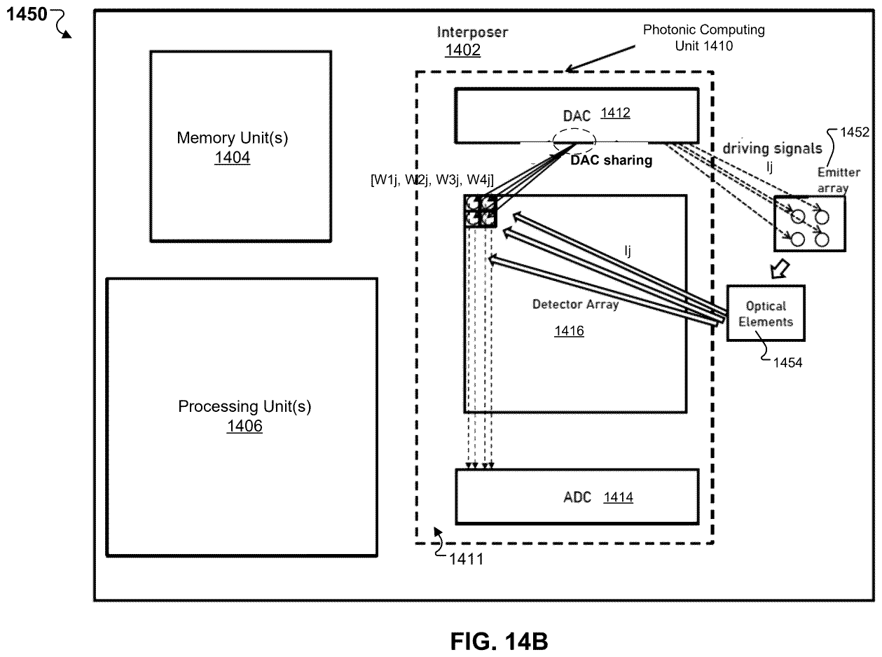

In some implementations, optical signals can be transmitted in the photonic computing system, e.g., be directed to the photodetectors, in a photonic integrated circuit (PIC). At least part of optical components in the photonic computing system (e.g., optical modulators, optical splitters, and/or photodetectors) can be integrated in the photonic integrated circuit, e.g., as illustrated with further details with respect to FIGS. 4A, 5A, 5B. The optical components can have a waveguide structure that can be made of any suitable material, e.g., an insulator material such as polymer, glass, sapphire, oxide, nitride, a metallic material such as Au, Ag, or a semiconductor material such as Si, Ge, or III-V, or a nonlinear material such as LiNbO₃, BaTiO₃. The control circuitry can be integrated in an electrical integrated circuit (EIC), and the photonic integrated circuit and the electrical integrated circuit are integrated in a chip package, which can be called a neural processing unit (NPU). In some implementations, one or more processing units and one or more memory devices can be integrated with the control circuitry, the chip package, or the NPU in an interposer, e.g., as illustrated with further details with respect to FIGS. 14A-14B. The control circuitry can include a Complementary Metal-Oxide-Semiconductor (CMOS) device, a latch-based memory such as Static Random-Access memory (SRAM), and a capacitor-based memory such as dynamic random-access memory (DRAM).

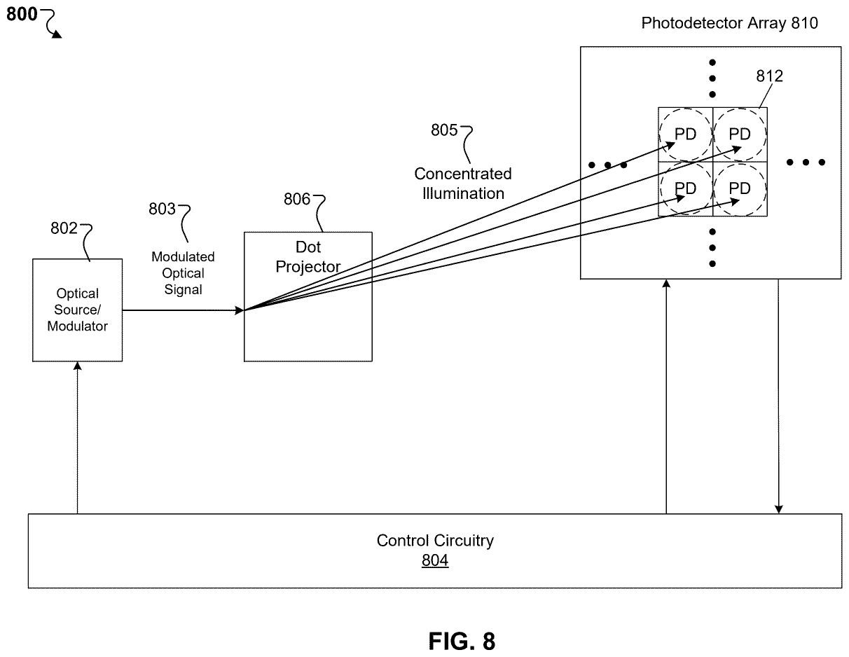

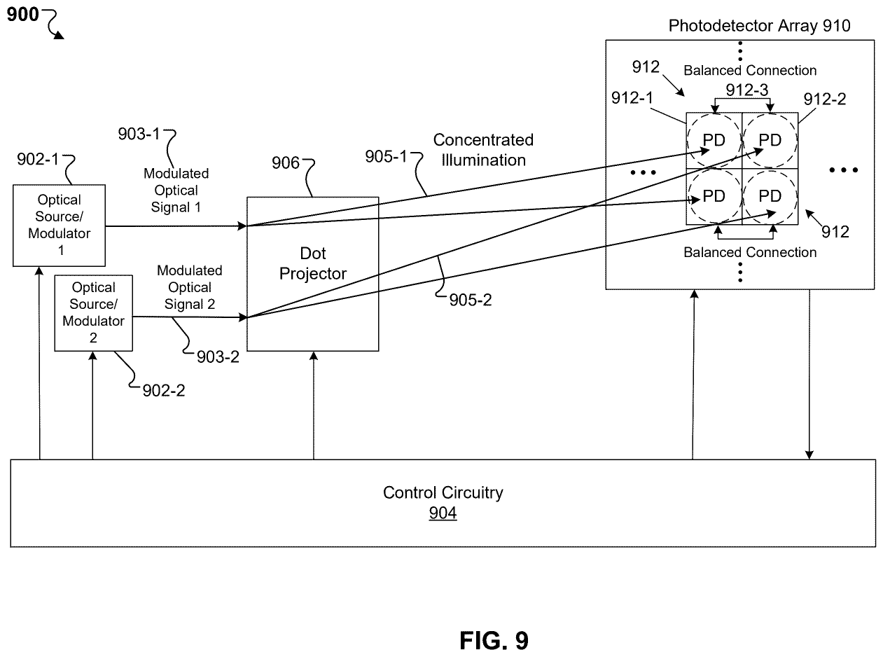

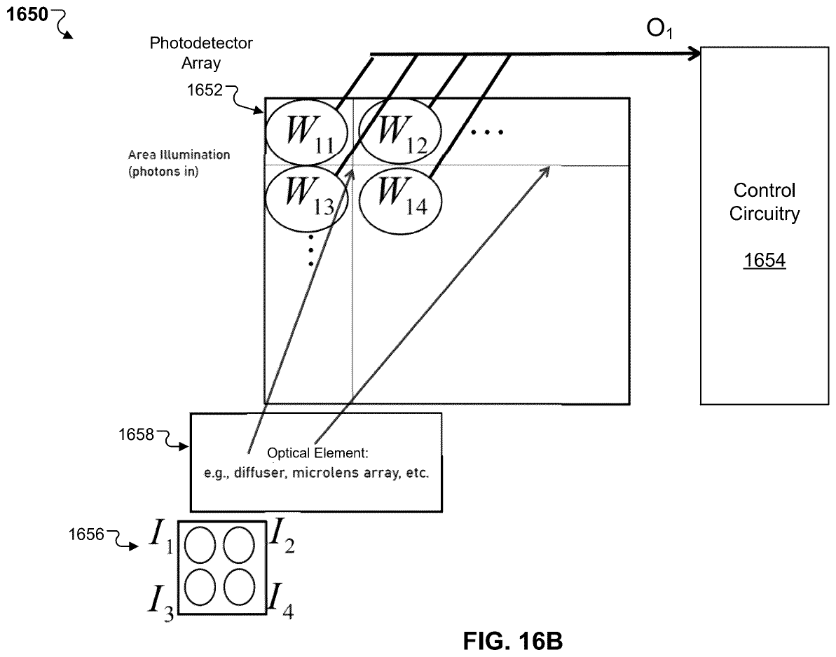

In some implementations, optical signals can be transmitted in the photonic computing system, e.g., be directed to the photodetectors, in free space. For example, as illustrated with further details with respect to FIGS. 7, 8, 9, 14A, 14B, 16A, 16B, the optical signals can be directed to the photodetectors using optical elements, e.g., an optical diffuser (FIG. 7), an optical dot projector (FIGS. 8, 9), an elliptical/circular lens (FIGS. 14A, 16A), and/or a microlens array (FIGS. 14B, 16B), and the photodetectors can include a microlens array. In some cases, an optical signal can be directed to uniformly illuminate one or more photodetectors, e.g., a photodetector array as illustrated with further details with respect to FIG. 7, an area of photodetectors as illustrated with further details with respect to FIG. 16A, or an array of photodetectors as illustrated with further details with respect to FIG. 16B. In some cases, an optical signal can be directed with concentrated illumination on individual photodetectors, e.g., as illustrated with further details with respect to FIGS. 8, 9.

The control circuitry can be configured to generate and/or store input information associated with the input matrix, weight information associated with the weight matrix, and/or bias information associated with a bias matrix. In some implementation, the bias matrix can be merge into the original weight matrix to form a new weight matrix. In some implementations, the control circuitry includes a digital-to-analog converter (DAC) circuit configured to convert digital values associated with input elements of the input matrix and/or weight elements of the weight matrix into analog electrical signals to output corresponding modulation signals that can be used to modulate optical signals and/or photodetectors. In some implementations, DAC sharing schemes can be implemented in the photonic computing system, which can effectively save DAC power and enable performing vector-matrix computation in parallel. As an example, outputs for weight information from the DAC circuit can be shared across multiple photodetector arrays, e.g., as illustrated with further details with respect to FIGS. 14A and 14B.

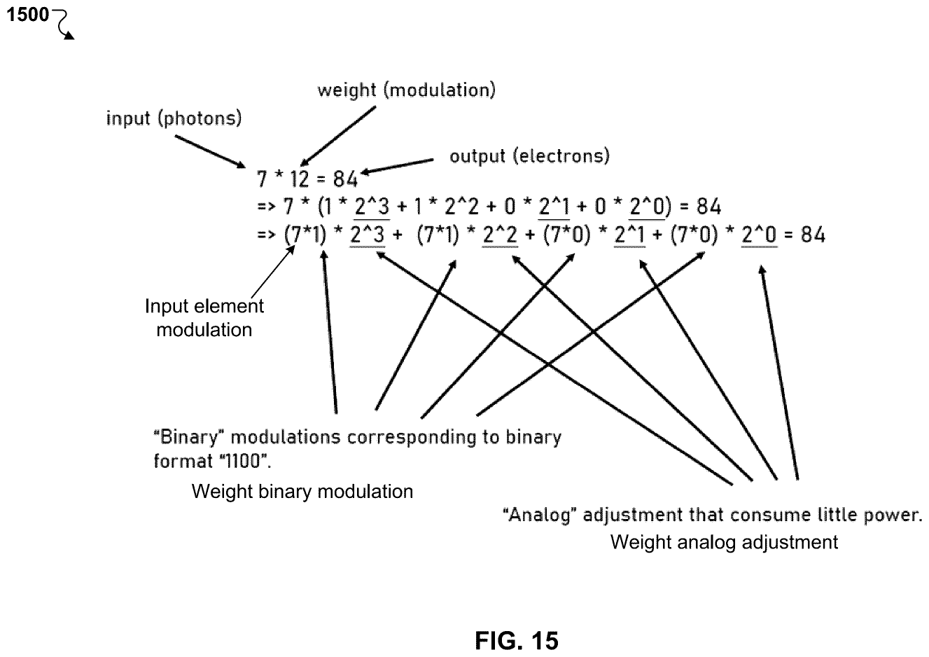

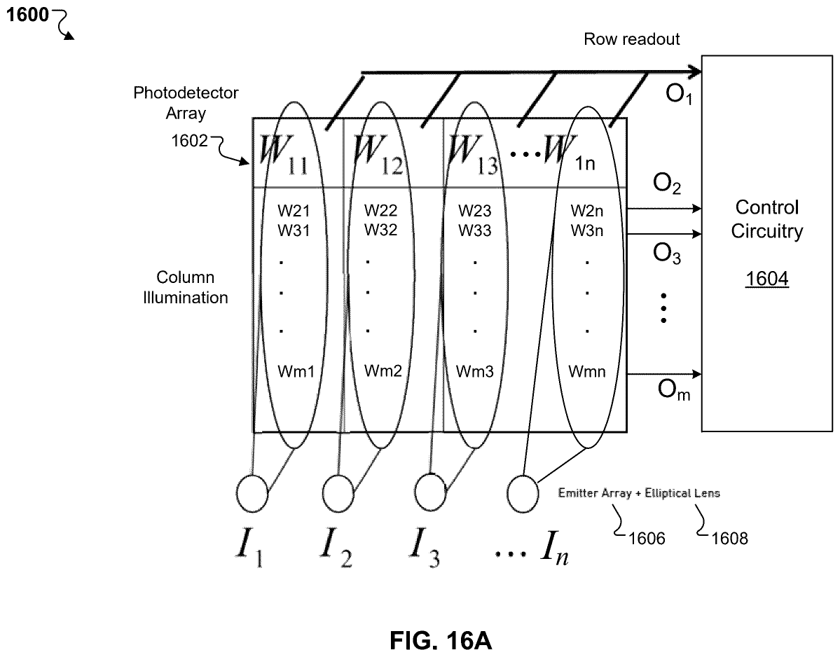

In some implementations, a DAC output can be represented in a binary format. One or more optical sources or signals can be modulated to represent an input element of the input matrix in time and/or in space, and/or one or more photodetectors can be modulated with a binary format in combination of individual power factors to represent a weight element of the weight matrix in time and/or in space, e.g., as illustrated with further details with respect to FIG. 15. In such a way, the DAC circuit can provide outputs in a large range with a limited power scaling (e.g., DAC power scaling by b instead of 2\hat{ }b, where b is the number of binary bits used to represent a number).

The photonic computing process can be used for matrix computation between adjacent layers in a neural network, e.g., as illustrated with further details with respect to FIG. 1A. For example, each set of connections between any two intermediate layers can be mathematically represented by a mathematical function including an input matrix, a weight matrix and optionally a bias matrix, and an output matrix, e.g., as illustrated with further details with respect to FIG. 1B, which can be physically implemented by the photonic computing system in time and/or in space.

In the present disclosure, Multiply-Accumulate (MAC) function is described as an example of a mathematical function. Note that the techniques implemented in the present disclosure can be also applied for computation of any other suitable functions. Besides photonic computation of a multiplication of a vector and a matrix, the techniques can be also used to photonically compute a multiplication of a first matrix and a second matrix, or a first vector and a second vector.

### II. Example Neural Network with Photonic Computing Implementations

Neural networks are machine learning models that include one or more layers of neurons that compute neuron output activations from weighted sums of a set of input activations. These computations can correspond to Multiply-Accumulate (MAC) operations. For a given neural network, the flow of activations between nodes and layers is fixed. Further, once training of the neural network is complete, the neuron weights in the weighted summation, and any other parameters associated with computing the activations, are likewise fixed. The neural network can be then used for inference. The MAC operations can be performed on input data and the fixed neuron weights in the trained neural network to infer a target output.

FIG. 1A illustrates an example of a neural network 100 having multiple layers. As shown in FIG. 1A, the neural network 100 is a collection of connected units or nodes 102, which can be also called neurons. The nodes 102 are organized in layers. In some implementations, different layers of the neural network 100 perform different kinds of transformations on their inputs. One of the layers is a first or input layer of the neural network, e.g., input layer 110, while another layer is a last or output layer of the neural network, e.g., output layer 130. The neural network 100 can include one or more intermediate layers (or hidden layers) 120 between the input layer 110 and the output layer 130.

In some implementations, a set of input data is presented to the neural network 100, e.g., at the input layer 110. A series of computations is performed at each subsequent layer such as 120. In the fully-connected neural network 100 illustrated in FIG. 1A, an output computation from each node in a previous layer is presented to all nodes in the subsequent layer, and the subsequent layer can be obtained by performing a corresponding computation based on the previous layer and a mathematical function 122 representing a relationship between nodes in the previous layer and nodes in the subsequent layer.

FIG. 1B illustrates an example mathematical function 150 between two adjacent layers of the neural network 100 of FIG. 1A and example physical implementations. The mathematical function 150 can be the mathematical function 122 of FIG. 1A. As shown in FIG. 1B, the mathematical function 150 includes an input matrix 152, a weight matrix 154, and an output matrix 158. In some cases, the mathematical function 150 also includes a bias matrix 156. The mathematical function 150 can be a Multiply-Accumulate operation (MAC) function, where the output matrix 158 is a computation result of a sum of the input matrix 152 multiplying the weight matrix 154 and the bias matrix 156.

In some implementations, the input matrix 152 is an N-by-1 input matrix that includes n input elements, I₁, I₂, . . . , Iₙ, the weight matrix 154 is an M-by-N weight matrix that includes an array of weight elements Wᵢⱼ, the bias matrix 156 is an M-by-1 bias matrix that includes m bias values, b₁, b₂, b₃, . . . , bₘ, and the output matrix 158 is an M-by-1 output matrix that includes m output elements, O₁, O₂, O₃, . . . , Oₘ, where each of m and n is an integer, i is an integer in a range from 1 to m, and j is an integer in a range from 1 to n. In the present disclosure, M and m represent a same integer, and N and n represent a same integer, where m can be smaller than, identical to, or greater than n. Each output element Oᵢ 159 in the output matrix 158 can be represented as:

$${O}_{i} = α ( {Σ}_{j = 1}^{N} {W}_{i} ( j ) I ( j ) + {b}_{i} ) ,$$

where α represents an activation function of the mathematical function, I(j) represents a j-th element in the N-by-1 input matrix 152, Wᵢ(j) represents an i,j-th element Wᵢⱼ in the M-by-N weight matrix 154, bᵢ represents a i-th element in the M-by-1 bias matrix 156.

As shown in the mathematical function 150, each input element Iⱼ is associated with (or corresponds to) a corresponding column of weight elements in the weight matrix W₁ⱼ, W₂ⱼ, W₃ⱼ, . . . , Wₘⱼ, and multiplying with the column of weight elements. For example, I₁ is multiplying with W₁₁, W₂₁, W₃₁, . . . , Wₘ₁. Thus, the multiplication between Iⱼ and the column of weight elements W₁ⱼ, W₂ⱼ, W₃ⱼ, . . . , Wₘⱼ can be performed in parallel in a computation, e.g., as illustrated in FIG. 4A, 5A, 5B, 7, 8, 9, 14A, 14B, or 16A, 16B. Each weight element Wᵢⱼ in the M-by-N weight matrix 154 is associated with (or corresponds to) and multiplying with a respective input element Iⱼ in the N-by-1 input matrix 152. Each output element Oᵢ is based on a sum of multiplication results of the n input elements I₁, I₂, . . . , Iₙ and a row of weight elements Wᵢ₁, Wᵢ₂, Wᵢ₃, . . . , Wᵢₙ and a corresponding bias value bᵢ.

In a time-based MAC computation 160, by repeating the computation for a number of times (e.g., n times) with an optical signal modulated with respective input information associated with the n input elements, I₁, I₂, . . . , Iₙ, and with an optical or electrical signal modulated with respective weight information associated with the n weight elements, Wᵢ₂, Wᵢ₃, . . . , Wₙₙ, e.g., as illustrated in FIG. 4B, the multiplication of the input matrix 152 and the weight matrix 154 can be completed.

In a space-based MAC computation 170, repeating the computation for a number of spaces (e.g., n spaces) with an optical signal modulated with respective input information associated with the n input elements, I₁, I₂, . . . , Iₙ, and with an optical or electrical signal modulated respective to weight information associated with the n weight elements, Wᵢ₂, Wᵢ₃, . . . , Wᵢₙ, e.g., as illustrated in FIG. 4C, the multiplication of the input matrix 152 and the weight matrix 154 can be completed.

Furthermore, in a space-based MAC computation 170, n modulated optical signals respectively representing the n input elements, I₁, I₂, . . . , Iₙ can be generated, e.g., as illustrated in FIG. 4C. In some cases, the n modulated optical signals have a same wavelength. In some cases, at least two modulated optical signals have different wavelengths. In some implementations, each of the n modulated optical signals Iⱼ can be further split into a respective group of M optical signals, and modulated (optically) based on a corresponding group of M weight elements Wᵢⱼ, W₂ⱼ, W₃ⱼ, . . . , Wₘⱼ. Each of M photodetectors can be configured to detect the corresponding N modulated optical signals to get an accumulated result representing a corresponding output element Oᵢ. In some implementations, for each of the n modulated optical signals Iⱼ, a group of M photodetectors can detect and be modulated (electrically) based on a corresponding group of M weight elements Wᵢⱼ, W₂ⱼ, W₃ⱼ, . . . , Wₘⱼ. An output element Oᵢ can be represented by a sum of outputs from a corresponding group of N modulated photodetectors.

In some implementations, the mathematical function 150 is computed by a time-based computation 160 as noted above. In some implementations, the mathematical function 150 is computed by a spaced-based computation 170 as noted above. In some implementations, the mathematical function 150 is computed in a combination of a time-based computation and a space-based computation.

In some implementations, the mathematical function 150 includes an activation function that can be a nonlinear function such as a ReLU function. The activation function can be physically implemented by at least one of a photodetector, e.g., as illustrated in FIGS. 2A-2B, or an electrical circuit, e.g., as illustrated in FIGS. 3A-3B. For illustration, nonlinearity is described as an example of the activation function.

FIGS. 2A-2B illustrate example photonic computing implementations for a neural network using photodetectors for nonlinearity generation. The neural network can be the neural network 100 of FIG. 1A. For a machine learning model, the neural network can be first trained by one or more digital systems to determine weight elements in a weight matrix (e.g., the weight matrix 154 of FIG. 1B) and optionally bias values in a bias matrix (e.g., the bias matrix 156 of FIG. 1B). A photonic system 200 can be configured to perform inference based on the trained neural network using photonic computation. The photonic system can be also called as a photonic computing system.

In some implementations, the photonic system 200 includes at least one optical source configured to generate at least one optical signal, photodetectors 202 configured to detect modulated optical signals, and a control circuitry 204 configured to generate electrical outputs based on outputs of the photodetectors. The photonic system 200 can further include optical modulators configured to modulate optical signals. The photonic system can also include optical splitters configured to split a single optical signal into multiple optical signals. In some implementations, the photonic system includes, but not limited to, an intensity modulator, an optical interferometer such as Mach-Zehnder interferometer (MZI), a unitary switch (US), a nonlinear phototransistor (NPT), or a star coupler (SC). Note that the MZI and US can be configured to be a variable optical splitter, the NPT can be a nonlinear photodetector, and the SC can be configured to be an optical splitter. In some implementations, an optical source can be an optical emitter such as a laser source such as an Edge-Emitting Laser (EEL), a Vertical-Cavity Surface-Emitting Laser (VCSEL), or a light emitting diode (LED). In some implementations, the photonic system 200 includes an array of optical sources or optical emitters, e.g., an EEL array, a VCSEL array, a LED array, or a Micro-LED array.

The control circuitry 204 can include one or more memory units configured to store weight information representing weight elements in the weight matrix and bias information representing bias values in the bias matrix. The control circuitry 204 can also include one or more processing units or be connected to one or more processing units. The one or more processing units can be configured to process data, e.g., input data associated with an input matrix, and generate data, e.g., output data associated with an output matrix. The one or more processing units can include, but not limited to, e.g., a central processing unit (CPU), a graphics processing unit (GPU), a multi-core processor, a data processing unit (DPU), a tensor processing unit (TPU), a quantum processing unit (QPU), an Application Specific Integrated Circuit (ASIC), a Field Programmable Gate Array (FPGA), a microprocessor, or any other processing device, or a combination thereof. The one or more memory units can include, but not limited to, high bandwidth memory (HBM), Dynamic random-access memory (DRAM), Static random-access memory (SRAM), NAND flash memory, NOR flash memory, Phase-change memory (PCM), Resistive Random-Access Memory (ReRAM), Ferroelectric RAM (FRAM), Magnetoresistive Random Access Memory (MRAM), a capacitor based memory, a latch/flip-flop based memory, a floating-gate based memory, any other memory devices, or a combination of thereof. The control circuitry 204 can be a Complementary Metal-Oxide-Semiconductor (CMOS) device. In some implementations, the control circuitry 204 can include, but not limited to, a transimpedance amplifier (TIA) and/or an Analog Front-End (AFE) in analog-to-analog domain, an analog-to-digital converter (ADC) and/or a time-to-digital converter (TDC) or a time digitizer (TD) in time-to-digital domain, and/or a Digital-to-Analog Converter (DAC) and/or a Light-emitting/Laser Diode Driver (LDD) circuit in digital-to-analog domain, a normalized circuit, a nonlinearity circuit if the nonlinearity is done at a circuit level, or any combination thereof.

The photonic system 200 can compute a mathematical function (e.g., the mathematical function 122 of FIG. 1A or 150 of FIG. 1B) between adjacent layers (e.g., the intermediate layers 120) in the neural network. A previous layer can be an input matrix (e.g., the input matrix 152 of FIG. 1B) and used as an input into the photonic system 200, and the photonic system 200 can compute a corresponding mathematical function and output a computation result as an output matrix (e.g., the output matrix 158 of FIG. 1B) that can be used as input matrix of a subsequent layer. The letter “r” in FIG. 2A represents the r-th computation cycle in the neural network, where r is an integer.

In some implementations, at step 1, as illustrated in FIG. 2A and with further details with respect to FIGS. 4A, 5A, and 5B, one or more optical signals can be first modulated with input information associated with an input element Iⱼ of the input matrix or a normalized value “1” for the bias matrix by an intensity modulator for a unipolar system (e.g., as illustrated in FIG. 4A) or an optical interferometer for a bipolar system (e.g., as illustrated in FIG. 5A or 5B) to get one or more first modulated optical signals. Each first modulated optical signal can be further modulated with weight information associated with a group of M weights W₁ⱼ, W₂ⱼ, . . . , Wₘⱼ in the weight matrix or bias information associated with a bias value bᵢ of the bias matrix by m weight modulators (e.g., as illustrated in FIG. 4A, 5A, or 5B) to generate m second modulated optical signals.

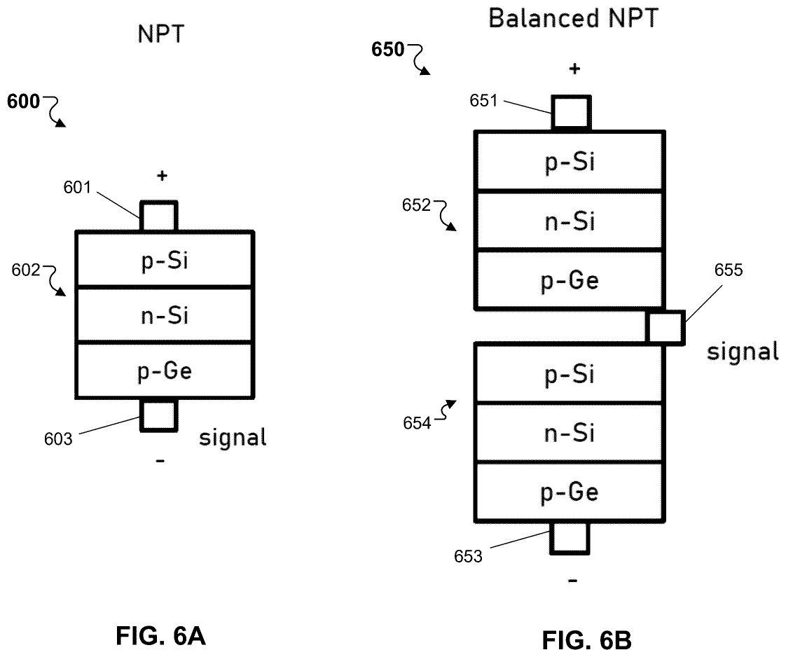

At step 2, each weight modulator can be coupled to a corresponding nonlinear photodetector 202 that can detect a corresponding second modulated optical signal to generate a corresponding electrical signal. The nonlinear photodetectors 202 can include phototransistors (e.g., as illustrated with further details with respect to FIGS. 6A) to realize the nonlinearity or activation function of the mathematical function. In some other examples, the nonlinear photodetectors 202 can be Single-photon avalanche diodes (SPADs) or any other type of nonlinear optical detectors. Each nonlinear photodetector 202 of m nonlinear photodetector in the photonic system 200 can be configured to generate an output electrical signal by accumulating n+1 electrical signals based on n+1 corresponding second modulated optical signals that are associated with n input elements I₁, I₂, . . . Iₙ of the input matrix and the normalized value “1” and n weight elements Wᵢ₁, Wᵢ₂, . . . , Wᵢₙ and a bias value bᵢ. The sum of the n+1 electrical signals represents a result of

$${Σ}_{j = 1}^{N} {W}_{i} ( j ) I ( j ) + {b}_{i} .$$

As discussed in FIG. 1B, the accumulation can be implemented in time and/or in space. The nonlinear photodetector 202 can be configured based on the nonlinearity or the activation function of the mathematical function to amplify the sum of the n+1 electrical signals to therefore generate the output electrical signal representing an output element

$${O}_{i} = α ( {Σ}_{j = 1}^{N} {W}_{i} ( j ) I ( j ) + {b}_{i} ) ,$$

where α represents nonlinearity or the activation function of the mathematical function, e.g., as illustrated in FIGS. 2A and 2B.

At step 3, the control circuitry 204 coupled to the m nonlinear photodetector 202 is configured to receive the m output electrical signals from the m nonlinear photodetector 202. The control circuitry 204 can include an ADC circuit to convert the m output electrical signals into m digital values representing m output elements of the output matrix. As noted above, the output matrix can be used as an input matrix of a subsequent layer. The control circuitry 204 can also include a DAC circuit configured to convert the m digital values into m electrical control signals to control the intensity modulator or the optical interferometer to modulate the optical signal for a next photonic computation using the photonic system 200, e.g., as illustrated in FIG. 2A. In some implementations, the control circuitry 204 may process the m digital values and provide the processed digital values to the DAC circuit for further processing.

FIGS. 3A-3B illustrate example photonic computing implementations for a neural network using electrical circuits for nonlinearity generation. The neural network can be the neural network 100 of FIG. 1A. Similar to the neural network of FIGS. 2A-2B, the neural network in FIGS. 3A-3B can be first trained by one or more digital systems to determine weight elements in a weight matrix (e.g., the weight matrix 154 of FIG. 1B) and optionally bias values in a bias matrix (e.g., the bias matrix 156 of FIG. 1B). A photonic system 300 can be configured to perform inference based on the trained neural network using photonic computation. The photonic system 300 can be also called as a photonic computing system.

The photonic system 300 can be similar to the photonic system 200 of FIGS. 2A-2B, except that the photonic system 300 includes a linear photodetector 302 and a control circuitry 304 configured to implement a nonlinearity or activation function of the mathematical function. The photodetector 302 can be a photodiode or an avalanche photodiode (APD) configured to be operated in a linear or Geiger mode. The photodiode or APD can be implemented based on Si or Ge homojunctions (e.g., for visible/NIR/SWIR light), Ge/Si as heterojunction SAM or SACM (e.g., for NIR or SWIR light), or InGaAs/InP as heterojunction SAM or SCAM (e.g., for NIR or SWIR light).

The control circuitry 304 can be similar to the control circuitry 204 of FIG. 2B. Different from the control circuitry 204, the control circuitry 304 can be configured to implement an electrical nonlinear activation function in one or more ways. In some implementations, the control circuitry can read from a nonlinear capacitor connected to the linear photodetector 302, e.g., a metal-oxide-semiconductor (MOS) capacitor. An output voltage of the nonlinear capacitor as a function of input charge can become nonlinear, due to the increase of depletion region in a semiconductor region when there are more input charges. In some implementations, an output optical power of a laser source is a nonlinear function of input current that can be like a shifted ReLU (rectified linear unit) function, due to the laser threshold to nonlinearly transition from spontaneous emission to stimulated emission. That is, the control circuitry can control the input current to realize the nonlinear activation of the ReLU function. The control circuitry can also include any other nonlinear components, e.g., limiting amplifiers. In some implementations, instead of using an optical source and a photodetector as a photo-current source, electrical circuits can be also used as electric-current source for computation.

In some implementations, at step 1 of FIG. 3A, similar to step 1 of FIG. 2A, one or more optical signals can be first modulated with input information associated with an input element Iⱼ of the input matrix or a normalized value “1” for the bias matrix by an intensity modulator for a unipolar system (e.g., as illustrated in FIG. 4A) or an optical interferometer for a bipolar system (e.g., as illustrated in FIG. 5A or 5B) to get one or more first modulated optical signals. Each first modulated optical signal can be further modulated with weight information associated with a group of M weights W₁ⱼ, W₂ⱼ, . . . , Wₘⱼ in the weight matrix or bias information associated with a bias value bᵢ of the bias matrix by m weight modulators (e.g., as illustrated in FIG. 4A, 5A, or 5B) to generate m second modulated optical signals.

At step 2 of FIG. 3A, each weight modulator can be coupled to a corresponding linear photodetector 302 that can detect a corresponding second modulated optical signal to generate a corresponding electrical signal. Each linear photodetector 302 of m linear photodetectors in the photonic system 300 can be configured to generate an output electrical signal by accumulating n+1 electrical signals based on n+1 corresponding second modulated optical signals that are associated with n input elements I₁, I₂, . . . Iₙ of the input matrix and the normalized value “1” and n weight elements Wᵢ₁, Wᵢ₂, . . . , Wᵢₙ and a bias value bᵢ. The output electrical signal as the sum of the n+1 electrical signals, represents a result of

$${Σ}_{j = 1}^{N} {W}_{i} ( j ) I ( j ) + {b}_{i} .$$

As discussed in FIG. 1B, the accumulation can be implemented in time and/or in space. The control circuitry 304 coupled to the m linear photodetectors 302 is configured to receive m output electrical signals from the m linear photodetectors 302.

Different from the photonic system 200 using a nonlinear photodetector 202, the control circuitry 304 can be configured based on the nonlinearity or the activation function of the mathematical function to process the output electrical signal from each photodetector 302 to therefore generate an electrical signal representing an output element

$${O}_{i} = α ( {Σ}_{j = 1}^{N} {W}_{i} ( j ) I ( j ) + {b}_{i} ) ,$$

where α represents nonlinearity or the activation function of the mathematical function, e.g., as illustrated in FIGS. 3A and 3B.

At step 3, the control circuitry 304 can include an ADC circuit to convert m electrical signals into m digital values representing m output elements of the output matrix. As noted above, the output matrix can be used as an input matrix of a subsequent layer. The control circuitry 304 can also include a DAC circuit configured to convert the m digital values into m electrical control signals to control the intensity modulator or the optical interferometer to modulate the optical signal for a next photonic computation using the photonic system 300, e.g., as illustrated in FIG. 3A. In some implementations, the control circuitry 304 may process the m digital values and provide the processed digital values to the DAC circuit for further processing.

### III. Example Unipolar and Bipolar Photonic Computing Systems

FIG. 4A is a schematic diagram of an example unipolar photonic computing system 400 using single photodetectors. The photonic computing system 400 can be configured to perform a photonic computation of a mathematical function (e.g., the mathematical function 122 of FIG. 1A or 150 of FIG. 1B) between adjacent layers (e.g., the layers 120 of FIG. 1A) in a neural network (e.g., the neural network 100 of FIG. 1A). The photonic computing system 400 can be similar to, or same as, the photonic system 200 of FIGS. 2A-2B or 300 of FIGS. 3A-3B.

The photonic computing system includes a plurality of photodetectors 402-1, 402-2, . . . , 402-M (referred to generally as photodetectors 402 and individually as photodetector 402) and a control circuitry 404 coupled to the plurality of photodetectors 402. An activation function of the mathematical function can be implemented by at least one of the control circuitry 404 or the plurality of photodetectors 402. In some implementations, e.g., as illustrated in FIGS. 2A-2B, each of the plurality of photodetectors 402 includes a nonlinear phototransistor (e.g., the photodetector 202 of FIGS. 2A-2B) configured based on the activation function of the mathematical function, and the control circuitry 404 (e.g., the control circuitry 204 of FIGS. 2A-2B) is configured to generate electrical outputs based on outputs of the plurality of photodetectors 402. In some implementations, e.g., as illustrated in FIGS. 3A-3B, each of the plurality of photodetectors 402 includes a photodiode, LIPD, APD, or SPAD (e.g., the photodetector 302 of FIGS. 3A-3B) configured to have a linear photo-response, and the control circuitry 404 (e.g., the control circuitry 304 of FIGS. 3A-3B) is configured to generate electrical outputs based on outputs of the plurality of photodetectors and the activation function of the mathematical function.

In some implementations, the mathematical function includes an input matrix such as N-by-1 input matrix (e.g., the input matrix 152 of FIG. 1B), a weight matrix such as an M-by-N weight matrix (e.g., the weight matrix 154 of FIG. 1B), and an output matrix such as an M-by-1 output matrix (e.g., the output matrix 158 of FIG. 1B). The mathematical function can also include a bias matrix such as an M-by-1 bias matrix (e.g., the bias matrix 156 of FIG. 1B). Each of M and N is an integer. M can be smaller than, identical to, or greater than N.

In some implementations, e.g., as illustrated in FIG. 4A, the photonic computing system 400 further includes an intensity modulator 406 configured to modulate an input optical signal 401 with input information associated with the input matrix of the mathematical function to generate a first modulated input optical signal. The intensity modulator 406 is configured to vary an intensity (or optical power) of the input optical signal 401 based on a modulating signal (e.g., the input information), and can include an electro-optic modulator or an acousto-optic modulator. The control circuitry 404 is coupled to the intensity modulator 406 and configured to provide the input information to the intensity modulator 406, such that the intensity modulator 406 can modulate the input optical signal based on the input information. The input information can be associated with a corresponding input element of the input matrix, e.g., Iⱼ, where j is an integer in a range from 1 to n. The first modulated input optical signal can have an optical intensity corresponding to the corresponding input element of the input matrix. The optical intensity corresponds to a normalized value in a range from 0 to 1, e.g., [0, 1].

In some implementations, the photonic computing system 400 further includes an optical splitter 408 coupled to the intensity modulator 406 and configured to generate M first modulated optical signals based on the first modulated input optical signal. The optical splitter 408 can be an optical star coupler, a multi-mode interferometer (MMI), or any other types of suitable optical splitter that can be configured to uniformly distribute the first modulated input optical signal received at an input port into the M first modulated optical signals respectively at M output terminals.

In some implementations, the photonic computing system 400 further includes M weight modulators 410-1, 410-2, . . . , 410-M (referred to generally as weight modulators 410 and individually as weight modulator 410) each coupled to a respective output terminal of the optical splitter 408. Each weight modulator 410 is configured to modulate a respective first modulated optical signal with corresponding weight information associated with the weight matrix to generate a respective second modulated optical signal of M second modulated optical signals. The weight modulator 410 can be similar to, or same as, the intensity modulator 406.

The weight modulator 410 can include an electro-optic modulator or an acousto-optic modulator. The control circuitry 404 is coupled to each of the weight modulators 410 and configured to provide the weight information to a corresponding weight modulator 410-i, where i is an integer in a range from 1 to m, such that the corresponding weight modulator 410-i can modulate the respective first modulated optical signal based on the weight information to generate the respective second modulated optical signal. The weight information can be associated with a corresponding weight element of the weight matrix, e.g., Wᵢⱼ. The corresponding weight element can correspond to a normalized value in a range from 0 to 1, e.g., [0, 1]. The second modulated optical signal can have an optical intensity corresponding to a multiplication of the corresponding input element Iⱼ of the input matrix and the corresponding weight element Wᵢⱼ of the weight matrix, e.g., Wᵢⱼ*Iⱼ.

As shown in FIG. 4A, each of the M photodetectors 402 is coupled to a respective weight modulator 410-i of the M weight modulators 410 and configured to detect a corresponding second modulated optical signal from the respective weight modulator 410 to generate a respective result for the corresponding input element Iⱼ of the input matrix. A photodetector 402-i can accumulate N respective results by detecting N second modulated optical signals associated with N input element I₁, I₂, . . . , Iₙ multiplied with corresponding N weight elements Mᵢ₁, Mᵢ₂, . . . , Mᵢₙ, in time (e.g., as illustrated with further details with respect to FIG. 4B) or in space (e.g., as illustrated with further details with respect to FIG. 4C). The photodetector 402-i generates an output electrical signal based on the sum of the N respective results, e.g.,

$${\sum }_{j = 1}^{n} {W}_{i} ( j ) I ( j ) .$$

If the photodetector 402-i is a nonlinear photodetector such as a phototransistor, the photodetector 402-i can amplify the sum of the N respective results to implement the activation function of the mathematical function such that the output electrical signal represents a result of

$$α ( {\sum }_{j = 1}^{N} {W}_{i} ( j ) I ( j ) ) ,$$

e.g., as illustrated in FIGS. 2A and 2B. The control circuitry 404 can be coupled to the M photodetectors 402 and configured to generate electrical outputs based on the output electrical signals from the M photodetectors 402. The electrical outputs represent a computation result of the mathematical function corresponding to a multiplication of the input matrix and the weight matrix.

If the photodetector 402-i is a linear photodetector such as a photodiode, LIPD, APD, or SPAD configured to have a linear photo-response, the control circuitry 404 can be coupled to the photodetector 402-i and configured to generate an electrical output based on the output electrical signal from the photodetectors 402-i and the activation function. The electrical output represents a corresponding output element Oᵢ of the computation result of the mathematical function

$$α ( {\sum }_{j = 1}^{N} {W}_{i} ( j ) I ( j ) ) ,$$

e.g., as illustrated in FIGS. 3A and 3B.

In some implementations, the control circuitry 404 is configured to receive electrical data or signal 403 from an external device or system, and transmit electrical data or signal 405 to an external device or system. For example, the electrical data or signal 403 can include weight information of the weight matrix and/or bias information of the bias matrix, e.g., from a computing system that has trained the neural network. The control circuitry 404 can store the weight information of the weight matrix and/or bias information of the bias matrix in one or more memory units. The electrical data or signal 403 can also include a command or an inquiry from the external device or system, e.g., a command for starting inference of the neural network or an inquiry for an inference result or a computation result. The electrical data or signal 405 can include computation results generated by the photonic computing system 400. The control circuitry 404 can also provide the computation result of the mathematical function (e.g., the output matrix) as an input matrix of a next photonic computation (e.g., for a subsequent layer in the neural network), for example, as illustrated in FIG. 2A or 3A.

FIG. 4B illustrates an example time-based photonic computing implementation 420 using the photonic computing system 400 of FIG. 4A. As shown in FIG. 4A, in a computation process, the input optical signal 401 is first modulated by the intensity modulator 406 to generate a first modulated input optical signal that is further split by the optical splitter 408 into M first modulated optical signals along M optical paths. Along each optical path (e.g., an i-th optical path) of the M optical paths (where i is an integer from 1 to m), a corresponding first modulated optical signal is further modulated by a corresponding weight modulator 410-i to generate a corresponding second modulated optical signal that is received and detected by a corresponding photodetector 402-i of the M photodetectors 402.

In time-based photonic computation, the computation process is repeated for n times during n time periods, where n is identical to a number of N input elements in the input matrix. During each time period Tj of the n time periods (T1, T2, T3, . . . , Tn, where j varies from 1 to n), the optical signal 401 is modulated with respective input information associated with a respective input element Iⱼ in the N-by-1 input matrix to generate the first modulated input optical signal. The first modulated input optical signal is split into M first modulated optical signals into M optical paths. The M first modulated optical signals can have a same optical intensity. In an i-th optical path, the first modulated optical signal has a first intensity with a normalized value of Iⁱ(j) in a range of [0, 1]. If the first modulated optical signal is further modulated with respective weight information associated with a respective weight element Wᵢⱼ in the M-by-N weight matrix by the corresponding weight modulator 410-i to generate a corresponding second modulated optical signal that has a second intensity with a normalized value of Wⁱ(j)*Iⁱ(j) representing a multiplication Wᵢⱼ*Iⱼ of the respective element Iⱼ and the respective weight element Wᵢⱼ. The corresponding second modulated optical signal is received and detected by a corresponding photodetector 402-i to generate a respective result. The corresponding photodetector 402-i can accumulate the respective results over the n time periods to generate a respective output representing a sum of N respective results over the n time periods.

Diagram (a) of FIG. 4B shows the normalized value I′(j) of the first modulated optical signal in the i-th optical path over the n time periods, e.g., Iⁱ(1), Iⁱ(2), Iⁱ(3), . . . Iⁱ(n). Diagram (b) of FIG. 4B shows the normalized value Wⁱ(j)*Iⁱ(j) of the second modulated optical signal in the i-th optical path over the n time periods, e.g., Wⁱ(1)*Iⁱ(1), Wⁱ(2)*Iⁱ(2), Wⁱ(3)*Iⁱ(3), . . . , Wⁱ(n)*Iⁱ(n).

In some implementations, during an additional time period Tn+1 different from the N time periods, the input optical signal 401 can be modulated and split into M first modulated optical signals each having an intensity corresponding to a normalized value of 1, e.g., as illustrated in diagram (a) of FIG. 4B. The M first modulated optical signals in the M optical paths are respectively modulated based on M bias values of the M-by-1 bias matrix to generate M second modulated optical signals. In the i-th optical path of the M optical paths, the corresponding second modulated optical signal has a second intensity with a normalized value bⁱ, corresponding to the bias value bᵢ in the bias matrix, e.g., as illustrated in diagram (b) of FIG. 4B. The corresponding photodetector 402-i can further accumulate a respective bias result by detecting the corresponding second modulated optical signal during the Tn+1 time period, together with the respective results over the n time periods.

Thus, after the n+1 time periods, the corresponding photodetector 402-i can generate a respective output representing a sum of the n respective results over the n time periods and the respective bias result for the additional time period. The control circuitry 404 can receive the respective output from the corresponding photodetector 402-i and generate a corresponding electrical output based on the respective output. The electrical output corresponds to an output element Oᵢ of the computation result

$$α ( {\sum }_{j = 1}^{n} {W}_{i} ( j ) I ( j ) + {b}_{i} ) ,$$

where α represents the activation function of the mathematical function, I(j) represents a j-th element in the N-by-1 input matrix, Wᵢ(j) represents an i,j-th weight element Wᵢⱼ in the M-by-N weight matrix, bᵢ represents a i-th element in the M-by-1 bias matrix, where i is an integer in a range from 1 to m, and j is an integer in a range from 1 to n.

Besides the time-based photonic computation as described in FIG. 4B, the photonic computing system 400 can also implement photonic computation in space, e.g., as noted in FIG. 4C. In some implementations, the intensity modulator 406, the optical splitter 408, the M weight modulators 410 form a photonic sub-system. The photonic computing system 400 can include (N+1) photonic sub-systems each coupled to the control circuitry 404 and configured to perform respective operations based on a corresponding input optical signal of (N+1) input optical signals.

In some implementations, each of the (N+1) input optical signals has a same wavelength. In some examples, the photonic computing system 400 includes (N+1) optical sources each providing a respective input optical signal. In some examples, the photonic computing system 400 includes an optical source configured to generate an input optical signal that can be split into (N+1) input optical signals respectively for the (N+1) photonic sub-systems.

In some implementations, each of the (N+1) input optical signals has a respective wavelength, and at least two of respective wavelengths of the N input optical signals are different. For example, a laser source can be modulated and/or filtered to generate the (N+1) input optical signals have corresponding (N+1) wavelengths. FIG. 4C illustrates an example space-based photonic computing implementation 430 using the photonic computing system 400 of FIG. 4A.

In an j-th photonic sub-system of the (N+1) photonic sub-systems, a corresponding input optical signal is modulated to generate a first modulated input optical signal to have a respective intensity corresponding to a respective input element Iⱼ of the N elements in the N-by-1 input matrix or a normalized value of 1. The first modulated input optical signal is split into a group of M first modulated optical signals each having a first intensity with a corresponding normalized value, Iⁱ(j). Accordingly, (N+1) groups of first modulated optical signals in the (N+1) photonic sub-systems respectively correspond to (N+1) normalized values Iⁱ(1), Iⁱ(2), Iⁱ(3), . . . , Iⁱ(n), 1 in space, e.g., as illustrated in diagram (a) of FIG. 4C.

In the j-th photonic sub-system, the corresponding group of M first modulated optical signals associated with a normalized value Iⁱ(j) is modulated with weight information W¹(j), W²(j), W³(j), . . . , W^{m}(j) associated with a respective group of M weights in the M-by-N weight matrix, e.g., W₁ⱼ, W₂ⱼ, W₃ⱼ, . . . , Wₘⱼ, to generate a respective group of M second modulated optical signals associated with a normalized value of W¹(j)*Iⁱ(j), W²(j)*Iⁱ(j), W³(j)*Iⁱ(j) W^{m}(j)*Iⁱ(j). In the (N+1)-th photonic sub-system, the corresponding group of M first modulated optical signals associated with a normalized value 1 is modulated based on M bias values in the M-by-1 bias matrix, e.g., b₁, b₂, b₃, . . . , bₘ, to generate an additional group of M second modulated optical signals associated with normalized values of b¹, b², b³, . . . , b^{m}.

In some implementations, each photonic sub-system includes M photodetectors, and the photonic system includes (N+1)*M photodetectors in total. For each of M groups of (N+1) photodetectors each from the (N+1) photonic sub-systems, the control circuitry 404 can add (N+1) outputs of corresponding (N+1) photodetectors to generate a respective electrical output representing an output element Oᵢ corresponding to

$$α ( {\sum }_{j = 1}^{N} {W}_{i} ( j ) I ( j ) + b ( i ) ) ,$$

where α represents the nonlinearity of the mathematical function, I(j) represents a j-th element in the N-by-1 input matrix, Wᵢ(j) represents an i,j-th weight element Wᵢⱼ in the M-by-N weight matrix, b(i) represents an i-th element bᵢ in the M-by-1 bias matrix, where i is an integer in a range from 1 to M, and j is an integer in a range from 1 to N. For the output element Oᵢ, corresponding (N+1) second modulated optical signals associated with the (N+1) outputs can have normalized values as illustrated in diagram (b) of FIG. 4C.

In some implementations, the photonic system includes M photodetectors. An i-th photodetector is coupled to a respective group of (N+1) weight modulators from the (N+1) photonic sub-systems, and configured to detect (N+1) second modulated optical signals to generate a respective result. The (N+1) second modulated optical signals can have normalized values as illustrated in diagram (b) of FIG. 4C, e.g., Wⁱ(1)*Iⁱ(1), Wⁱ(2)*Iⁱ(2), Wⁱ(3)*Iⁱ(3), . . . , Wⁱ(n)*Iⁱ(n), bᵢ. The i-th photodetector is configured to generate the respective output by accumulating detection results of the (N+1) second modulated optical signals. The control circuitry can receive the respective output from the i-th photodetector and generate a respective electrical output based on the respective output. The respective electrical output represents an output element Oᵢ of the computation result

$$α ( {\sum }_{j = 1}^{N} {W}_{i} ( j ) I ( j ) + b ( i ) ) ,$$

where α represents the nonlinearity of the mathematical function, I(j) represents a j-th element in the N-by-1 input matrix, Wᵢ(j) represents an i,j-th weight element Wᵢⱼ in the M-by-N weight matrix, b(i) represents an i-th element bᵢ in the M-by-1 bias matrix, where i is an integer in a range from 1 to M, and j is an integer in a range from 1 to N.

In the unipolar photonic computing system 400 as illustrated in FIG. 4A, a first modulated optical signal, e.g., generated by the optical modulator 406 or the optical splitter 408, can have an optical intensity with a normalized value in a range [0, 1], which represents an input element of the input matrix of the mathematical function. To increase a range of the normalized value, e.g., from [0, 1] to [−1, 1], to represent a broader range of the input element, bipolar photonic computing systems using balanced photodetectors can be configured for such photonic computation, e.g., as illustrated with further details in FIGS. 5A-5B.

FIG. 5A is a schematic diagram of an example bipolar photonic computing system 500 using balanced photodetectors. Similar to the unipolar photonic computing system 400 of FIG. 4A, the bipolar photonic computing system 500 can be configured to perform a photonic computation of a mathematical function (e.g., the mathematical function 122 of FIG. 1A or 150 of FIG. 1B) between adjacent layers (e.g., the layers 120 of FIG. 1A) in a neural network (e.g., the neural network 100 of FIG. 1A). The photonic computing system 500 can be similar to, or same as, the photonic system 200 of FIGS. 2A-2B or 300 of FIGS. 3A-3B.

For illustration, the mathematical function can be same as or similar to the mathematical function as described with respect to FIGS. 4A-4C, and can include an input matrix such as N-by-1 input matrix (e.g., the input matrix 152 of FIG. 1B), a weight matrix such as an M-by-N weight matrix (e.g., the weight matrix 154 of FIG. 1B), and an output matrix such as an M-by-1 output matrix (e.g., the output matrix 158 of FIG. 1B). The mathematical function can also include a bias matrix such as an M-by-1 bias matrix (e.g., the bias matrix 156 of FIG. 1B). Each of M and N is an integer.

Different from the unipolar photonic computing system 400 of FIG. 4A, the bipolar photonic computing system 500 includes a plurality of balanced photodetectors 502-1, 502-2, . . . , 502-M (referred to generally as balanced photodetectors 502 and individually as balanced photodetector 502) and a control circuitry 504 coupled to the plurality of balanced photodetectors 502.

An activation function of the mathematical function can be implemented by at least one of the control circuitry 504 or the plurality of balanced photodetectors 502. In some implementations, e.g., as illustrated in FIGS. 2A-2B, each of the plurality of balanced photodetectors 502 includes a nonlinear balanced phototransistor (e.g., the photodetector 202 of FIGS. 2A-2B and as illustrated with further details in FIG. 6B) configured based on the activation function of the mathematical function, and the control circuitry 504 (e.g., the control circuitry 204 of FIGS. 2A-2B) is configured to generate electrical outputs based on outputs of the plurality of balanced photodetectors 502. In some implementations, e.g., as illustrated in FIGS. 3A-3B, each of the plurality of balanced photodetectors 502 includes a photodiode, LIPD, APD, or SPAD (e.g., the photodetector 302 of FIGS. 3A-3B) configured to have a linear photo-response, and the control circuitry 504 (e.g., the control circuitry 304 of FIGS. 3A-3B) is configured to generate electrical outputs based on outputs of the plurality of photodetectors and the activation function of the mathematical function.

In some implementations, as illustrated in FIG. 5A, the bipolar photonic computing system 500 includes a variable optical splitter 506 configured to receive an input optical signal 501 and generate two separated modulated input optical signals: a first modulated input optical signal 507-1 and a second modulated input optical signal 507-2. The first modulated input optical signal 507-1 represents first input information and the second modulated input optical signal 507-2 represents second input information, and the first input information and the second input information can be determined based on input information associated with a corresponding input element (e.g., Iⱼ) of the input matrix of the mathematical function. The variable optical splitter 506 can include a Mach-Zehnder interferometer (MZI) or 1×2 variable splitter, and has one input port and two output terminals. The first modulated input signal 507-1 has a first intensity representing a first normalized value in a range from 0 to 1, the second modulated input optical signal 507-2 has a second intensity representing a second normalized value in a range from 0 to 1. The variable optical splitter 506 can be configured such that a difference between the first modulated input optical signal 507-1 and the second modulated input optical signal 507-2 is in a range from −1 to 1. Thus, the corresponding input element of the input matrix can be represented with a normalized value in a range [−1, 1].

In some implementations, as illustrated in FIG. 5A, the bipolar photonic computing system 500 includes a first optical splitter 508-1 and a second optical splitter 508-2 (referred to generally as optical splitters 508 and individually as optical splitter 508). The optical splitter 508 can be same as, or similar to, the optical splitter 408 of FIG. 4A. The first optical splitter 508-1 is configured to split the first modulated input optical signal 507-1 into M first split modulated optical signals corresponding to M first optical pathways, which are received and detected by M first weight modulators 510-1, 510-2, . . . , 510-M (referred to generally as first weight modulators 510 and individually as first weight modulator 510). The second optical splitter 508-2 is configured to split the second modulated input optical signal 507-2 into M second split modulated optical signals corresponding to M second optical pathways, which are received and detected by M second weight modulators 512-1, 512-2, . . . , 512-M (referred to generally as second weight modulators 512 and individually as second weight modulator 512).

For each of the M first optical pathways, a respective first modulated optical signal is modulated by a corresponding first weight modulator 510 based on a respective weight element of M weight elements (e.g., W₁ⱼ, W₂ⱼ, . . . , Wₘⱼ) of the M-by-N weight matrix corresponding to the corresponding input element Ij to generate a respective positive modulated optical signal. For each of the M second optical pathways, a respective second modulated optical signal is modulated by a corresponding second weight modulator 512 based on a respective weight element of the M weight elements (e.g., W₁ⱼ, W₂ⱼ, . . . , Wₘⱼ) of the M-by-N weight matrix corresponding to the corresponding input element Iⱼ to generate a respective negative modulated optical signal.

As illustrated in FIG. 5A, each balanced photodetector 502 is coupled to a corresponding first weight modulator 510 and a corresponding second weight modulator 512 and configured to detect a corresponding positive modulated optical signal from the corresponding first weight modulator 510 and a corresponding negative modulated optical signal from the corresponding second weight modulator 512 to generate a respective output represents a difference between the corresponding positive modulated optical signal and the corresponding negative modulated optical signal.

The corresponding positive modulated optical signal and the corresponding negative modulated optical signal are based on a same weight element corresponding to the input element. For example, as illustrated in FIG. 5A, balanced photodetector 502-1 is coupled to a first weight modulator 510-1 and a second weight modulator 512-1 that are configured to modulate a first modulated optical signal and a second modulated optical signal based on a first weight element W₁ⱼ; balanced photodetector 502-2 is coupled to a first weight modulator 510-2 and a second weight modulator 512-2 that are configured to modulate a first modulated optical signal and a second modulated optical signal based on a second weight element W₂ⱼ; and so on, balanced photodetector 502-M is coupled to a first weight modulator 510-M and a second weight modulator 512-M that are configured to modulate a first modulated optical signal and a second modulated optical signal based on an m-th weight element Wₘⱼ.

As the corresponding positive modulated optical signal and the corresponding negative modulated optical signal are based on a same weight element and a difference between the first modulated optical signal and the second modulated optical signal corresponds to a same input element, a difference between the corresponding positive modulated optical signal and the corresponding negative modulated signal corresponds to a multiplication of the input element and the weight element.

Similar to the unipolar photonic computing system 400 of FIG. 4A, the bipolar photonic computing system 500 can perform time-based photonic computation (e.g., as illustrated with respect to FIG. 4B) and/or space-based photonic computation (e.g., as illustrated with respect to FIG. 4C). The control circuitry 504 is coupled to the M balanced photodetectors and can be configured to generate electrical results based on outputs of the M balanced photodetectors, the electrical results representing a computation result of the multiplication of the input matrix and the weight matrix.

In some implementations, similar to the control circuitry 404 of FIG. 4A, the control circuitry 504 is configured to receive electrical data or signal 503 from an external device or system, and transmit electrical data or signal 505 to an external device or system. The electrical data or signal 503 can be similar to, or same as, the electrical data or signal 403 of FIG. 4A, and can include weight information of the weight matrix and/or bias information of the bias matrix, e.g., from a computing system that has trained the neural network, or a command or an inquiry from the external device or system, e.g., a command for starting inference of the neural network or an inquiry for an inference result or a computation result. The electrical data or signal 505 can be similar to, or same as, the electrical data or signal 405 of FIG. 4A, and can include computation results generated by the photonic computing system 500. The control circuitry 504 can also provide the computation result of the mathematical function (e.g., the output matrix) as an input matrix of a next photonic computation (e.g., for a subsequent layer in the neural network), for example, as illustrated in FIG. 2A or 3A.

FIG. 5B is a schematic diagram of another example bipolar photonic computing system 550 using balanced photodetectors 502. The bipolar photonic computing system 550 is substantially same as the bipolar photonic computing system 500 of FIG. 5A, except that the bipolar photonic computing system 550 includes two optical modulators 556-1, 556-2 (referred to generally as optical modulators 556 and individually as optical modulator 556), instead of the variable optical splitter 506 of FIG. 5A.

The two optical modulators 556-1, 556-2 are configured to modulate respective first and second input optical signals 551-1, 551-2 with respective first and second input information associated with a same input element of the input matrix. For example, the first optical modulator 556-1 is configured to modulate the first input optical signal 551-1 with the first input information associated with the input element to generate a first modulated input optical signal 557-1, and the second optical modulator 556-2 is configured to modulate the second input optical signal 551-2 with second input information associated with the input element to generate a second modulated input optical signal 557-2. The first input information and the second input information can be determined based on input information associated with the input element. In some examples, the first input optical signal 551-1 and the second input optical signal 551-2 can have a same optical intensity, e.g., from a same optical source.

The first modulated input optical signal 557-1 is output to the first optical splitter 508-1 and split into M first modulated optical signals for M first optical pathways, and the second modulated input optical signal 557-2 is output to the second optical splitter 508-2 and split into M second modulated optical signals for M second optical pathways, e.g., as illustrated in FIG. 5B.

FIG. 6A is a schematic diagram of an example single nonlinear phototransistor (NPT) 600. The NPT 600 can be implemented as the nonlinear photodetector 202 of FIGS. 2A-2B, or the photodetector 402 of FIG. 4A.

In some implementations, as shown in FIG. 6A, the NPT 600 includes a positive terminal 601, a negative terminal 603, and a detector body 602 between the positive terminal 601 and the negative terminal 603. The detector body 602 can include one or more doped semiconductor layers, e.g., p-Si, n-Si, and p-Ge. The detector body 602 can have an absorption region, e.g., at the p-Ge semiconductor layer, configured to absorb photons to generate electrons or currents. The positive terminal 601 can be coupled to a supply voltage, e.g., VDD. The negative terminal 603 can be coupled to an output circuit, and the NPT 600 is configured to provide an output signal at the negative terminal 603 to the output circuit.

FIG. 6B is a schematic diagram of an example balanced nonlinear phototransistor (balanced NPT) 650. The NPT 650 can be implemented as the nonlinear photodetector 202 of FIGS. 2A-2B, or the photodetector 502 of FIG. 5A or 5B.

In some implementations, as shown in FIG. 6B, the NPT 650 can include a positive terminal 651, a negative terminal 653, and an output terminal 655. The NPT 650 can further include a first detection body 652 between the positive terminal 651 and the output terminal 655, and a second detection body 654 between the negative terminal 653 and the output terminal 655. The positive terminal 651 can be coupled to a higher supply voltage, e.g., VDD, and the negative terminal 653 can be coupled to a lower supply voltage, e.g., a ground, VSS, or a negative voltage −VDD. A first optical signal incident on the first detection body 652 can be considered as a positive optical signal, and a second optical signal incident on the second detection body 654 can be considered as a negative optical signal. The output of the NPT 650 at the output terminal 655 corresponds to a difference between the first optical signal and the second optical signal. For example, as discussed with respect to FIG. 5A or 5B, an NPT 650 can receive a pair of a positive modulated optical signal and a negative modulated optical signal, and the positive modulated optical signal can be incident on the first detection body 652 of the NPT and the negative modulated optical signal can be incident on the second detection body 654 of the NPT. When the intensity of the positive modulated optical signal is greater than the intensity of the negative modulated optical signal, the output terminal 655 can provide an output signal that represents a positive value (e.g., a current source at the output terminal 655). When the intensity of the positive modulated optical signal is less than the intensity of the negative modulated optical signal, the output terminal 655 can provide an output signal that represents a negative value (e.g., a current sink at the output terminal 655). When the intensity of the positive modulated optical signal is the same as the intensity of the negative modulated optical signal, the output terminal 655 can provide an output signal that represents zero (e.g., a null current at the output terminal 655).

In some implementations, the NPT 600 or NPT 650 can be implemented based on Si homojunctions, e.g., for visible, near infrared (NIR), and shortwave-infrared (SWIR) light. In some implementations, the NPT 600 or NPT 650 can be implemented based on Ge/Si as heterojunction separate absorption and multiplication (SAM) or separate absorption, charge, and multiplication (SACM), e.g., for NIR or short-wave infrared (SWIR) light. In some implementations, the NPT 600 or NPT 650 can be implemented based on InGaAs/InP as heterojunction SAM or SCAM, e.g., for NIR or SWIR light.

In some implementations, optical signals can be transmitted in a photonic computing system, e.g., the unipolar photonic computing system 400 of FIG. 4A, the bipolar photonic computing system 500 of FIG. 5A or 550 of FIG. 5B, in a photonic integrated circuit (PIC). At least part of optical components in the photonic computing system (e.g., intensity modulators 406, variable optical splitters 506, optical splitters 408 or 508, weight modulators 410 or 510, and/or photodetectors 402 or 502) can be integrated in the photonic integrated circuit. The optical components can have a waveguide structure that can be made of any suitable material, e.g., an insulator material such as polymer, glass, sapphire, oxide, nitride, a metallic material such as Au, Ag, or a semiconductor material such as Si, Ge, or III-V, or a nonlinear material such as LiNbO₃, BaTiO₃. A control circuitry (e.g., 404 of FIG. 4A, 504 of FIG. 5A or 5B) can be integrated in an electrical integrated circuit (EIC). The photonic integrated circuit and the electrical integrated circuit can be integrated in a chip package. In some implementations, one or more processing units and one or more memory devices can be integrated with or within the control circuitry or the chip package in an interposer. The control circuitry can include a Complementary Metal-Oxide-Semiconductor (CMOS) device.

### IV. Photonic Computing with Example Normal-Incident Photodetectors

In some implementations, instead of using an optical modulator for modulating at least one modulated optical signal based on weight elements of a weight matrix of a mathematical function (e.g., as described with respect to FIGS. 4A, 5A, 5B), photodetectors can be modulated based on the weight matrix and configured to detect at least one modulated optical signal representing one or more input elements in an input matrix of the mathematical function to generate electrical signals that can be processed by a control circuitry to generate corresponding electrical results that represent a computation result of the mathematical function, e.g., as illustrated below with respect to FIGS. 7-9, 14A, 14B, 16A, and 16B. These optical signals can be transmitted in free space, e.g., from optical sources/modulators to optical elements, and/or from optical elements to photodetectors. The techniques implemented herein can reduce a number of optical components used in a photonic computing system for one computation and reduce cost. Moreover, the techniques implemented herein can allow a higher number of computations to be performed in parallel, as normal-incident photodetectors can be arranged in a two-dimensional array.

FIG. 7 is a schematic diagram of an example photonic computing system 700 with uniform illumination on a photodetector (PD) array 710 that can be modulated based on a weight matrix of a mathematical function. The photonic computing system 700 can be configured to perform a photonic computation of the mathematical function (e.g., the mathematical function 122 of FIG. 1A or 150 of FIG. 1B) between adjacent layers (e.g., the layers 120 of FIG. 1A) in a neural network (e.g., the neural network 100 of FIG. 1A). The photonic computing system 700 can be similar to, or same as, the photonic system 200 of FIGS. 2A-2B or 300 of FIGS. 3A-3B.

In some implementations, the mathematical function includes an input matrix such as N-by-1 input matrix (e.g., the input matrix 152 of FIG. 1B), a weight matrix such as an M-by-N weight matrix (e.g., the weight matrix 154 of FIG. 1B), and an output matrix such as an M-by-1 output matrix (e.g., the output matrix 158 of FIG. 1B). The mathematical function can also include a bias matrix such as an M-by-1 bias matrix (e.g., the bias matrix 156 of FIG. 1B). Each of M and N is an integer. M can be smaller than, identical to, or greater than N.

The photodetector array 710 can include a plurality of photodetectors (PDs) 712. A photodetector 712 can be modulated to represent a weight element of the weight matrix by modulating a bias voltage applied to the photodetector with weight information corresponding to the weight element of the weight matrix. The photodetector 712 can be a single photodetector like a photodiode, an APD, a phototransistor (e.g., the phototransistor 600 of FIG. 6A), a balanced NPT (e.g., the balanced NPT 650 of FIG. 6B), or a multi-tap photodetector (e.g., as illustrated with further details in FIG. 10). The photodetector 712 can be same as, or similar to, the photodetector 202 of FIGS. 2A-2B, 302 of FIGS. 3A-3B, 402 of FIG. 4A, or 502 of FIGS. 5A-5B.

The photonic computing system 700 can include a control circuitry 704 coupled to the photodetector array 710 and coupled to each of the plurality of photodetectors 712. The control circuitry 704 can be similar to the control circuitry 204 of FIGS. 2A-2B, the control circuitry 304 of FIGS. 3A-3B, the control circuitry 404 of FIG. 4A, or the control circuitry 504 of FIG. 5A or 5B.

An activation function of the mathematical function can be implemented by at least one of the control circuitry 704 or the plurality of photodetectors 712. In some implementations, e.g., as illustrated in FIGS. 2A-2B, each of the plurality of photodetectors 712 includes a nonlinear phototransistor (e.g., the photodetector 202 of FIGS. 2A-2B, the NPT 600 of FIG. 6A) configured based on the activation function of the mathematical function, and the control circuitry 704 (e.g., the control circuitry 204 of FIGS. 2A-2B) is configured to generate electrical outputs based on outputs of the plurality of photodetectors 712. In some implementations, e.g., as illustrated in FIGS. 3A-3B, each of the plurality of photodetectors 712 includes a photodiode, LIPD, APD, or SPAD (e.g., the photodetector 302 of FIGS. 3A-3B) configured to have a linear photo-response, and the control circuitry 704 (e.g., the control circuitry 304 of FIGS. 3A-3B) is configured to generate electrical outputs based on outputs of the plurality of photodetectors 712 and the activation function of the mathematical function.

In some implementations, e.g., as illustrated in FIG. 7, the photonic computing system 700 further includes an optical source or optical modulator 702 configured to generate at least one modulated optical signal 703 representing one or more input elements of the input matrix of the mathematical function. In some implementations, an optical source 702 is modulated with input information associated with the input matrix to generate the at least one modulated optical signal 703. For example, the optical source 702 can include a laser source such as VCSEL or EEL or a light-emitting diode (LED) or a micro-LED, and can be modulated by modulating a bias voltage applied to the laser source or the light-emitting diode based on the input matrix. In some implementations, an optical modulator 702 is configured to modulate an input optical signal from an optical source with input information associated with the input matrix to generate the at least one modulated optical signal 703. the optical modulator 702 can be an intensity modulator (e.g., the intensity modulator 406 of FIG. 4A or 556 of FIG. 5B).

The optical modulator 702 can include an electro-optic modulator or an acousto-optic modulator.

The control circuitry 704 is coupled to the optical source or optical modulator 702 and configured to provide the input information associated with the input matrix. The input information can be associated with a corresponding input element of the input matrix, e.g., Iⱼ, where j is an integer in a range from 1 to n. The at least one modulated input optical signal can have an optical intensity corresponding to the corresponding input element of the input matrix. The optical intensity can correspond to a normalized value in a range from 0 to 1, e.g., [0, 1].

In photonic computation, the at least one modulated optical signal 703 is directed to at least part of the plurality of photodetectors 712, e.g., in free space. In some implementations, the photonic computing system 700 includes an optical diffuser 706, as shown in FIG. 7. The optical diffuser 706 can direct the at least one modulated optical signal 703 to uniformly illuminate the at least part of, or the entirety of, the plurality of photodetectors 712. For example, an uniform optical beam 705 can be generated based on the at least one modulated optical signal 703 by the optical diffuser 706, and can illuminate an area 707 covering the at least part of the plurality of photodetectors 712. In some implementations, the photodetector array 710 includes a microlens array or meta-microlens array that can cover the plurality of photodetectors 712 and be configured to focus light onto individual photodetectors 712.

Similar to the photonic computing system 400 of FIGS. 4A, the photonic computing system 700 can perform time-based photonic computation (e.g., as illustrated in FIG. 4B), and/or space-based photonic computation (e.g., as illustrated in FIG. 4C). The photodetector array 710 can include N groups of M photodetectors for the M-by-N weight matrix.

In a time-based photonic computation, during each of N time periods, the optical source or modulator 702 generates at least one modulated optical signal 703 with a respective intensity corresponding to a respective input element (e.g., Iⱼ) of N elements in the N-by-1 input matrix. The optical diffuser 706 directs the at least one modulated optical signal 703 to illuminate at least part of the plurality of photodetectors 712. A group of M photodetectors can be modulated based on a corresponding group of M weights (e.g., a column of M weights such as W₁ⱼ, W₂ⱼ, W₃ⱼ, . . . , Wₘⱼ) in the M-by-N weight matrix corresponding to the respective input element. Each of the group of M photodetectors detects the at least one modulated optical signal 703 to generate a respective result corresponding to a multiplication of the respective input element and a corresponding weight of the corresponding group of M weight elements (e.g., W₁ⱼ*Iⱼ, W₂ⱼ*Iⱼ, W₃ⱼ*Iⱼ, . . . , or Wₘⱼ*Iⱼ), and transmits the respective result to the control circuitry 704. The M respective results from the group of M photodetectors represent the multiplication of the respective input element and the corresponding group of M weight elements.

From the first time period to the Nth time period, the modulated optical signal can sequentially represent the N input elements (e.g., I₁, I₂, I₃, . . . , Iₙ) of the N-by-1 input matrix, and accordingly, M photodetectors can be sequentially modulated based on N corresponding groups of M weights and generate respective results.

In some implementations, the mathematical function further includes an M-by-1 bias matrix. During an additional time period different from the N time periods, the at least one modulated optical signal is generated to have an intensity corresponding to a normalized value of 1. A group of M photodetectors in the photodetector array 710 is respectively modulated based on M bias values (e.g., b₁, b₂, b₃, . . . , bₘ) in the M-by-1 bias matrix. Each of the M photodetectors can accumulate a respective bias result by detecting the at least one modulated optical signal 703, and the respective bias result corresponds to a multiplication of the value of 1 and a corresponding bias value of the M bias values.

The control circuitry 704 is coupled to each photodetector 712 of M photodetectors and generate M electrical outputs representing M output elements in the computation result (e.g., O₁, O₂, . . . , Oₘ). Each of the M electrical outputs is based on the sum of N respective results respectively from the M photodetectors during the N time periods and the respective bias result from M photodetectors modulated during the additional time period. For example, an electrical output corresponds to an output element Oᵢ of the computation result

$$α ( {\sum }_{j = 1}^{N} {W}_{i} ( j ) I ( j ) + {b}_{i} ) ,$$

where α represents the activation function of the mathematical function, I(j) represents a j-th element in the N-by-1 input matrix, Wᵢ(j) represents a i,j-th weight element Wᵢⱼ in the M-by-N weight matrix, b(i) represents an i-th element in the M-by-1 bias matrix, where i is an integer in a range from 1 to M, and j is an integer in a range from 1 to N.

In some implementations, in a time-based photonic computation, the photodetector array 710 may include one group of M photodetectors. In some other implementations, in a time-based photonic computation, the photodetector array 710 may include multiple groups (e.g., N+1 groups) of M photodetectors that corresponds to a number of input elements in the input array. In some implementations, during each of the (N+1) time periods, a corresponding group of the (N+1) groups of M photodetectors is turned on, and other N groups of M photodetectors are turned off.

In a space-based photonic computation, the photonic computing system 700 can include N optical source or modulators 702 configured to generate N modulated optical signals respectively representing N input elements of the input matrix (e.g., I₁, I₂, I₃, . . . , Iₙ). The photodetector array 710 can include N groups of M photodetectors.

Each of the N modulated optical signals representing a respective input element is directed to a respective group of the N groups of M photodetectors. The respective group of M photodetectors is modulated respectively based on a corresponding group of M weight elements (e.g., W₁ⱼ, W₂ⱼ, W₃ⱼ, . . . , Wₘⱼ) in the M-by-N weight matrix corresponding to the respective input element. Each of the respective group M photodetectors generates a respective result by detecting the modulated optical signal, and the respective result corresponds to a multiplication of the respective input element and a corresponding weight of the corresponding group of M weights.

Similarly, the mathematical function further includes an M-by-1 bias matrix, and the photodetector array 710 can further include an additional group of M photodetectors. An additional modulated optical signal can be generated, e.g., by an additional optical source or modulator 702 and can have an optical intensity corresponding to a normalized value of 1. The additional group of M photodetectors can be modulated respectively based on M bias values (e.g., b₁, b₂, b₃, . . . , bₘ) in the M-by-1 bias matrix. Each of the additional group of M photodetectors can generate a respective bias result by detecting the additional modulated optical signal, and the respective bias result corresponds to a multiplication of the value of 1 and a corresponding bias value of the M bias values.

The control circuitry 704 is coupled to each photodetector in the (N+1) groups of M photodetectors and generate M electrical outputs representing M output elements in the computation result (e.g., O₁, O₂, . . . , Oₘ). Each of the M electrical outputs is based on the sum of N respective results respectively from the N groups of M photodetectors and the respective bias result from an additional photodetector in the additional group of M photodetectors. For example, an electrical output corresponds to an output element Oᵢ of the computation result

$$α ( {\sum }_{j = 1}^{N} {W}_{i} ( j ) I ( j ) + {b}_{i} ) ,$$

where α represents the activation function of the mathematical function, I(j) represents a j-th element in the N-by-1 input matrix, Wᵢ(j) represents an i,j-th weight element Wᵢⱼ in the M-by-N weight matrix, b(i) represents an i-th element in the M-by-1 bias matrix, where i is an integer in a range from 1 to M, and j is an integer in a range from 1 to N.

In some implementations, each of the N modulated optical signals has a respective wavelength, and at least two of respective wavelengths of the N modulated optical signals can be different. The N modulated optical signals can be respectively generated by N optical sources having different wavelengths, or by an optical source modulated and/or filtered to generate optical signals with different wavelengths. In some implementations, each of the N modulated optical signals has a same wavelength. For example, the N modulated optical signals can be respectively generated by N optical sources having a same wavelength, or by an optical source providing an optical signal split into N optical signals that are modulated by N different optical modulators.

FIG. 8 is a schematic diagram of another example photonic computing system 800 with concentrated illumination on a photodetector array 810 that can be modulated based on a weight matrix of a mathematical function. The photonic computing system 800 can be configured to perform a photonic computation of the mathematical function (e.g., the mathematical function 122 of FIG. 1A or 150 of FIG. 1B) between adjacent layers (e.g., the layers 120 of FIG. 1A) in a neural network (e.g., the neural network 100 of FIG. 1A). The photonic computing system 800 can be similar to, or same as, the photonic system 200 of FIGS. 2A-2B or 300 of FIGS. 3A-3B.

The photonic computing system 800 is substantially same as the photonic computing system 700 of FIG. 7. For example, the photonic computing system 800 includes a control circuitry 804 that is same as or similar to the control circuitry 704 of FIG. 7, an optical source or modulator 802 that is same as or similar to the optical source or modulator 702 of FIG. 7, and the photodetector array 810 that is same as or similar to the photodetector array 710 of FIG. 7. The photodetector array 810 includes a plurality of photodetectors 812 each that is same as or similar to the photodetector 712 of FIG. 7.

The optical source or modulator 802 is configured to generate at least one modulated optical signal 803 based on an input matrix of the mathematical function. The at least one modulated optical signal 803 can be same as or similar to the at least one modulated optical signal 703 of FIG. 7. The at least one modulated optical signal 803 is directed to at least part of the plurality of photodetectors 812. Different from the photonic computing system 700 that includes the optical diffuser 706 configured to cause uniform illumination on the at least part of the plurality of photodetectors 712, the photonic computing system 800 is configured to cause concentrated illumination on individual photodetectors 812. In some implementations, the photonic computing system 800 includes an optical dot projector 806 configured to generate illumination dots 805 to respectively illuminate the individual photodetectors 812, e.g., as shown in FIG. 8.

Similar to the photonic computing system 700 of FIG. 7, the photonic computing system 800 can also perform time-based photonic computation and/or space-based photonic computation, as noted above.

In either the photonic computing system 700 of FIG. 7 or the photonic computing system 800 of FIG. 8, each modulated optical signal (e.g., 703 of FIG. 7 or 803 of FIG. 8) has an optical intensity corresponding to a normalized value in a range of [0, 1]. To enable representation of an input element of an input matrix with a corresponding value in a range of [−1, 1], a bipolar photonic computing system can be configured, e.g., similar to the bipolar photonic computing system 500 of FIG. 5A or 550 of FIG. 5B.

FIG. 9 is a schematic diagram of another example photonic computing system 900 with concentrated illumination on a photodetector array 910 with balanced connection, which enables to implement a bipolar photonic computing system. The photonic computing system 900 can be configured to perform a photonic computation of a mathematical function (e.g., the mathematical function 122 of FIG. 1A or 150 of FIG. 1B) between adjacent layers (e.g., the layers 120 of FIG. 1A) in a neural network (e.g., the neural network 100 of FIG. 1A). The photonic computing system 900 can be similar to, or same as, the photonic system 200 of FIGS. 2A-2B or 300 of FIGS. 3A-3B.

In some implementations, the mathematical function includes an input matrix such as N-by-1 input matrix (e.g., the input matrix 152 of FIG. 1B), a weight matrix such as an M-by-N weight matrix (e.g., the weight matrix 154 of FIG. 1B), and an output matrix such as an M-by-1 output matrix (e.g., the output matrix 158 of FIG. 1B). The mathematical function can also include a bias matrix such as an M-by-1 bias matrix (e.g., the bias matrix 156 of FIG. 1B). Each of M and N is an integer. M can be smaller than, identical to, or greater than N.

The photodetector array 910 includes a plurality of balanced photodetectors 912.

Each balanced photodetector 912 includes a first photodetector 912-1 and a second photodetector 912-2 that are electrically connected by a balanced connection 912-3, which together can be same as or similar to the balanced photodetector 502 of FIG. 5A or 5B, or the balanced phototransistor 650 of FIG. 6B. Each photodetector 912-1, 912-2 can be same as or similar to the photodetector 402 of FIG. 4A, the phototransistor 600 of FIG. 6A, the photodetector 712 of FIG. 7, the photodetector 812 of FIG. 8, or the multi-tap photodetector of FIG. 10. The photonic computing system 900 also includes a control circuitry 904 coupled to the plurality of balanced photodetectors 912. The control circuitry 904 can be same as or similar to the control circuitry 204 of FIGS. 2A-2B, the control circuitry 304 of FIGS. 3A-3B, the control circuitry 404 of FIG. 4A, the control circuitry 504 of FIG. 5A or 5B, the control circuitry 704 of FIG. 7, or the control circuitry 804 of FIG. 8.

An activation function of the mathematical function can be implemented by at least one of the control circuitry 904 or the plurality of balanced photodetectors 912. In some implementations, e.g., as illustrated in FIGS. 2A-2B, each photodetector 912-1, 912-2 of a balanced photodetector 912 includes a nonlinear photodetector (e.g., the photodetector 202 of FIGS. 2A-2B, or the NPT 600 of FIG. 6A) configured based on the activation function of the mathematical function, and the control circuitry 904 (e.g., the control circuitry 204 of FIGS. 2A-2B) is configured to generate electrical outputs based on outputs of the plurality of balanced photodetectors 912. In some implementations, e.g., as illustrated in FIGS. 3A-3B, each photodetector 912-1, 912-2 of a balanced photodetector 912 includes a photodiode, LIPD, APD, or SPAD (e.g., the photodetector 302 of FIGS. 3A-3B) configured to have a linear photo-response, and the control circuitry 904 (e.g., the control circuitry 304 of FIGS. 3A-3B) is configured to generate electrical outputs based on outputs of the plurality of balanced photodetectors 912 and the activation function of the mathematical function.

Similar to the bipolar photonic computing system 500 of FIG. 5A or 550 of FIG. 5B, the photonic computing system 900 is configured to provide a pair of first and second modulated optical signals 903-1, 903-2 respectively directed to a pair of first and second photodetectors 912-1, 912-2 of a balanced photodetector 912.

In some implementations, the photonic computing system 900 includes a first optical source or modulator 902-1 configured to generate the first modulated optical signal 903-1 with first input information associated with an input element of the input matrix, and a second optical source or modulator 902-2 configured to generate the second modulated optical signal 903-2 with second input information associated with the input element of the input matrix. Each of the first and second optical source or modulators 902-1, 902-2 can be same as or similar to the optical source or modulator 702 of FIG. 7 or 802 of FIG. 8. The first input information and the second input information can be determined based on input information associated with the input element of the input matrix.

The first modulated optical signal 903-1 has a first intensity corresponding to the input element, and the second modulated optical signal 903-2 has a second intensity corresponding to the input element. The first intensity corresponds to a first normalized value in a range from 0 to 1, the second intensity corresponds to a second normalized value in the range from 0 to 1, and a difference between the first intensity and the second intensity corresponds to a normalized value in a range from −1 to 1. The normalized value corresponds to the input element. Thus, the first input information and the second input information can be determined, e.g., by the control circuitry 904, such that the difference between the first intensity of the first modulated optical signal 903-1 and the second intensity of the second modulated optical signal 903-2 can represent the input element that can correspond to a normalized value in a range of [−1, 1].

The photonic computing system 900 includes at least one optical dot projector 906 that can be same as or similar to the optical dot projector 806 of FIG. 8. The at least one optical dot projector 906 can be configured to direct the first modulated optical signal 903-1 to generate first illumination dots 905-1 respectively on first photodetectors 912-1 of the balanced photodetectors 912, and direct the second modulated optical signal 903-2 to generate second illumination dots 905-2 on second photodetectors 912-2 of the balanced photodetectors 912. The balanced photodetectors 912 are modulated based on a group of weight elements (e.g., W₁ⱼ, W₂ⱼ, W₃ⱼ, . . . , Wₘⱼ) in the weight matrix corresponding to the input element (e.g., Iⱼ). Each photodetector 912-1, 912-2 in a balanced photodetector 912 is modulated based on a respective weight element (e.g., Wᵢⱼ) corresponding to the input element.

A first illumination dot 905-1 on a first photodetector 912-1 of a corresponding balanced photodetector 912 represents a positive modulated optical signal, and a second illumination dot 905-2 on a second photodetector 912-2 of the corresponding balanced photodetector 912 represents a negative modulated optical signal. The corresponding balanced photodetector 912 generates a corresponding output based on a first detection result from the first photodetector 912-1 detecting the positive modulated optical signal and a second detection result from the second photodetector 912-2 detecting the negative modulated optical signal. The corresponding output can be a difference between the first detection result and the second detection result and can correspond to a multiplication of the input element and the weight element. In such a way, the input element having a normalized value in [−1, 1] can be represented and computed in the photonic computing system 900.

Similar to the photonic computing system 700 of FIG. 7 or 800 of FIG. 8, the photonic computing system 900 can also perform time-based photonic computation and/or space-based photonic computation, as noted above.

### V. Photonic Computing with Example Multi-Tap Photodetectors

A multi-tap (e.g., two-tap) photodetector can be used in a photonic computing system and can be modulated based on a weight element of a weight matrix to detect an individual modulated optical signal associated with an input element of an input matrix during sequential time slots, e.g., as illustrated with further details with respect to FIGS. 10 to 13B, which can increase a range of the input element of the input matrix (e.g., I(j) with a normalized value in [−1, 1]) and/or a range of the weight element of the weight matrix (e.g., Wᵢⱼ with a normalized value in [−1, 1]). Moreover, dark current information can be cancelled out by a complementary measurement in the sequential time slots, e.g., as illustrated with further details with respect to FIGS. 12B and 13B, such that an output obtained by the multi-tap photodetector based on the complementary measurement can exclude such dark current information. Further, a symmetric measurement (e.g., including multiple complementary measurements) can be performed using the multi-tap photodetector to address any asymmetry between different taps of the multi-tap photodetector, e.g., as illustrated with further details with respect to FIGS. 13A-13B.

The multi-tap photodetector can be implemented as a photodetector in a photonic computing system, e.g., the photodetector 202 of FIGS. 2A-2B, 302 of FIGS. 3A-3B, 712 of FIG. 7, 812 of FIG. 8, or 912-1, or 912-2 of FIG. 9. Accordingly, the techniques including performing the complementary measurements and/or symmetric measurements can be also implemented in corresponding photonic computing systems, e.g., the photonic computing system 200 of FIGS. 2A-2B, 300 of FIGS. 3A-3B, 400 of FIG. 4A, 500 of FIG. 5A, 550 of FIG. 5B, 700 of FIG. 7, 800 of FIG. 8, or 900 of FIG. 9. The multi-tap photodetector can include a silicon (Si)-based photodetector or a germanium (Ge)-based photodetector. The multi-tap photodetector can include one or more transistors (e.g., metal-oxide semiconductor field-effect transistors (MOSFETs)) as one or more corresponding taps. The multi-tap photodetector can include two taps, four taps, eight taps, or even more. For illustration, a multi-tap photodetector is described as an example of the multi-tap photodetector.

FIG. 10 illustrates an example multi-tap photodetector 1000. As diagrams (a) and (b) of FIG. 10 shows, the multi-tap photodetector 1000 includes a first tap 1010 (e.g., Tap+) having a first control terminal Q1 (e.g., for Tap+ gate control) and a first output terminal P1 (e.g., for outputting a Tap+ demodulated signal), a second tap 1020 (e.g., Tap−) having a second control terminal Q2 (e.g., for Tap− gate control) and a second output terminal P2 (e.g., for outputting a Tap− demodulated signal), and an absorption region 1002 coupled at a node 1015 between the first tap 1010 and the second tap 1020. The first tap 1010 can include a first switch 1012 coupled between the first control terminal Q1, the first output terminal P1, and the node 1015. The second tap 1020 can include a second switch 1022 coupled between the second control terminal Q2, the second output terminal P2, and the node 1015. The first switch 1012 and/or the second switch 1022 can include a transistor, e.g., MOSFET. The first output terminal P1 can be coupled to a first output circuit including a first capacitor C1, and the second output terminal P2 can be coupled to a second output circuit including a second capacitor C2.

Diagram (c) of FIG. 10 shows a schematic diagram of a structure of the multi-tap photodetector 1000. The structure can include multiple semiconductor layers that are stack together, including a bottom Si layer, a top Si layer, and a Ge-based layer between the bottom Si layer and the top Si layer. The first control terminal Q1, the first output terminal P1, the second control terminal Q2, and the second output terminal P2 can be formed in the Ge-based layer. The absorption region 1002 can be also formed in the Ge-based layer.

In operation, the absorption region 1002 converts input light 1001 into photo-response or photocarriers that flow to the node 1015. The first tap 1010 and the second tap 1020 can be configured to control flows of the photocarriers. For example, by controlling a first control signal applied at the first control terminal Q1, the first tap 1010 can be controlled to guide, based on a first demodulation contrast, a first portion of the photocarriers to the first output terminal P1 to generate a first output. By controlling a second control signal applied at the second control terminal Q2, the second tap 1020 can be controlled to guide, based on a second demodulation contrast, a second portion of the photocarriers to the second output terminal P2 to generate a second output.

The multi-tap photodetector 1000 can be coupled to an output circuitry (e.g., an analog to digital converter (ADC) circuitry) configured to calculate a difference of the first output from the first output terminal P1 of the first tap 1010 and the second output from the second output terminal P2 of the second tap 1020 to generate a result. A control circuitry can include the output circuitry. The control circuitry can be same as or similar to the control circuitry 204 of FIGS. 2A-2B, the control circuitry 304 of FIGS. 3A-3B, the control circuitry 404 of FIG. 4A, the control circuitry 504 of FIG. 5A or 5B, the control circuitry 704 of FIG. 7, the control circuitry 804 of FIG. 8, or the control circuitry 904 of FIG. 9.

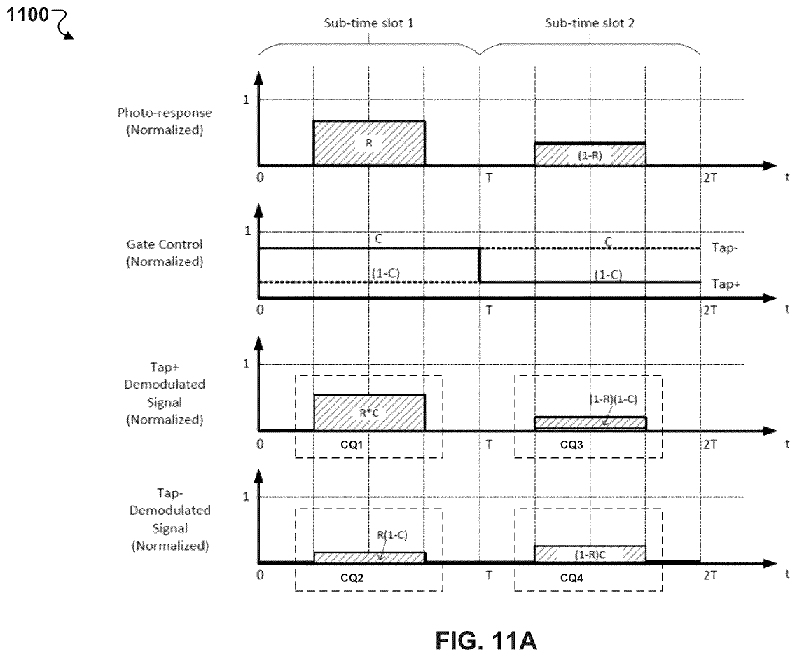

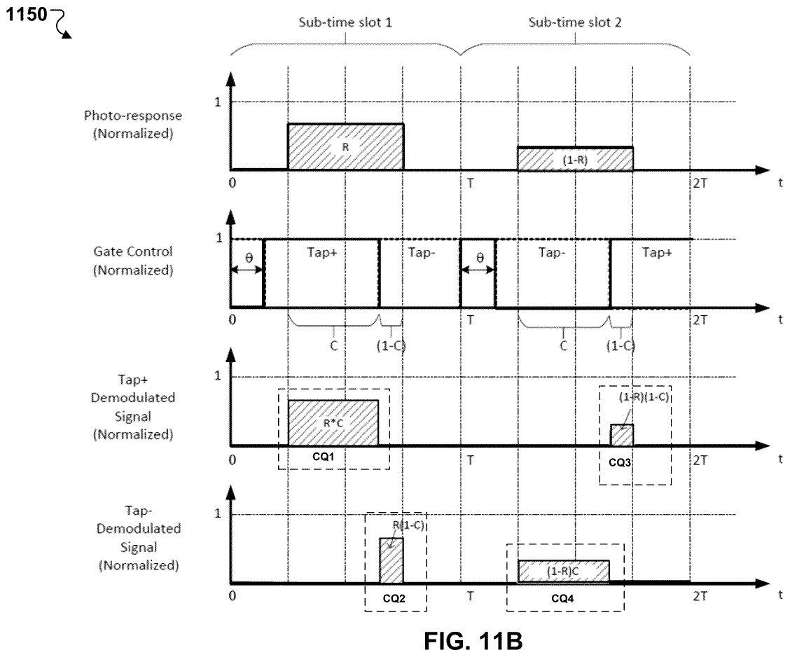

In some implementations, the output circuitry includes the first capacitor C1, and the first output from the first output terminal of the first tap 1010 can correspond to first electrical charges stored in the first capacitor C1. The output circuitry can include the second capacitor C2, and the second output from the second output terminal of the second tap 1020 can correspond to second electrical charges stored in the second capacitor C2. Thus, by controlling the first demodulation contrast, the second demodulation contrast, and the light intensity, a photonic computing system including the multi-tap photodetector 1000 can be configured to represent an input element of an input matrix (e.g., I(j) with a normalized value in a range of [−1, 1]) and a weight element of an weight matrix (e.g., Wᵢⱼ with a normalized value in [−1, 1]) in a complimentary amendment by amplitude or phase, as discussed with further details in FIGS. 11A-11B.

FIG. 11A illustrates an example complimentary measurement 1100 using the multi-tap photodetector 1000 of FIG. 10 modulated by amplitude for photonic computing. FIG. 11B illustrates another example complimentary measurement 1150 using the multi-tap photodetector 1000 of FIG. 10 modulated by phase for photonic computing. FIG. 12A illustrates a scheme of an example complimentary measurement (e.g., 1100 of FIG. 11A or 1150 of FIG. 11B) using the multi-tap photodetector 1000. FIG. 12B illustrates a scheme of the example complimentary measurement with dark current compensation using the multi-tap photodetector 1000.

The complimentary measurement 1100 or 1150 can be performed during a time period including a first sub-time period (e.g., Sub-time slot 1) and a second sub-time period (e.g., Sub-time slot 2). The first sub-time period and the second sub-time period can be adjacent to each other in the time period, e.g., as illustrated in FIG. 11A or 11B.

During the first sub-time period of the time period, a modulated optical signal can be generated, e.g., by an optical source and/or an optical modulator. The modulated optical signal can be configured to have a first intensity such that when detected, first photocarriers corresponding to a first normalized photocurrent response R (or Rₚ) in a range from 0 to 1 are generated. In some examples, the value of R is controlled by applying a bias voltage to modulate the optical source or the optical modulator over the first sub-time period, e.g., as shown in FIG. 11A, 11B, or 12A. The first control terminal Q1 of the first tap is modulated with a first control signal corresponding to a first normalized demodulation contrast C (or C_{D}) in a range from 0 to 1 during the first sub-time period, and the second control terminal Q2 of the second tap is modulated with a second control signal corresponding to a second normalized demodulation contrast (1−C) (or (1−C_{D})) during the first sub-time period, e.g., as illustrated in FIG. 11A, 11B, 12A, or 12B. A first measurement output can be generated (e.g., by the output circuitry coupled to the multi-tap photodetector) based on a first difference between the first output from the first output terminal of the first tap and the second output from the second output terminal of the second tap. For the first sub-time period, as illustrated in FIG. 12A, the first output from the first output terminal of the first tap can be represented by Rₚ*C_{D}, and the second output from the second output terminal of the second tap can be represented by Rₚ*(1−C_{D}), and the first difference is represented by Rₚ*(2*C_{D}−1).

During the second sub-time period of the time period, the modulated optical signal can be configured to have a second intensity such that when detected, second photocarriers corresponding to a second normalized photocurrent response (1−R) (or (1−Rₚ)) are generated, e.g., as illustrated in FIG. 11A, 11B, or 12A. The first control terminal Q1 of the first tap is modulated with the second control signal corresponding to the second normalized demodulation contrast (1−C) (or (1−C_{D})) during the second sub-time period, and the second control terminal Q2 of the second tap is modulated with the first control signal corresponding to the first normalized demodulation contrast C (or C_{D}) during the second sub-time period. A second measurement output can be generated based on a second difference between the first output from the first output terminal of the first tap and the second output from the second output terminal of the second tap. For the second sub-time period, as illustrated in FIG. 12A, the first output from the first output terminal of the first tap can be represented by (1−Rₚ)*(1−C_{D}) or (1−R)*(1−C), and the second output from the second output terminal of the second tap can be represented by (1−Rₚ)*C_{D} or (1−R)*C and the second difference is represented by (1−Rₚ)*(1−2*C_{D}) or (1−R)(1−2C).

The output circuitry can generate an electrical output based on a sum of the first measurement output from the first sub-time period and the second measurement output from the second sub-time period. The sum of the first measurement output and the second measurement output corresponds to a sum of the first difference and the second difference which can be represented by (2*C_{D}−1)*(2*Rₚ−1) or (2C−1)(2R−1), e.g., as illustrated in FIG. 12A. In some implementations, the output circuitry can generate the electrical output based on the first output and the second output during the first sub-time period and the first output and the second output during the second sub-timer period. For example, the output circuitry can calculate a first sum of the first outputs during the first and second sub-time periods and a second sum of the second outputs during the first and second sub-time periods, and generate the electrical output based on a difference between the first sum and the second sum.

The electrical output from the output circuitry can represent a multiplication of a particular weight element of the weight matrix and a particular input element of the input matrix. The particular weight element can be represented by (2*C_{D}−1) or (2C−1) that can correspond to a normalized value in a weight range from −1 to 1, and the particular input element can be represented by (2*Rₚ−1) or (2R−1) that can correspond to a normalized value in an input range from −1 to 1. Thus, the first intensity and the second intensity of the modulated optical signal can be determined based on the particular input element of the input matrix, and the first control signal at the first control terminal Q1 and the second control signal at the second control terminal Q2 can be determined based on the particular weight of the weight matrix.

In some implementations, the multi-tap photodetector is modulated by amplitude. As illustrated in FIG. 11A, the first control terminal Q1 is modulated by the first control signal corresponding to the first normalized demodulation contrast C (or C_{D}) during the full first sub-time period and modulated by the second control signal corresponding to the second normalized demodulation contrast 1−C (or 1−C_{D}) during the full second sub-time period. The second control terminal Q2 is modulated by the second control signal corresponding to the second normalized demodulation contrast 1−C (or 1−C_{D}) during the full first sub-time period and modulated by the first control signal corresponding to the first normalized demodulation contrast C (or C_{D}) during the full second sub-time period. The first output during the first sub-time period, the second output during the first sub-time period, the first output during the second sub-time period, and the second output during the second sub-time period can be represented by CQ1, CQ2, CQ3, CQ4, as shown in FIG. 11A, where CQ1 represents R*C, CQ2 represents R*(1−C), CQ3 represents (1−R)(1−C), CQ4 represents (1−R)C.

In some implementations, the multi-tap photodetector is modulated by time (or phase). As illustrated in FIG. 11B, the first control signal and the second control signal have a peak amplitude that is equal with a phase difference, e.g., “pi”. The phase difference can be configured, such that the first output during the first sub-time period, the second output during the first sub-time period, the first output during the second sub-time period, and the second output during the second sub-time period can be represented by CQ1, CQ2, CQ3, CQ4, as shown in FIG. 11B, where CQ1 represents R*C, CQ2 represents R*(1−C), CQ3 represents (1−R)(1−C), CQ4 represents (1−R)C. For example, as shown in FIG. 11B, while an input optical signal is modulated to have a first intensity corresponding to R during the first sub-time period, the first control signal has the peak amplitude corresponding to C during a first portion of the first sub-time period, and the second control signal has the peak amplitude corresponding to (1−C) during a second portion of the first sub-time period, and while the input optical signal is modulated to have a second intensity corresponding to (1−R) during the second sub-time period, the second control signal has the peak amplitude corresponding to (1−C) during the first portion of the second sub-time period, and the first control signal has the peak amplitude corresponding to C during the second portion of the second sub-time period.

Dark currents, either modulated dark current I_{dm} or unmodulated dark current I_{du}, can be canceled out with the complementary measurement. For example, as illustrated in FIG. 12B, when there is no optical signal, e.g., R=0, and there are a first control signal applied on the first control terminal and a second control signal applied on the second control terminal, the first output from the first output terminal and the second output from the second output terminal during each of the first sub-time period and the second sub-time period include dark current information. However, a sum of (i) a first difference between the first output and the second output during the first sub-time period and (ii) a second difference between the first output and the second output during the second sub-time period is 0. Thus, when there is the modulated optical signal, the electrical output based on a sum of the first measurement output from the first sub-time period and the second measurement output from the second sub-time period, e.g., corresponding to (2C−1)(2R−1) as noted above, include no such dark current information.

FIG. 13A illustrates a scheme of an example symmetric measurement using a multi-tap photodetector (e.g., the multi-tap photodetector 1000 of FIG. 10). FIG. 13B illustrates a scheme of the example symmetric measurement with dark current compensation using the multi-tap photodetector. The technical advantage of the symmetric measurement scheme is that when there exists an imbalance between the two taps, the symmetric measurement scheme can be used to address such imbalance. An imbalance may exist when the portions of photocarriers extracted by the two taps are slightly different given the same applied bias, which can be attributed by variations in device fabrication, device design, etc.

The symmetric measurement can include: i) a first complementary measurement (e.g., Repeat+) performed during a first time period to generate a first result, and ii) a second complementary measurement (e.g., Repeat−) performed during a second time period to generate a second result. Each of the first and second complementary measurements can be same as or similar to the complementary measurement as illustrated in FIGS. 11A, 11B, 12A, and/or 12B. The output circuitry can generate an electrical output based on a difference of the first result and the second result, which can represent a multiplication of a particular weight element associated with a normalized value in a range of [−1, 1] and a particular input element associated with a normalized value in a range of [−1, 1].

In some implementations, in the first complementary measurement (e.g., Repeat+), e.g., as shown in FIG. 13A, during a first sub-time period of the first time period, an input optical signal is modulated to have a first intensity such that when detected, first photocarriers corresponding to a first normalized photocurrent response Rₚ in a range from 0 to 1 are generated, the first control terminal of the first tap is applied with a first control signal corresponding to a first normalized demodulation contrast C_{D}′ in a range from 0 to 1, and the second control terminal of the second tap is applied with a second control signal corresponding to a second normalized demodulation contrast (1−C_{D}′). A first measurement output can be generated based on a first difference, e.g., Rₚ*(2*C_{D}′−1), between a first output, e.g., Rₚ*C_{D}′, from the first output terminal of the first tap and a second output, e.g., Rₚ*(1−C_{D}′), from the second output terminal of the second tap.

In the first complementary measurement, e.g., as shown in FIG. 13A, during a second sub-time period of the first time period, the input optical signal is modulated to have a second intensity such that when detected, second photocarriers corresponding to a second normalized photocurrent response (1−Rₚ) are generated, the first control terminal of the first tap is applied with a third control signal corresponding to a third normalized demodulation contrast (1−C_{D}″) in the range from 0 to 1, and the second control terminal of the second tap is applied with a fourth control signal corresponding to a fourth normalized demodulation contrast C_{D}″. A second measurement output can be generated based on a second difference, e.g., (1−Rₚ)*(1−2*C_{D}″), between the first output, e.g., (1−Rₚ)*(1−C_{D}″), from the first output terminal of the first tap and the second output, e.g., (1−Rₚ)*C_{D}″, from the second output terminal of the second tap. A first sum of the first difference and the second difference for the first complementary measurement is (2*C_{A}−1)*2*Rₚ−(2C_{D}″−1), where C_{A}=(C_{D}′+C_{D}″)/2.

In the second complimentary measurement, e.g., as shown in FIG. 13A, during a first sub-time period of the second time period, the input optical signal is modulated to have a third intensity such that when detected, third photocarriers corresponding to the first normalized photocurrent response Rₚ are generated, the first control terminal of the first tap is applied with the third control signal corresponding to the third normalized demodulation contrast (1−C_{D}″), and the second control terminal of the second tap is applied with the fourth control signal corresponding to the fourth normalized demodulation contrast C_{D}″. A third measurement output can be generated based on a third difference, e.g., Rₚ*(1−2*C_{D}″), between a first output, e.g., Rₚ*(1−C_{D}″), from the first output terminal of the first tap and a second output, e.g., Rₚ*C_{D}″, from the second output terminal of the second tap.

In the second complimentary measurement, e.g., as shown in FIG. 13A, during a second sub-time period of the second time period, the input optical signal is modulated to have a fourth intensity corresponding to the second normalized photocurrent response (1−Rₚ), the first control terminal of the first tap is applied with the first control signal corresponding to the first normalized demodulation contrast C_{D}′, and the second control terminal of the second tap is applied with the second control signal corresponding to the second normalized demodulation contrast (1−C_{D}′). A fourth measurement output can be generated based on a fourth difference, e.g., (1−Rₚ)*(2*C_{D}′−1) between the first output, e.g., (1−Rₚ)*C_{D}′, from the first output terminal of the first tap and the second output, e.g., (1−Rₚ)*(1−C_{D}′), from the second output terminal of the second tap. A second sum of the third difference and the fourth difference for the second complementary measurement is −(2*C_{A}−1)*2*Rₚ+(2C_{D}′−1).

In some implementations, the output circuitry is configured to generate an electrical output based on the first measurement output, the second measurement output, the third measurement output, and the fourth measurement output. For example, the electrical output can be generated based on a difference between the first sum of the first measurement output and the second measurement output for the first complementary measurement and the second sum of the third measurement output and the fourth measurement output for the second complementary measurement. The first sum corresponds to a sum of the first difference and the second difference, e.g., (2*C_{A}−1)*2*Rₚ−(2C_{D}″−1). The second sum corresponds to a sum of the third difference and the fourth difference, e.g., −(2*C_{A}−1)*2*Rₚ+(2C_{D}′−1). The difference between the first sum and the second sum corresponds to 2*(2*C_{A}−1)*(2Rₚ−1).

The first intensity, the second intensity, the third intensity, and the fourth intensity can be determined based on a particular input element (e.g., I(j)) of the input matrix, and the first control signal, the second control signal, the third control signal, and the fourth control signal can be determined based on a particular weight element (e.g., Wᵢ(j)) of the weight matrix. The particular input element I(j) can be represented by (2Rₚ−1) with a range of [−1, 1], and the particular weight element Wᵢ(j) can be represented by (2*C_{A}−1) with a range of [−1, 1].

Dark currents, either modulated dark current I_{dm} or unmodulated dark current I_{du}, can be canceled out with the summary measurement. For example, as illustrated in FIG. 13B, for the summary measurement as shown in FIG. 13A, the first measurement output, the second measurement output, the third measurement output, and the fourth measurement output each include dark current information representing dark currents associated with the multi-tap photodetector. However, the difference between the first sum of the first measurement output and the second measurement output for the first complementary measurement and the second sum of the third measurement output and the fourth measurement output for the second complementary measurement includes no such dark current information.

### VI. Photonic Computing with Example DAC Schemes

A control circuitry can be configured to generate and/or store input information associated with an input matrix, weight information associated with a weight matrix, and/or bias information associated with a bias matrix. In some implementations, the control circuitry includes a digital-to-analog converter (DAC) circuit configured to convert digital values associated with input elements of the input matrix and/or weight elements of the weight matrix into analog electrical signals that can be used to modulate optical signals and/or photodetectors. In some implementations, DAC sharing schemes are implemented in a photonic computing system, which can effectively save DAC power and enable performing vector-matrix computation in parallel. As an example, outputs for weight information from the DAC circuit can be shared across multiple photodetector arrays, e.g., as illustrated with further details with respect to FIGS. 14A and 14B.

### DAC Sharing Schemes

FIG. 14A is a schematic diagram of an example system 1400 with an example digital-to-analog converter (DAC) sharing scheme for photonic computing. The system 1400 can include one or more memory units 1404 configured to store data, one or more processing units 1406 configured to process data, and one or more photonic computing units 1410. A photonic computing unit 1410 can be configured to perform photonic computation of a mathematical function (e.g., the mathematical function 122 of FIG. 1A or 150 of FIG. 1B) between adjacent layers (e.g., the layers 120 of FIG. 1A) in a neural network (e.g., the neural network 100 of FIG. 1A). The system 1400 can be a neural network system, and the photonic computing unit 1410 can be considered as a neural processing unit (NPU).

The photonic computing unit 1410 can be similar to, or same as, the photonic system 200 of FIGS. 2A-2B, 300 of FIGS. 3A-3B, 400 of FIG. 4A, 500 of FIG. 5A, 550 of FIG. 5B, 700 of FIG. 7, 800 of FIG. 8, or 900 of FIG. 9. The photonic computing unit 1410 can include one or more photodetector arrays 1416-1, 1416-2, 1416-3, 1416-4 (referred to generally as photodetector arrays 1416 and individually as photodetector array 1416) and a control circuitry 1411 coupled to the one or more photodetector arrays 1416. A photodetector array 1416 can include a plurality of photodetectors, e.g., 202 of FIGS. 2A-2B, 302 of FIGS. 3A-3B, 402 of FIG. 4A, 502 of FIGS. 5A-5B, 600 of FIG. 6A, 650 of FIG. 6B, 712 of FIG. 7, 812 of FIG. 8, 912, 912-1 or 912-2 of FIG. 9, or 1000 of FIG. 10. The photodetector array 1416 can be same as or similar to the photodetector array 710 of FIG. 7, 810 of FIG. 8, or 910 of FIG. 9. The control circuitry 1411 can be same as or similar to the control circuitry 204 of FIGS. 2A-2B, the control circuitry 304 of FIGS. 3A-3B, the control circuitry 404 of FIG. 4A, the control circuitry 504 of FIG. 5A or 5B, the control circuitry 704 of FIG. 7, the control circuitry 804 of FIG. 8, or the control circuitry 904 of FIG. 9.

In some implementations, the one or more processing units 1406 can include, but not limited to, e.g., a central processing unit (CPU), a graphics processing unit (GPU), a multi-core processor, a data processing unit (DPU), a tensor processing unit (TPU), a quantum processing unit (QPU), an Application Specific Integrated Circuit (ASIC), a Field Programmable Gate Array (FPGA), a microprocessor, or any other processing device, or a combination thereof. The one or more memory units 1404 can include, but not limited to, high bandwidth memory (HBM), Dynamic random-access memory (DRAM), Static random-access memory (SRAM), NAND flash memory, NOR flash memory, Phase-change memory (PCM), Resistive Random-Access Memory (ReRAM), Ferroelectric RAM (FRAM), Magnetoresistive Random Access Memory (MRAM), a latch/flip-flop based memory, a floating-gate based memory, and/or any other memory devices.

In some implementations, the mathematical function includes an input matrix such as N-by-1 input matrix (e.g., the input matrix 152 of FIG. 1B), a weight matrix such as an M-by-N weight matrix (e.g., the weight matrix 154 of FIG. 1B), and an output matrix such as an M-by-1 output matrix (e.g., the output matrix 158 of FIG. 1B). The mathematical function can also include a bias matrix such as an M-by-1 bias matrix (e.g., the bias matrix 156 of FIG. 1B). Each of M and N is an integer. M can be smaller than, identical to, or greater than N.

In some implementations, the control circuitry 1411 includes a digital-to-analog converter (DAC) circuit 1412 having an output electrically coupled to a plurality of devices including one of (i) a plurality of optical sources, (ii) a plurality of optical modulators, or (iii) multiple photodetectors. The DAC circuit 1412 is configured to provide a modulation signal configured to modulate the plurality of devices. The modulation signal can represent (i) a particular input element of an input matrix or (ii) a particular weight element of a weight matrix.

In some implementations, as illustrated in FIG. 14A, an input element in the input matrix includes multiple values, e.g., input element Iⱼ is a vector including 4 values Vⱼ₁, Vⱼ₂, Vⱼ₃, Vⱼ₄. The DAC circuit 1412 can generate a modulation signal representing a particular weight element Wᵢⱼ of the weight matrix corresponding to the input element. For example, the particular weight element Wᵢⱼ can be W₁ⱼ, W₂ⱼ, W₃ⱼ, . . . , or Wₘⱼ, where i is an integer in a range from 1 to m, where j is an integer in a range from 1 to n. The output of the DAC circuit 1412 can be electrically coupled to a group of multiple photodetectors in the one or more photodetector arrays 1416. A number of the multiple values in the input element corresponds to (e.g., is identical to) a number of the multiple photodetectors receiving the modulation signal. In some implementations, the group of multiple photodetectors, e.g., 4, are arranged in separate photodetector arrays, e.g., 1416-1, 1416-2, 1416-3, and 1416-4.

In a photonic computation, the DAC circuit 1412 can output first electrical signals to respectively modulate multiple optical sources or optical modulators 1418-1, 1418-2, 1418-3, 1418-4 (referred to generally as optical sources or optical modulators 1418 and individually as optical sources or optical modulator 1418) to generate multiple modulated optical signals. The optical sources or optical modulators 1418 can be same as, or similar to, the optical source or optical modulator 702 of FIG. 7, 802 of FIG. 8, or 902 of FIG. 9. Each of the multiple modulated optical signals represents a respective value of the multiple values of the input element in the input matrix, e.g., Vⱼ₁, Vⱼ₂, Vⱼ₃, Vⱼ₄. Each of the group of multiple photodetectors is modulated by the modulation signal representing the particular weight element Wᵢⱼ corresponding to the input element. The multiple modulated optical signals can be directed respectively to the group of multiple photodetectors each modulated by the same modulation signal. Each photodetector of the group of multiple photodetectors generates an output corresponding to a multiplication of the particular weight element in the weight matrix and the respective value of the input element.

In some implementations, the control circuitry 1411 includes an analog-to-digital converter (ADC) circuit 1414 coupled to each photodetector in the one or more photodetector arrays 1416. The ADC circuit 1414 can be configured to receive the outputs from the group of multiple photodetectors and convert the outputs into corresponding digital values. The control circuitry 1411 can generate a digital result corresponding to a multiplication (e.g., Wᵢⱼ*Iⱼ) of the input element of the input matrix and the particular weight element of the weight matrix, e.g., by summing the corresponding digital values corresponding to multiplications of the particular weight element with each of the multiple values in the input element, e.g., Wᵢⱼ*Iⱼ=Wᵢⱼ*Vⱼ₁+Wᵢⱼ*Vⱼ₂+Wᵢⱼ*Vⱼ₃+Wᵢⱼ*Vⱼ₄.

In some implementations, another group of multiple photodetectors can be modulated based on another particular weight element corresponding to the input element, e.g., W₍ᵢ₊₁₎ⱼ. The DAC circuit 1412 can output another modulated signal to be shared by the another group of multiple photodetectors. For example, a first group of multiple photodetectors is modulated based on Wᵢⱼ, and a second group of multiple photodetectors is modulated based on W₂ⱼ. The multiple modulated optical signals representing the multiple values of the input element in the input matrix, e.g., Vⱼ₁, Vⱼ₂, Vⱼ₃, Vⱼ₄, can be directed to different groups of multiple photodetectors sequentially or simultaneously in space. The photonic computing unit 1410 can include at least one optical element configured to direct the multiple modulated optical signals to the different groups of multiple photodetectors. The at least one optical element can include at least one of an optical diffuser (e.g., the optical diffuser 706 of FIG. 7), an optical dot projector (e.g., the optical dot projector 806 of FIG. 8 or 906 of FIG. 9), an elliptical/circular lens, or an microlens array. A photodetector array 1416 can include a microlens array covering photodetectors to focus light onto the photodetectors.

In some implementations, the multiple optical sources or optical modulators 1418 are formed on separate substrates. In some implementations, the multiple optical sources or optical modulators 1418, the one or more photodetector arrays 1416, the control circuitry 1411, one or more processing units 1406, and one or more memory units 1404 are integrated on an interposer 1402.

In some implementations, at least part of optical components in the photonic computing unit 1410 (e.g., the optical sources or optical modulators 1418, optical diffusers or optical dot projectors, and/or photodetector arrays 1416) can be integrated in a photonic integrated circuit (PIC). The optical components can have a waveguide structure that can be made of any suitable material, e.g., an insulator material such as polymer, glass, sapphire, oxide, nitride, a metallic material such as Au, Ag, or a semiconductor material such as Si, Ge, or III-V, or a nonlinear material such as LiNbO₃, BaTiO₃. The control circuitry 1411 can include a Complementary Metal-Oxide-Semiconductor (CMOS) device, and can be integrated in an electrical integrated circuit (EIC). The photonic integrated circuit and the electrical integrated circuit can be integrated in a chip package. In some implementations, the one or more processing units 1406, the one or more memory units 1404, and the chip package can be integrated on the interposer 1402, e.g., as illustrated in FIG. 14A.

FIG. 14B is a schematic diagram of an example system 1450 with another example digital-to-analog converter (DAC) sharing scheme. The system 1450 can be same as, or similar to, the system 1400 of FIG. 14A, and can include one or more memory units 1404, one or more processing units 1406, one or more photonic computing units 1410 that can be integrated on an interposer 1402. Note that the system 1450 can be the same as the system 1400 of FIG. 14A, and the system 1450 or 1400 can implement one or more DAC sharing schemes including those described with respect to FIGS. 14A and 14B.

As illustrated in FIG. 14B, the DAC circuit 1412 outputs the modulation signal representing the particular input element (e.g., Iⱼ) to multiple optical emitters in an optical emitter array 1452 that can be an a VCSEL array, an EEL array, a LED array, or a Micro-LED array. Each of the multiple optical emitters is modulated by the same modulation signal to generate a modulated optical signal representing the particular input element (e.g., Iⱼ). In some implementations, the modulation signal can be output to an optical modulator array including multiple optical modulators. Each of the multiple optical modulators can be configured to receive an input optical signal and modulate the input optical signal based on the modulated signal from the DAC circuit 1412 to generate a corresponding modulated optical signal. The input optical signals received by the multiple optical modulators can be generated by a same optical source or different optical sources. The multiple optical emitters or the multiple optical modulators can be integrated on a same substrate.

The photonic computing unit 1410 can include one or more optical elements 1454 configured to direct multiple modulated optical signals from the multiple optical emitters 1452 (or optical modulators) to a corresponding group of photodetectors in a photodetector array 1416. The one or more optical elements 1454 can include an optical diffuser (e.g., the optical diffuser 706 of FIG. 7), an optical dot projector (e.g., the optical dot projector 806 of FIG. 8 or 906 of FIG. 9), an elliptical/circular lens, or a microlens array, and the photodetector array 1416 can include a microlens array. The corresponding group of photodetectors can be arranged in a same area of the photodetector array 1416, e.g., as illustrated in FIG. 14B.

Each photodetector in the corresponding group of photodetectors is modulated based on a respective weight element Wᵢⱼ in the weight matrix corresponding to the particular input element, e.g., W₁ⱼ, W₂ⱼ, W₃ⱼ, . . . , or Wₘⱼ, where i is an integer in a range from 1 to m, where j is an integer in a range from 1 to n. A number of the optical emitters or optical modulators can be identical to a number of photodetectors in the corresponding group. For example, as illustrated in FIG. 14B, four modulated optical signal representing the particular input element Iⱼ are directed to four photodetectors respectively modulated based on weight elements W₁ⱼ, W₂ⱼ, W₃ⱼ, W₄ⱼ.

An analog-to-digital converter (ADC) circuit 1414 can be coupled to each photodetector in the photodetector array 1416 and configured to receive outputs from the corresponding group of photodetectors and convert the outputs into corresponding digital values. Each digital value corresponds to a multiplication (e.g., Wᵢⱼ*Iⱼ) of the particular input element Iⱼ of the input matrix and the respective weight element Wᵢⱼ of the weight matrix.

In some implementations, in wavelength-based computation (e.g., as illustrated with respect to FIG. 4C), the DAC circuit 1412 can generate a plurality of modulation signals respectfully representing a plurality of input elements in the input matrix, e.g., I₁, I₂, I₃, . . . , Iₙ, and output the plurality of modulation signals respectfully to a plurality of optical emitter or modulator arrays. Optical emitters or modulators in each array are modulated by a same modulation signal to generate modulated optical signals that can be directed to corresponding photodetectors modulated based on respective weight elements, e.g., as shown in FIG. 14B. The control circuitry 1411 can generate electrical outputs based on outputs from photodetectors in the photodetector array 1416, and the electrical outputs representing a computation result of multiplication of the input matrix and the output matrix.

In some implementations, in time-based computation (e.g., as illustrated with respect to FIG. 4B), the DAC circuit 1412 can sequentially generate the plurality of modulation signals respectfully representing the plurality of input elements in the input matrix, e.g., I₁, I₂, I₃, . . . , Iₙ, and output each of the plurality of modulation signals to the optical emitter or modulator array 1452 in a respective time period. In the respective time period, the one or more optical elements 1454 can direct a respective group of modulated optical signals to a corresponding group of photodetectors in the photodetector array 1416.

### Binary DAC

In some implementations, DAC output can be represented in a binary format. For example, a DAC power (P) can be scaled with a number of bits (b) by P=P_level*2^{b}, where P_level is a power needed for one level. By introducing the binary DAC, the scaling becomes P=P_level*b. In such a way, a DAC circuit (e.g., the DAC circuit 1412 of FIG. 14A or 14B) can provide a modulation signal representing a larger level range with a limited power variation. Accordingly, multiple optical sources or signals can be modulated together to represent an input element of the input matrix, and/or multiple photodetectors can be modulated together to represent a weight matrix of the weight matrix.

FIG. 15 illustrates an example DAC scheme 1500 using binary DAC. In one example, in a computation of an input element “7” multiplying by a weight element “12”, the input element can be represented by a modulated optical signal with an optical intensity corresponding to a value of 7, and the weight element can be represented by a combination of a weight binary modulation and a weight analog adjustment, e.g., as shown in FIG. 15.

The weight binary modulation corresponds to a binary number including a multi-digital value “1100”. The weight element can be represented by a group of four photodetectors each modulated by a respective modulation signal based on a respective digit of the multi-digit value, e.g., 1, 1, 0, or 0. To implement the analog adjustment, each photodetector of the group of four photodetectors can be associated with a power-factor of the binary number, e.g., 2\hat{ }3 for 1, 2\hat{ }2 for 1, 2\hat{ }1 for 0, or 2\hat{ }0 for 0, respectively. A photodetector can include a number of pixels. The four photodetectors can have one or more properties that are different from one another, including, but not limited to, an optical fill factor of pixels, a number of pixels, a number of activated pixels, a bias associated with a photodetector gain, or a number of activated gate circuitry that control a flow of outputs from the photodetector.

In some implementations, the weight element can be represented by four groups of one or more photodetectors. Each group of one or more photodetectors is associated with a power-factor of the binary number, and the four groups of one or more photodetectors of the multiple photodetectors have one or more properties that are different from one another, including an optical fill factor, a number of photodetectors, a number of activated photodetectors, a bias associated with a photodetector gain, or a number of activated gate circuitry that control a flow of outputs from the one or more photodetectors.

### VI. Example Photonic Computing Systems with Spatial-Spatial Mapping

FIG. 16A is a schematic diagram of an example photonic computing system 1600 with area illumination for parallel computation. The photonic computing system 1600 can be configured to perform a photonic computation of a mathematical function (e.g., the mathematical function 122 of FIG. 1A or 150 of FIG. 1B) between adjacent layers (e.g., the layers 120 of FIG. 1A) in a neural network (e.g., the neural network 100 of FIG. 1A). The photonic computing system 1600 can be similar to, or same as, the photonic system 200 of FIGS. 2A-2B or 300 of FIGS. 3A-3B, the photonic computing system 700 of FIG. 7, 800 of FIG. 8, 900 of FIG. 9, 1400 of FIG. 14A, or 1450 of FIG. 14B.

In some implementations, the mathematical function includes an input matrix such as N-by-1 input matrix (e.g., the input matrix 152 of FIG. 1B), a weight matrix such as an M-by-N weight matrix (e.g., the weight matrix 154 of FIG. 1B), and an output matrix such as an M-by-1 output matrix (e.g., the output matrix 158 of FIG. 1B). The mathematical function can also include a bias matrix such as an M-by-1 bias matrix (e.g., the bias matrix 156 of FIG. 1B). Each of M and N is an integer. M can be smaller than, identical to, or greater than N.

Similar to the photonic computing system 700 of FIG. 7, 900 of FIG. 9, 1400 of FIG. 14A, or 1450 of FIG. 14B, the photonic computing system 1600 includes a photodetector array 1602 having an array of photodetectors in rows and columns (e.g., M columns×N rows) that can be modulated based on a weight matrix. As illustrated in FIG. 16A, each photodetector in the photodetector array 1602 can be modulated with a corresponding weight element Wᵢⱼ to function as a modulation array for photonic computation, where i is an integer in a range from 1 to m, and j is an integer in a range from 1 to n. The photodetector can be same as, or similar to, the photodetector 202 of FIGS. 2A-2B, 302 of FIGS. 3A-3B, 402 of FIG. 4A, or 502 of FIGS. 5A-5B. The photodetector can be a single photodetector like a photodiode, an APD, a phototransistor (e.g., the phototransistor 600 of FIG. 6A), a balanced NPT (e.g., the balanced NPT 650 of FIG. 6B), or a multi-tap photodetector (e.g., 1000 of FIG. 10).

The photonic computing system 1600 can include a control circuitry 1604 coupled to the photodetector array 1602 and coupled to each row of photodetectors. Each photodetector in a row can be coupled to an output circuit in the control circuitry 1604. The control circuitry 1604 can be similar to the control circuitry 204 of FIGS. 2A-2B, the control circuitry 304 of FIGS. 3A-3B, the control circuitry 404 of FIG. 4A, the control circuitry 504 of FIG. 5A or 5B, the control circuitry 704 of FIG. 7, the control circuitry 804 of FIG. 8, the control circuitry 904 of FIG. 9, or the control circuitry 1411 of FIG. 14A or 14B.

In some implementations, as illustrated in FIG. 16A, the photonic computing system 1600 is configured to generate a plurality of modulated optical signals, e.g., by a plurality of optical sources or optical modulators 1606 (e.g., 702 of FIG. 7, 802 of FIG. 8, or 902 of FIG. 9) based on modulation signals. Each of the plurality of modulated optical signals has an optical intensity representing a respective input element of the input matrix (e.g., I₁, I₂, I₃, . . . , Iₙ).

Each modulated optical signal representing the respective input element can be directed to a corresponding column of photodetectors by at least one optical element 1608. The at least one optical element 1608 can include an elliptical lens arranged above the corresponding column of photodetectors and configured to focus the modulated optical signal to the photodetectors in the corresponding column. In some implementations, the at least one optical element 1608 includes an optical diffuser (e.g., the optical diffuser 706 of FIG. 7), an optical dot projector (e.g., the optical dot projector 806 of FIG. 8 or 906 of FIG. 9), an elliptical/circular lens, or a microlens array. The plurality of modulated optical signals can be directed to corresponding columns of photodetectors in parallel, which can achieve parallel photonic computation.

The corresponding column of photodetectors are respectively modulated based on a corresponding group of weight elements in the weight matrix that are associated with the respective input element. For example, a first group of weight elements W₁₁, W₂₁, W₃₁, . . . , Wₘ₁ are associated with I₁, a second group of weight elements W₁₂, W₂₂, W₃₂, . . . , Wₘ₂ are associated with I₂, a third group of weight elements W₁₃, W₂₃, W₃₃, . . . , Wₘ₃ are associated with I₃, and so on, a nth group of weight elements W₁ₙ, W₂ₙ, W₃ₙ, . . . , Wₘₙ are associated with Iₙ.

Each photodetector (e.g., a photodetector at the ith row and the jth column) in the photodetector array 1602 can be modulated based on a respective weight element Wᵢⱼ and be configured to detect a corresponding modulated optical signal representing a respective input element Iⱼ to generate an output. The output represents a multiplication of the respective weight element Wᵢⱼ and the respective input element Iⱼ, e.g., Wᵢⱼ*Iⱼ. Photodetectors in each row (e.g., an ith row) can be coupled together to an output circuit in the control circuitry 1604, and the output circuit can sum the outputs from the photodetectors in the same row to generate a result representing an output element in the output matrix Oᵢ (e.g., O₁, O₂, O₃, . . . , Oₘ), where

$${O}_{i} = α ( {\sum }_{j = 1}^{N} {W}_{i} ( j ) I ( j ) ) .$$

α represents an activation function of the mathematical function that can be implemented by at least one of the control circuitry 1604 or the photodetectors in the photodetector array 1602, e.g., as discussed above.

In some implementations, the photodetector array 1602 includes an additional column of photodetectors that can be modulated based on bias values of the bias matrix. The optical sources or modulators 1606 can generate an additional modulated optical signal having an optical intensity corresponding to a normalized value of 1. The additional modulated optical signal can be directed to the additional column of photodetectors, e.g., by using at least one corresponding optical element like 1608. Each photodetector in the additional column is configured to generate an output by detecting the additional modulated optical signal, the output representing a multiplication of a normalized value of “1” and a respective bias value bᵢ. The photodetector can be also coupled to a corresponding output circuit, together with other photodetectors in a same row. The corresponding output circuit can add the outputs from the n+1 photodetector in the same row and generate a result representing the output element in the output matrix, where

$${O}_{i} = α ( {\sum }_{j = 1}^{N} {W}_{i} ( j ) I ( j ) + {b}_{i} ) .$$

FIG. 16B is a schematic diagram of an example photonic computing system 1650 with array illumination for parallel computation. The photonic computing system 1650 is similar to the photonic computing system 1600, and include a photodetector array 1652 and a control circuitry 1654. The control circuitry 1654 can be same as or similar to the control circuitry 1604 of FIG. 16A.

The photodetector array 1652 can be similar to the photodetector array 1602 of FIG. 16A. Different from the photonic computing system 1600 where photodetectors are arranged in N groups (e.g., N columns) of M photodetectors, the photonic computing system 1600 is configured to arrange the photodetectors in the photodetector array 1652 in M groups of N photodetectors. Each group of N photodetectors is arranged together in a respective area.

The photonic computing system 1600 can include an optical source (or modulator) array 1656 configured to generate modulated optical signals to be directed to the photodetector array 1602 by one or more optical elements 1658, e.g., as illustrated in FIG. 16B. The optical source (or modulator 1656) can be same as or similar to the optical source or modulator 702 of FIG. 7, 802 of FIG. 8, or 902 of FIG. 9. The one or more optical elements 1658 can include at least one of an optical diffuser (e.g., the optical diffuser 706 of FIG. 7), an optical dot projector (e.g., the optical dot projector 806 of FIG. 8 or 906 of FIG. 9), an elliptical/circular lens, or a microlens array, and the photodetector array 1602 can include a microlens array.

In some implementations, the optical source (or modulator) array 1656 includes M×N optical sources (or optical modulators) configured to generate M×N modulated optical signals. Each modulated optical signal representing a respective input element is directed to a corresponding photodetector modulated based on a weight element corresponding to the respective input element.

In some implementations, the optical source (or modulator) array 1656 includes N optical sources (or optical modulators) configured to generate N modulated optical signals each representing respective input elements (e.g., I₁, I₂, I₃, . . . , Iₙ) of the input matrix. In some implementations, each of the N modulated optical signals is generated by modulating a respective optical source based on a respective input element of the input matrix, or by modulating an input optical signal based on the respective input element by a respective optical modulator. Each of the N modulated optical signals can have a respective wavelength, and at least two of respective wavelengths of the N modulated optical signals can be different. In some implementations, each of the N modulated optical signals has a same wavelength.

The N modulated optical signals can be directed to each of M groups of N photodetectors, e.g., sequentially. An ith group of N photodetectors can be modulated based on a corresponding group of N weights in the M×N weight matrix (e.g., Wᵢ₁, Wᵢ₂, Wᵢ₃, . . . , Wᵢₙ). Each of the N modulated optical signals is associated with a respective input element Iⱼ of N elements in the input matrix and directed to a corresponding photodetector in the ith group of N photodetectors, and the corresponding photodetector is modulated based on a weight element Wᵢⱼ corresponding to the respective input element in the ith group of N weight elements (e.g., I₁ for Wᵢ₁, I₂ for Wᵢ₂, I₃ for Wᵢ₃, I₄ for Wᵢ₄). The corresponding photodetector is configured to generate a respective output representing a multiplication of the respective input element Iⱼ and the weight element Wᵢⱼ. Each group of N photodetectors is coupled to an output circuit in the control circuitry 1654. The output circuit can generate a respective electrical output based on a sum of N respective results from the group of N photodetectors.

In some implementations, the mathematical function further includes an M-by-1 bias matrix, and the optical source or modulator array 1656 is configured to generate an additional modulated optical signal different from the N modulated optical signals. The additional modulated optical signal can have an intensity corresponding to a normalized value of 1. The photodetector array 1652 can include M groups of (N+1) photodetectors. Each group includes N photodetectors for N weight elements in the weight matrix and an additional photodetector for a respective bias value in the M-by-1 bias matrix. A bias result can be generated by the additional photodetector detecting the additional modulated optical signal, and the bias result corresponds to a multiplication of the value of 1 and the respective bias value. The respective electrical output can be generated based on the sum of the N respective results from the N photodetectors and the respective bias result from the additional photodetector. The N photodetectors and the additional photodetector in a same group can be arranged in a same area.

### VIII. Example Processes for Photonic Computing

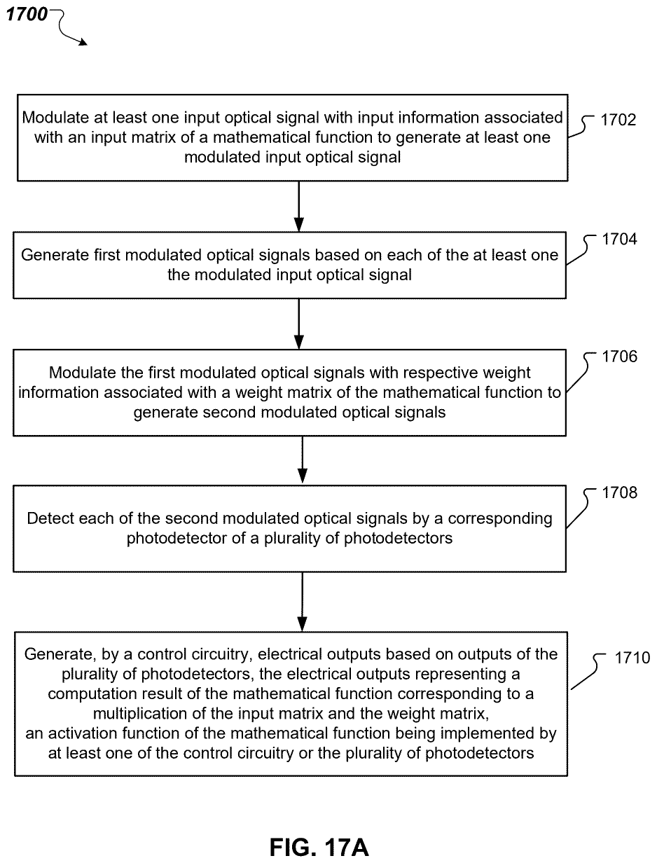

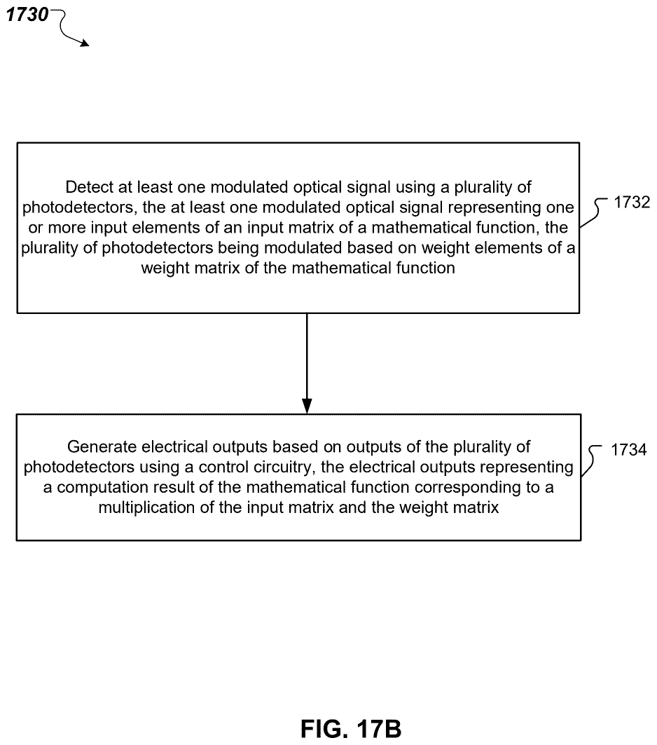

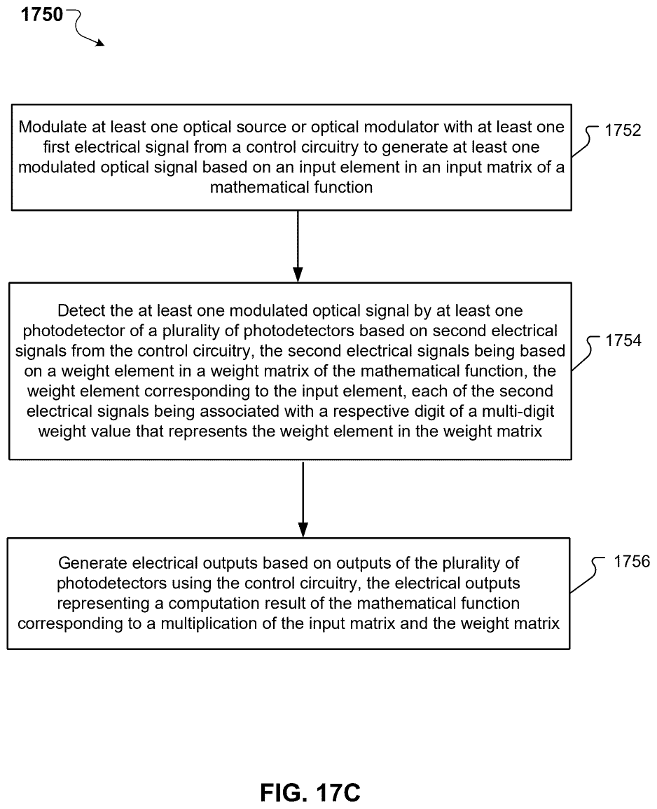

FIG. 17A is a flowchart of an example process 1700 for photonic computing. The process 1700 can be performed by a photonic computing system, e.g., the photonic system 200 of FIGS. 2A-2B, the photonic system 300 of FIGS. 3A-3B, the photonic computing system 400 of FIG. 4A, the photonic computing system 500 of FIG. 5A, or the photonic computing system 550 of FIG. 5B.

At 1702, at least one input optical signal is modulated with input information associated with an input matrix of a mathematical function to generate at least one modulated input optical signal each having an optical intensity corresponding to an input element of the input matrix. At 1704, first modulated optical signals are generated based on each of the at least one the modulated input optical signal. At 1706, the first modulated optical signals are modulated with respective weight information associated with a weight matrix of the mathematical function to generate second modulated optical signals. At 1708, each of the second modulated optical signals is detected by a corresponding photodetector of a plurality of photodetectors. At 1710, a control circuitry generates electrical outputs based on outputs of the plurality of photodetectors. The electrical outputs represent a computation result of the mathematical function corresponding to a multiplication of the input matrix and the weight matrix. An activation function of the mathematical function is implemented by at least one of the control circuitry or the plurality of photodetectors.

In some implementations, e.g., as illustrated in FIG. 1B, the input matrix includes an N-by-1 input matrix, the weight matrix includes an M-by-N weight matrix, and the computation result includes an M-by-1 matrix. Each of M and N is an integer.

The process 1700 can be used to implement time-based computation, e.g., as shown in FIG. 4B. In some implementations, e.g., as shown in FIG. 4A, the plurality of photodetectors include M photodetectors, the first modulated optical signals include M first modulated optical signals, and the second modulated optical signals include M second modulated optical signals. As shown in FIG. 4B, the process 1700 includes: during each of N time periods, modulating the at least one input optical signal with a respective intensity corresponding to a respective element of N elements in the N-by-1 input matrix, modulating the M first modulated optical signals based on a respective group of M weights in the M-by-N weight matrix corresponding to the respective element to generate the M second modulated optical signals, and accumulating a respective result by each of the M photodetectors detecting a respective second modulated optical signal of the M second modulated optical signals, the respective result corresponding to a multiplication of the respective element and a corresponding weight of the respective group of M weights, and generating a respective output by each of the M photodetectors representing a sum of N respective results over the N time periods.

In some implementations, the mathematical function further includes an M-by-1 bias matrix. The process 1700 can further include, e.g., as shown in FIG. 4B, during an additional time period different from the N time periods, modulating the input optical signal with an intensity corresponding to a normalized value of 1, modulating the M first modulated optical signals respectively based on M bias values of the M-by-1 bias matrix, and accumulating a respective bias result by each of the M photodetectors detecting a corresponding second modulated optical signal, the respective bias result corresponding to a multiplication of the value of 1 and a corresponding bias value of the M bias values. The respective output by each of the M photodetectors represents a sum of the N respective results over the N time periods and the respective bias result for the additional time period.

In some implementations, generating the electrical outputs based on the outputs of the plurality of photodetectors using the control circuitry includes: generating each of the electrical outputs based on the respective output of a corresponding photodetector of the M photodetectors, the electrical output corresponding to an element of the computation result

$$α ( {\sum }_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, bᵢ represents a bias value in the M-by-1 bias matrix, where i is an integer in a range from 1 to M, and j is an integer in a range from 1 to N.

The process 1700 can be used to implement space-based computation or wavelength-based computation, e.g., as shown in FIG. 4C. In some implementations, the at least one input optical signal includes N input optical signals. The process 1700 can include: modulating each of the N input optical signals to have a respective intensity based on a respective element of N elements in the N-by-1 input matrix to generate a respective modulated input optical signal of N modulated input optical signals, generating N groups of M first modulated optical signals using the N modulated input optical signals, and, for each group of the N groups of M first modulated optical signals, modulating the respective M first modulated optical signals based on a respective group of M weights in the M-by-N weight matrix to generate a respective group of M second modulated optical signals.

In some implementations, the plurality of photodetectors includes N×M photodetectors, and generating the electrical outputs can include: for each of M groups, adding outputs of corresponding N photodetectors of the N×M photodetectors to generate M electrical outputs representing the multiplication of the input matrix and the weight matrix.

In some implementations, the plurality of photodetectors includes M photodetectors, and the process 1700 includes: detecting, by each of the M photodetectors, a respective second modulated optical signal from each of N groups of M second modulated optical signals to generate a respective result, the respective result corresponding to a multiplication of a corresponding element of the N elements in the N-by-1 input matrix and a corresponding weight in the M-by-N weight matrix; and generating a respective output by each of the M photodetectors by accumulating a sum of N respective results based on N respective second modulated optical signals from the N groups of M second modulated optical signals.

In some implementations, the mathematical function further includes an M-by-1 bias matrix, and the respective intensity corresponds to a normalized value in a range from 0 to 1. The at least one input optical signal includes an additional input optical signal different from the N input optical signals. The process 1700 can further include: modulating the additional input optical signal with an intensity corresponding to a value of 1, generating additional M first modulated optical signals based on the additional input optical signal, modulating the additional M first modulated optical signals respectively based on M bias values in the M-by-1 bias matrix to generation additional M second modulated optical signals, and generating a respective bias result by a corresponding photodetector of the M photodetectors detecting a corresponding additional second modulated optical signal, the respective bias result corresponding to a multiplication of the value of 1 and a corresponding bias value of the M bias values. The respective output is generated by each of the M photodetectors by accumulating the respective bias result, together with the N respective results.

In some implementations, each of the N input optical signals has a respective wavelength, and at least two of respective wavelengths of the N input optical signals can be different. In some implementations, each of the N input optical signals has a same wavelength.

In some implementations, the photonic computing system is a bipolar photonic computing system, e.g., as shown in FIG. 5A or 5B. The at least one modulated input optical signal can include a first modulated input optical signal and a second modulated input optical signal, and the plurality of photodetectors include a plurality of balanced photodetectors (e.g., 502 of FIG. 5A or 5B). The process 1700 can include: generating a first plurality of first modulated optical signals based on the first modulated input optical signal, modulating the first plurality of first modulated optical signals with the respective weight information associated with the weight matrix of the mathematical function to generate a first plurality of second modulated optical signals as positive modulated optical signals; generating a second plurality of first modulated optical signals based on the second modulated input optical signal, modulating the second plurality of first modulated optical signals with the respective weight information associated with the weight matrix of the mathematical function to generate a second plurality of second modulated optical signals as negative modulated optical signals, a number of the positive modulated optical signals being identical to a number of the negative modulated optical signals; detecting, by each of the plurality of balanced photodetectors, (i) a corresponding positive modulated optical signal of the positive modulated optical signals and (ii) a corresponding negative modulated optical signal of the negative modulated optical signals; and generating the electrical outputs based on outputs of the plurality of balanced photodetectors.

In some implementations, the process 1700 further includes, e.g., as shown in FIG. 5A, generating, by a variable optical splitter (e.g., the variable optical splitter 506 of FIG. 5A), the first modulated input optical signal and the second modulated input optical signal based on an initial input optical signal and the input information associated with the input matrix. The first modulated input optical signal has a first intensity, and the second modulated input optical signal has a second intensity, and the first intensity and the second intensity are determined based on the input information.

In some implementations, the process 1700 further includes, e.g., as shown in FIG. 5B, modulating, by a first optical modulator, a first input optical signal with first input information to generate the first modulated input optical signal with a first intensity; and modulating, by a second optical modulator, a second input optical signal with second input information to generate the first modulated input optical signal with a second intensity. The first input information and the second input information are determined based on the input information associated with the input matrix.

In some implementations, the first intensity represents a first normalized value in a range from 0 to 1, the second intensity represents a second normalized value in the range from 0 to 1, and a difference between the first intensity and the second intensity corresponds to a third normalized value in a range from −1 to 1.

In some implementations, each of the plurality of photodetectors includes a nonlinear phototransistor (e.g., the photoresistor 600 of FIG. 6A) configured based on the activation function of the mathematical function, and the control circuitry is configured to generate the electrical outputs based on the outputs of the plurality of photodetectors.

In some implementations, each of the plurality of photodetectors includes a photodiode configured to have a linear photon-response, and the control circuitry is configured to generate the electrical outputs based on the outputs of the plurality of photodetectors and the activation function of the mathematical function.

In some implementations, the control circuitry is configured to store the input information associated with the input matrix and the weight information associated with the weight matrix.

In some implementations, the process 1700 can be used for computing adjacent layers in a neural network (e.g., the neural network 100 of FIG. 1A). The process 1700 can include: performing a first computation of the mathematic function between a first layer and a second layer of a neural network using the photonic system, where the first layer is represented by the input matrix, and the second layer is represented by the computation result; and performing a second computation of a second mathematical function between the second layer and a third layer of the neural network using the photonic system. Performing the second computation can include: modulating the at least one input optical signal with second input information that is generated based on the computation result. The first layer, the second layer, and the third layer can be sequential to one another in the neural network.

FIG. 17B is a flowchart of an example process 1730 for photonic computing. The process 1730 can be performed by a photonic computing system, e.g., the photonic system 200 of FIGS. 2A-2B, the photonic system 300 of FIGS. 3A-3B, the photonic computing system 700 of FIG. 7, the photonic computing system 800 of FIG. 8, the photonic computing system 900 of FIG. 9, the photonic computing system 1400 of FIG. 14A or 1450 of FIG. 14B, or the photonic computing system 1600 of FIG. 16A or 1650 of FIG. 16B.

At 1732, at least one modulated optical signal is detected using a plurality of photodetectors. The at least one modulated optical signal represents one or more input elements of an input matrix of a mathematical function, and the plurality of photodetectors are modulated based on weight elements of a weight matrix of the mathematical function. At 1734, electrical outputs are generated based on outputs of the plurality of photodetectors using a control circuitry. The electrical outputs represent a computation result of the mathematical function corresponding to a multiplication of the input matrix and the weight matrix. The control circuitry can be same as or similar to the control circuitry 204 of FIGS. 2A-2B, the control circuitry 304 of FIGS. 3A-3B, the control circuitry 404 of FIG. 4A, the control circuitry 504 of FIG. 5A or 5B, the control circuitry 704 of FIG. 7, the control circuitry 804 of FIG. 8, the control circuitry 904 of FIG. 9, the control circuitry 1411 of FIG. 14A or 14B, or the control circuitry 1604 of FIG. 16A or 1654 of FIG. 16B. The photodetector can be same as, or similar to the photodetector 202 of FIGS. 2A-2B, 302 of FIGS. 3A-3B, 402 of FIG. 4A, 502 of FIGS. 5A-5B, 712 of FIG. 7, 812 of FIG. 8, or 912 of FIG. 9. The photodetector can be a single photodetector like a photodiode, an APD, a phototransistor (e.g., the phototransistor 600 of FIG. 6A), a balanced NPT (e.g., the balanced NPT 650 of FIG. 6B), or a multi-tap photodetector (e.g., the multi-tap photodetector 1000 of FIG. 10). The plurality of photodetectors can form one or more photodetector arrays, e.g., the photodetector array 710 of FIG. 7, 810 of FIG. 8, 910 of FIG. 9, 1416 of FIG. 14A or 14B, or 1602 of FIG. 16A or 1652 of FIG. 16B.

In some implementations, an activation function of the mathematical function is implemented by at least one of the control circuitry or the plurality of photodetectors. In some implementations, each of the plurality of photodetectors includes a nonlinear phototransistor configured based on the activation function, and the control circuitry is configured to generate the electrical outputs based on the outputs of the plurality of photodetectors. In some implementations, each of the plurality of photodetectors includes a photodiode, LIPD, APD, or SPAD configured to have a linear photo-response, and the control circuitry is configured to generate the electrical outputs based on the outputs of the plurality of photodetectors and the activation function.

In some implementations, the process 1730 further includes at least one of: modulating at least one optical source with input information corresponding to the input matrix to generate the at least one modulated optical signal, or modulating at least one input optical signal with input information corresponding to the input matrix by at least one optical modulator to generate the at least one modulated optical signal.

In some implementations, the at least one optical source includes a laser source (e.g., a VCSEL or EEL) or a light-emitting diode. Modulating the at least one optical source with the intensity information includes: modulating a bias voltage applied to the laser source or the light-emitting diode based on the input matrix.

In some implementations, a bias voltage applied to each of the plurality of photodetectors is modulated with respective weight information corresponding to the weight matrix of the mathematical function. For example, the photodetector can be a bias-voltage modulated single detector like PD/APD, LIPD, a balanced NPT, or a multi-tap photodetector.

In some implementations, the process 1730 further includes: directing the at least one modulated optical signal to at least part of the plurality of photodetectors in free space. In some implementations, e.g., as shown in FIG. 7, the at least one modulated optical signal is uniformly illuminated on the plurality of photodetectors. An optical diffuser (e.g., the optical diffuser 706 of FIG. 7) can be configured to direct the least one modulated optical signal to uniformly illuminate the plurality of photodetectors. In some implementations, e.g., as shown in FIG. 8, the at least one modulated optical signal is concentratedly illuminated on individual photodetectors of the plurality of photodetectors. The process 1730 can further include: directing, by an optical dot projector (e.g., the optical dot projector 806 of FIG. 8 or 906 of FIG. 9), the at least one modulated optical signal to generate illumination dots respectively on the individual photodetectors.

In some implementations, the input matrix includes an N-by-1 input matrix, the weight matrix includes an M-by-N weight matrix, and the computation result includes an M-by-1 matrix, where each of M and N is an integer.

In some implementations, the plurality of photodetectors include N groups of M photodetectors. The process 1730 includes: during each of N time periods, generating the at least one modulated optical signal with a respective intensity corresponding to a respective input element in the N-by-1 input matrix, directing the at least one modulated optical signal to illuminate at least part of the plurality of photodetectors, modulating a group of the N groups of M photodetectors based on a corresponding group of M weights in the M-by-N weight matrix corresponding to the respective input element, and generating a respective result by each of the group of M photodetectors detecting the at least one modulated optical signal, the respective result corresponding to a multiplication of the respective input element and a corresponding weight element of the corresponding group of M weights; and after the N time periods, generating M electrical outputs by the control circuitry, where each of the M electrical outputs is based on a sum of N respective results from the N groups of M photodetectors.

In some implementations, the mathematical function further includes an M-by-1 bias matrix. The process 1730 can further include: during an additional time period different from the N time periods, generating the at least one modulated optical signal having an intensity corresponding to a normalized value of 1, modulating an additional group of M photodetectors in the plurality of photodetectors respectively based on M bias values in the M-by-1 bias matrix, and accumulating a respective bias result by each of the additional group of M photodetectors by detecting the at least one modulated optical signal, the respective bias result corresponding to a multiplication of the value of 1 and a corresponding bias value of the M bias values. Each of the M electrical outputs is based on the sum of N respective results from the N groups of M photodetectors and the respective bias result from an additional photodetector in the additional group of M photodetectors modulated during the additional time period. The electrical output corresponds to an element of the computation result

$$α ( {\sum }_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, b(i) represents a bias value in the M-by-1 bias matrix, where i is an integer in a range from 1 to M, and j is an integer in a range from 1 to N.

In some implementations, during each of the N time periods, a corresponding group of the N groups of M photodetectors is turned on, and other groups of the N groups of M photodetectors in the plurality of photodetectors are turned off.

In some implementations, the at least one modulated optical signal includes N modulated optical signals. The plurality of photodetectors include N groups of M photodetectors. The process 1730 can include: generating the N modulated optical signals each having an optical intensity representing a respective input element in the N-by-1 input matrix; for each of the N modulated optical signals corresponding to the respective element, directing the modulated optical signal to a respective group of the N groups of M photodetectors, modulating the respective group of M photodetectors based on a corresponding group of M weight elements in the M-by-N weight matrix corresponding to the respective input element, and generating a respective result by each of the respective group M photodetectors detecting the modulated optical signal, the respective result corresponding to a multiplication of the respective input element and a corresponding weight element of the corresponding group of M weights; and generating M electrical outputs by the control circuitry, where each of the M electrical outputs is based on a sum of N respective results from the N groups of M photodetectors.

In some implementations, the mathematical function further includes an M-by-1 bias matrix, and the respective intensity corresponds to a normalized value in a range from 0 to 1, and where the plurality of photodetectors further include an additional group of M photodetectors. The at least one modulated optical signal includes an additional modulated optical signal different from the N modulated optical signals. The process 1730 can further include: generating the additional modulated optical signal having an optical intensity corresponding to a normalized value of 1, modulating the additional group of M photodetectors in the plurality of photodetectors array respectively based on M bias values in the M-by-1 bias matrix, and generating a respective bias result by each of the additional group of M photodetectors detecting the additional modulated optical signal, the respective bias result corresponding to a multiplication of the value of 1 and a corresponding bias value of the M bias values. Each of the electrical outputs can be generated based on the sum of the N respective results from the group of N photodetectors and the respective bias result from a corresponding additional photodetector in the additional group of M photodetectors. The electrical output corresponds to an element of the computation result

$$α ( {\sum }_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, where i is an integer in a range from 1 to M, and j is an integer in a range from 1 to N.

In some implementations, each of the N modulated optical signals has a respective wavelength, at least two of respective wavelengths of the N modulated optical signals being different. In some implementations, each of the N modulated optical signals has a same wavelength.

In some implementations, e.g., as shown in FIG. 9, the at least one modulated optical signal includes a first modulated optical signal and a second modulated optical signal, and the plurality of photodetectors include balanced photodetectors (e.g., the balanced photodetectors 912 of FIG. 9) each including a pair of photodetectors electrically coupled with balanced connections. The process 1730 includes: directing the first modulated optical signal to generate first illumination dots respectively on first photodetectors of the balanced photodetectors, and directing the second modulated optical signal to generate second illumination dots on second photodetectors of the balanced photodetectors. A first illumination dot of the first illumination dots on a first photodetector of a corresponding balanced photodetector represents a positive modulated optical signal, and a second illumination dot of the second illumination dots on a second photodetector of the corresponding balanced photodetector represents a negative modulated optical signal, and where the corresponding balanced photodetector generates a corresponding output based on the positive modulated optical signal and the negative modulated optical signal.

In some implementations, the positive modulated optical signal has a first intensity based on first input information from the control circuitry, and the negative modulated optical signal has a second intensity based on second input information from the control circuitry, and where the first input information and the second input information are determined based on input information associated with an input element of the input matrix. The balanced photodetector is modulated based on weight information of a weight element in the weight matrix corresponding to the input element, and the corresponding output corresponds to a multiplication of the input element and the weight element.

In some implementations, the first intensity corresponds to a first normalized value in a range from 0 to 1, the second intensity corresponds to a second normalized value in the range from 0 to 1, and a difference between the first intensity and the second intensity corresponds to a normalized value in a range from −1 to 1. In some implementations, the first modulated optical signal and the second modulated optical signal are directed by at least one optical dot projector to respectively generate the first illumination dots and the second illumination dots.

In some implementations, a photodetector of the plurality of photodetector includes a multi-tap photodetector, e.g., the multi-tap photodetector 1000 of FIG. 10. The multi-tap photodetector includes a silicon (Si)-based photodetector or a germanium (Ge)-based photodetector. The multi-tap photodetector can include one or more transistors as one or more corresponding taps.

In some implementations, e.g., as shown in FIG. 10, the multi-tap photodetector includes a first tap having a first control terminal and a first output terminal, a second tap having a second control terminal and a second output terminal. The control circuitry is coupled to the multi-tap photodetector and configured to generate an electrical output based on a difference of a first output from the first output terminal of the first tap and a second output from the second output terminal of the second tap.

In some implementations, the first tap and the second tap of the multi-tap photodetector are configured to control flows of photocarriers generated by the multi-tap photodetector. The process 1730 can include: generating the first output by controlling the first tap of the multi-tap photodetector to guide, based on a first demodulation contrast, a first portion of the photocarriers to the first output terminal, and generating the second output by controlling the second tap of the multi-tap photodetector to guide, based on a second demodulation contrast, a second portion of the photocarriers to the second output terminal.

In some implementations, e.g., as shown in FIG. 12A, the process 1730 includes: performing a complementary measurement during a time period using the multi-tap photodetector. Performing the complementary measurement includes: during a first sub-time period of the time period, modulating an input optical signal to have a first intensity such that when detected, first photocarriers corresponding to a first normalized photocurrent response R in a range from 0 to 1 are generated, modulating the first control terminal of the first tap with a first control signal corresponding to a first normalized demodulation contrast C_{D} in a range from 0 to 1, modulating the second control terminal of the second tap with a second control signal corresponding to a second normalized demodulation contrast (1−C_{D}), and generating a first measurement output based on a first difference between the first output from the first output terminal of the first tap and the second output from the second output terminal of the second tap; during a second sub-time period of the time period, modulating the input optical signal to have a second intensity such that when detected, second photocarriers corresponding to a second normalized photocurrent response (1−R) are generated, modulating the first control terminal of the first tap with the second control signal corresponding to the second normalized demodulation contrast (1−C_{D}), modulating the second control terminal of the second tap with the first control signal corresponding to the first normalized demodulation contrast C_{D}, and generating a second measurement output based on a second difference between the first output from the first output terminal of the first tap and the second output from the second output terminal of the second tap. The first sub-time period and the second sub-time period are adjacent in the time period.

The process 1730 can further include: generating, by the control circuitry, the electrical output based on a sum of the first measurement output from the first sub-time period and the second measurement output from the second sub-time period, the electrical output representing a multiplication of a particular weight element of the weight matrix and a particular input element of the input matrix, where the particular weight is in a normalized weight range from −1 to 1, and the particular input element is in a normalized input range from −1 to 1. The first intensity and the second intensity are determined based on the particular input element of the input matrix, and the first control signal and the second control signal are determined based on the particular weight of the weight matrix.

In some implementations, e.g., as shown in FIG. 12B, the first measurement output and the second measurement output each includes dark current information representing dark currents associated with the multi-tap photodetector, and where the sum of the first measurement output and the second measurement output includes no such dark current information.

In some implementations, e.g., as shown in FIG. 11A, the first control terminal is modulated by a first voltage during the first sub-time period and a second voltage during the second sub-time period, and the second control terminal is modulated by the second voltage during the first sub-time period and the first voltage during the second sub-time period.

In some implementations, e.g., as shown in FIG. 11B, the first control signal and the second control signal have a peak amplitude that is equal with a phase difference of “pi”. While the input optical signal is modulated to have the first intensity during the first sub-time period, the first control signal has the peak amplitude during a first portion of the first sub-time period, and the second control signal has the peak amplitude during a second portion of the first sub-time period, and while the input optical signal is modulated to have the second intensity during the second sub-time period, the second control signal has the peak amplitude during the first portion of the second sub-time period, and the first control signal has the peak amplitude during the second portion of the second sub-time period.

In some implementations, the process 1730 includes: performing a symmetric measurement using the multi-tap photodetector by: performing a first complementary measurement during a first time period to generate a first result, performing a second complementary measurement during a second time period to generate a second result, and generating the electrical output based on a difference of the first result and the second result.

In some implementations, e.g., as shown in FIG. 13A, performing the first complementary measurement includes: during a first sub-time period of the first time period, modulating an input optical signal to have a first intensity such that when detected, first photocarriers corresponding to a first normalized photocurrent response R in a range from 0 to 1 are generated, modulating the first control terminal of the first tap with a first control signal corresponding to a first normalized demodulation contrast C_{D}′ in a range from 0 to 1, modulating the second control terminal of the second tap with a second control signal corresponding to a second normalized demodulation contrast (1−C_{D}′), and generating a first measurement output based on a first difference between the first output from the first output terminal of the first tap and the second output from the second output terminal of the second tap; during a second sub-time period of the first time period, modulating the input optical signal to have a second intensity such that when detected, second photocarriers corresponding to a second normalized photocurrent response (1−R) are generated, modulating the first control terminal of the first tap with a third control signal corresponding to a third normalized demodulation contrast (1−C_{D}″) in the range from 0 to 1, modulating the second control terminal of the second tap with a fourth control signal corresponding to a fourth normalized demodulation contrast C_{D}″, and generating a second measurement output based on a second difference between the first output from the first output terminal of the first tap and the second output from the second output terminal of the second tap. Performing the second complimentary measurement includes: during a first sub-time period of the second time period, modulating the input optical signal to have a third intensity such that when detected, third photocarriers corresponding to the first normalized photocurrent response R are generated, modulating the first control terminal of the first tap with the third control signal corresponding to the third normalized demodulation contrast (1−C_{D}″), modulating the second control terminal of the second tap with the fourth control signal corresponding to the fourth normalized demodulation contrast C_{D}″, and generating a third measurement output based on a third difference between the first output from the first output terminal of the first tap and the second output from the second output terminal of the second tap; during a second sub-time period of the second time period, modulating the input optical signal to have a fourth intensity corresponding to the second normalized photocurrent response (1−R), modulating the first control terminal of the first tap with the first control signal corresponding to the first normalized demodulation contrast C_{D}′, modulating second control terminal of the second tap with the second control signal corresponding to the second normalized demodulation contrast (1−C_{D}′), and generating a fourth measurement output based on a fourth difference between the first output from the first output terminal of the first tap and the second output from the second output terminal of the second tap; and generating, by the control circuitry, the electrical output based on the first measurement output, the second measurement output, the third measurement output, and the fourth measurement output. The first intensity, the second intensity, the third intensity, and the fourth intensity are determined based on a particular input element of the input matrix, and the first control signal, the second control signal, the third control signal, and the fourth control signal are determined based on a particular weight of the weight matrix.

In some implementations, e.g., as shown in FIG. 13B, the first measurement output, the second measurement output, the third measurement output, and the fourth measurement output each includes dark current information representing dark currents associated with the multi-tap photodetector, and a difference between a first sum of the first measurement output and the second measurement output for the first complementary measurement and a second sum of the third measurement output and the fourth measurement output for the second complementary measurement includes no such dark current information.

In some implementations, e.g., as shown in FIGS. 10, 11A, 11B, the first output terminal is coupled to a first capacitor, and the first output from the first output terminal of the first tap corresponds to first electrical charges stored in the first capacitor, and the second output terminal is coupled to a second capacitor, and the second output from the second output terminal of the second tap corresponds to second electrical charges stored in the second capacitor.

In some implementations, e.g., as shown in FIGS. 16A, 16B, a particular modulated optical signal of the at least one modulated optical signal is directed to a group of M photodetectors of the plurality of photodetectors. The particular modulated optical signal has an intensity associated with a particular input element of an input matrix of a mathematical function, the input matrix including an N-by-1 input matrix. The group of M photodetectors is modulated respectively with a group of M weight elements in a weight matrix corresponding to the particular input element, the weight matrix including an M-by-N weight matrix. A result by the group of M photodetectors detecting the particular modulated optical signal is generated, and the result corresponds to a multiplication of the particular input element and the group of M weights.

In some implementations, e.g., as shown in FIG. 16A, the at least one modulated optical signal includes N modulated optical signals, and the plurality of photodetectors includes N groups of M photodetectors. The process 1730 can include: directing each of the N modulated optical signals to a respective group of M photodetectors, where the modulated optical signal has a respective intensity associated with a respective input element of N input elements in the input matrix; modulating the N groups of M photodetectors with corresponding N groups of M weights in the M-by-N weight matrix; and generating a respective result by each of the respective group of M photodetectors detecting the respective modulated optical signal, the respective result corresponding to a multiplication of the respective input element and the respective group of M weights. Each of the electrical outputs represents a sum of N respective results from N photodetectors of the N groups, where each of the N respective results represents a multiplication of a corresponding input element in the N-by-1 input matrix by a corresponding weight element in the M-by-N weight matrix.

In some implementations, the mathematical function further includes an M-by-1 bias matrix, and the respective intensity corresponds to a normalized value in a range from 0 to 1. The at least one modulated optical signal includes an additional modulated optical signal different from the N modulated optical signals, and the plurality of photodetectors further includes an additional group of M photodetectors. The process 1730 can further include: generating the additional modulated optical signal with an intensity corresponding to a normalized value of 1, directing the additional modulated optical signal to the additional group of M photodetectors, modulating the additional group of M photodetectors based on M bias values in the M-by-1 bias matrix, and generating a respective bias result by each of M photodetectors in the additional group detecting the additional modulated optical signal, the respective bias results corresponding to a multiplication of the value of 1 and the M bias values. Each of the electrical outputs represents the sum of the N respective results from the N photodetectors of the N groups and the respective bias result from a corresponding photodetector in the additional group. The electrical output can correspond to an element of the computation result

$$α ( {\sum }_{j = 1}^{N} {W}_{i} ( j ) I ( j ) + {b}_{i} ) ,$$

where α represents the activation function, Wᵢ(j) represents a weight element Wᵢⱼ in the M-by-N weight matrix, I(j) represents the jth input element in the N-by-1 input matrix, bᵢ represents the ith bias element in the M-by-1 bias matrix, here i is an integer in a range from 1 to M, and j is an integer in a range from 1 to N.

In some implementations, each of the N modulated optical signals has a respective wavelength, at least two of respective wavelengths of the N modulated optical signals being different. In some implementations, each of the N modulated optical signals has a same wavelength.

In some implementations, the process 1730 further includes: generating each of the N modulated optical signals by at least one of modulating a respective optical source of a plurality of optical sources based on the respective input element of the input matrix or modulating an input optical signal based on the respective input element of the input matrix by a respective optical modulator.

In some implementations, the process 1730 includes: directing, in parallel, the N modulated optical signals respectively to the N groups of M photodetectors, e.g., as shown in FIG. 16A.

In some implementations, directing each of the N modulated optical signals to the respective group of M photodetectors includes: directing, by at least one optical element, the modulated optical signal to illuminate the respective group of M photodetectors. The at least one optical element can include at least one of an optical diffuser, an optical dot projector, an elliptical/circular lens, or a microlens array, and the plurality of photodetectors include a microlens array.

In some implementations, e.g., as shown in FIG. 16B, the plurality of photodetectors includes M groups of N photodetectors, each group of N photodetectors being arranged together in a respective area. The at least one modulated optical signal includes N modulated optical signals each representing respective input elements of the input matrix. The process 1730 can include: directing the N modulated optical signals to each group of N photodetectors, the group of N photodetectors being modulated based on a corresponding group of N weights in the M×N weight matrix, where each of the N modulated optical signals is associated with a respective input element of N elements in the input matrix and directed to a corresponding photodetector in the group of N photodetectors, and where the corresponding photodetector is modulated based on a weight element corresponding to the respective input element in the corresponding group of N weights; generating a respective result by the corresponding photodetector in the group of N photodetectors, the respective result corresponding to a multiplication of the respective element and the weight corresponding to the respective element in the group of N weights; and generating a respective electrical output by the control circuitry based on a sum of N respective results from the group of N photodetectors.

In some implementations, the mathematical function further includes an M-by-1 bias matrix, and the respective intensity corresponds to a normalized value in a range from 0 to 1, and the at least one modulated optical signal includes an additional modulated optical signal different from the N modulated optical signals. The method can further include: generating an additional modulated optical signal with an intensity corresponding to a normalized value of 1, modulating an additional photodetector in the plurality of photodetectors array based on a respective bias value corresponding to the group of N weights in the M-by-1 bias matrix, and generating a respective bias result by the additional photodetector detecting the additional modulated optical signal, the bias result corresponding to a multiplication of the value of 1 and the respective bias value. The respective electrical output is generated based on the sum of the N respective results from the group of N photodetectors and the respective bias result from the additional photodetector, and where the group of N photodetectors and the additional photodetector are arranged in a same area. The respective electrical output corresponds to an element of the computation result

$$α ( {\sum }_{j = 1}^{N} {W}_{i} ( j ) I ( j ) + {b}_{i} ) ,$$

where α represents the activation function of the mathematical function, Wᵢ(j) represents a weight element Wᵢⱼ in the M-by-N weight matrix, I(j) represents a jth element in the N-by-1 input matrix, where i is an integer in a range from 1 to M, and j is an integer in a range from 1 to N.

In some implementations, directing the N modulated optical signals to each group of N photodetectors includes: sequentially directing, by an optical element, the N modulated optical signals to each group of N photodetectors.

In some implementations, directing the N modulated optical signals to each group of N photodetectors includes: directing, by at least one optical element, each of the N modulated optical signals to a respective photodetector of each group of N photodetectors. The at least one optical element can include at least one of an optical diffuser, an optical dot projector, an elliptical/circular lens, or a microlens array, and the plurality of photodetectors include a microlens array.

In some implementations, the process 1730 further includes: generating each of the N modulated optical signals by at least one of modulating a respective optical source of a plurality of optical sources based on the respective input element of the N input elements in the input matrix, or modulating an input optical signal based on the respective input element of the N input elements in the input matrix by a respective optical modulator of a plurality of optical modulators.

In some implementations, each of the N modulated optical signals has a respective wavelength, at least two of respective wavelengths of the N modulated optical signals being different. In some implementations, each of the N modulated optical signals has a same wavelength.

In some implementations, e.g., as shown in FIGS. 14A and 14B, the at least one modulated optical signal represents one or more input elements of an input matrix of a mathematical function, and the plurality of photodetectors are modulated based on weight elements of the weight matrix of the mathematical function. The control circuitry includes a digital-to-analog converter (DAC) circuit (e.g., the DAC circuit 1412 of FIG. 14A or 14B) having an output electrically coupled to a plurality of devices including one of (i) a plurality of optical sources, (ii) a plurality of optical modulators, or (iii) a subset of the plurality of photodetectors. The output provides a modulation signal configured to modulate the plurality of devices, and where the modulation signal represents (i) a particular input element of the input matrix or (ii) a particular weight element of the weight matrix.

In some implementations, the modulation signal represents the particular weight element of the weight matrix. The output of the DAC circuit is electrically coupled to the subset of the plurality of photodetectors. An input element in the input matrix includes multiple values, and a number of the subset of the plurality of photodetectors correspond to a number of the multiple values in the input element. The process 1730 can include: modulating multiple optical sources or optical modulators respectively with first electrical signals from the control circuitry to generate multiple modulated optical signals, where each of the multiple modulated optical signals represents a respective value of the multiple values of the particular input element in the input matrix, e.g., as shown in FIG. 14A; directing the multiple modulated optical signals respectively to the subset of the plurality of photodetectors, each of the subset of the plurality of photodetectors being modulated by the modulation signal; and generating outputs by the subset of the plurality of photodetectors, an output from each photodetector of the multiple photodetectors corresponding to a multiplication of the particular weight element in the weight matrix and the respective value of the input element.

In some implementations, the control circuitry includes an analog-to-digital converter (ADC) circuit (e.g., the ADC circuit 1414 of FIG. 14A or 14B). The process 1730 can include: converting, by the ADC circuit, the outputs from the subset of the plurality of photodetectors into corresponding digital values; and generating, by the control circuitry, a digital result corresponding to a multiplication of the input matrix and the weight matrix.

In some implementations, the plurality of photodetectors includes multiple photodetector arrays (e.g., the photodetector arrays 1416 of FIG. 14A), and the output of the DAC circuit is electrically coupled to each of the multiple photodetector arrays.

In some implementations, the multiple optical sources or the multiple optical modulators are formed on separate substrates. In some implementations, the multiple optical sources or multiple optical modulators, the plurality of photodetectors, the control circuitry, one or more processing units (e.g., 1406 of FIG. 14A), and one or more memory unit (e.g., 1404 of FIG. 14A) are integrated on an interposer (e.g., the interposer 1402 of FIG. 14A).

In some implementations, e.g., as shown in FIG. 14B, the modulation signal represents the particular input element of the input matrix, and the output of the DAC circuit is electrically coupled to the plurality of optical sources or the plurality of optical modulators. The process 1730 can include: modulating the plurality of optical sources or the plurality of optical modulators with the modulation signal from the control circuitry to generate multiple modulated optical signals each representing the particular input element of the input matrix; directing the multiple modulated optical signals respectively to the subset of photodetectors of the plurality of photodetectors, each of the subset of photodetectors being modulated based on a respective weight element in the weight matrix corresponding to the particular input element in the input matrix; and generating outputs by the subset of photodetectors, the outputs from the subset of photodetectors corresponding to a multiplication of the particular input element and the weight elements associated with the particular input element.

In some implementations, the process 1730 includes: generating, by the DAC circuit at the output, the modulation signal based on a digital value corresponding to the particular input element of the input matrix.

In some implementations, the control circuitry includes an analog-to-digital converter (ADC) circuit, and the process 1730 includes: converting, by the ADC circuit, the outputs from the subset of the plurality of photodetectors into corresponding digital values; and generating, by the control circuitry, a digital result corresponding to a multiplication of the input matrix and the weight matrix.

In some implementations, directing the multiple modulated optical signals respectively to the subset of the plurality of photodetectors includes: directing, by at least one optical element, the multiple modulated optical signals respectively to the subset of the plurality of photodetectors. The at least one optical element includes an optical diffuser, an optical dot projector, an elliptical/circular lens, or a microlens array, and the subset of the plurality of photodetectors include a microlens array.

In some implementations, the plurality of photodetectors form a photodetector array, and the subset of the plurality of photodetectors are formed in a same area of the photodetector array. In some implementations, each of the multiple optical sources or the multiple optical modulators is formed on a same substrate. In some implementations, the multiple optical sources or multiple optical modulators, the plurality of photodetectors, the control circuitry, one or more processors, one or more memory devices are integrated on an interposer, e.g., the interposer 1402 of FIG. 14B.

FIG. 17C is a flowchart of an example process 1750 for photonic computing, particularly using a binary DAC scheme. The process 1750 can be performed by any suitable photonic computing system implemented in the present disclosure, e.g., the photonic system 200 of FIGS. 2A-2B, the photonic system 300 of FIGS. 3A-3B, the photonic computing system 700 of FIG. 7, the photonic computing system 800 of FIG. 8, the photonic computing system 900 of FIG. 9, the photonic computing system 1400 of FIG. 14A or 1450 of FIG. 14B, or the photonic computing system 1600 of FIG. 16A or 1650 of FIG. 16B.

At 1752, at least one optical source or optical modulator is modulated with at least one first electrical signal from a control circuitry to generate at least one modulated optical signal based on an input element in an input matrix of a mathematical function. The control circuitry can be same as or similar to the control circuitry 204 of FIGS. 2A-2B, the control circuitry 304 of FIGS. 3A-3B, the control circuitry 404 of FIG. 4A, the control circuitry 504 of FIG. 5A or 5B, the control circuitry 704 of FIG. 7, the control circuitry 804 of FIG. 8, the control circuitry 904 of FIG. 9, the control circuitry 1411 of FIG. 14A or 14B, or the control circuitry 1604 of FIG. 16A or 1654 of FIG. 16B. At 1754, the at least one modulated optical signal is detected by at least one photodetector of a plurality of photodetectors based on second electrical signals from the control circuitry. The second electrical signals are based on a same weight element in a weight matrix of the mathematical function. The weight element corresponds to the input element. Each of the second electrical signals is associated with a respective digit of a multi-digit weight value that represents the weight element in the weight matrix. At 1756, electrical outputs are generated based on outputs of the plurality of photodetectors using the control circuitry. The electrical outputs represent a computation result of the mathematical function corresponding to a multiplication of the input matrix and the weight matrix.

In some implementations, detecting the at least one modulated optical signal by the at least one photodetector of the plurality of photodetectors based on the second electrical signals includes: modulating the at least one photodetector based on the second electrical signals.

In some implementations, e.g., as shown in FIG. 15, the multi-digit weight value is a binary number, and each of the second electrical signals represents a respective digit value of the binary number.

In some implementations, the at least one optical source or optical modulator includes multiple optical sources or multiple optical modulators, the at least one modulated optical signal includes multiple modulated optical signals, and the at least one photodetector includes multiple photodetectors. The process 1750 can further include: directing each of the multiple modulated optical signals associated with a corresponding digit value of the binary number to a respective group of one or more photodetectors of the multiple photodetectors, the respective group of one or more photodetectors being modulated based on the corresponding digit value, and generating a respective output by the respective group of one or more photodetectors detecting the modulated optical signal; and generating a sum based on the outputs of the groups of one or more photodetectors of the multiple photodetectors, the sum corresponding to a multiplication of the input element in the input matrix and the weight element in the weight matrix.

In some implementations, each group of one or more photodetectors of the multiple photodetectors are associated with a power-factor of a binary number. The groups of one or more photodetectors of the multiple photodetectors have one or more properties that are different from one another. The one or more properties can include at least one of an optical fill factor, a number of photodetectors, a number of activated photodetectors, a bias associated with a photodetector gain, or a number of activated gate circuitry that control a flow of outputs from the one or more photodetectors.

In some implementations, the plurality of photodetectors include multiple photodetector arrays, and each group of one or more photodetectors of the multiple photodetectors are in a same photodetector array or in different photodetector arrays.

In some implementations, the binary number includes multiple digit values associated with multiple power-factors. Modulating the at least one optical source or optical modulator with the at least one first electrical signal can include: during each of multiple time periods, modulating the at least one optical source or optical modulator with the at least one first electrical signal to generate the at least one modulated optical signal based on (i) the input element and (ii) a respective digit value of the multiple digit values.

In some implementations, the multi-digit weight value is provided by a digital-to-analog converter (DAC) circuitry, e.g., the DAC circuit 1412 of FIG. 14A or 14B.

The detailed description of various example embodiments herein makes reference to the accompanying drawings and pictures, which show various example embodiments by way of illustration. While these various example embodiments are described in sufficient detail to enable those skilled in the art to practice the disclosure, it should be understood that other example embodiments may be realized and that logical, optical, and mechanical changes may be made without departing from the spirit and scope of the disclosure. Thus, the detailed description herein is presented for purposes of illustration only and not of limitation. For example, the steps recited in any of the method or process descriptions may be executed in any suitable order and are not limited to the order presented unless explicitly so stated. Moreover, any of the functions or steps may be outsourced to or performed by one or more third parties. Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps.

As used in the present disclosure, “each” refers to each member of a set or each member of a subset of a set. Furthermore, any reference to singular includes plural example embodiments, and any reference to more than one component may include a singular example embodiment. Although specific advantages have been enumerated herein, various example embodiments may include some, none, or all of the enumerated advantages.

As used herein and not otherwise defined, the terms “substantially” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

As used in the present disclosure, where a phrase similar to ‘at least one of A, B, and C’ or ‘at least one of A, B, or C’ is used in the claims or specification, it is intended that the phrase be interpreted to mean that A alone may be present in an example embodiment, B alone may be present in an example embodiment, C alone may be present in an example embodiment, or that any combination of the elements A, B and C may be present in a single example embodiment; for example, A and B, A and C, B and C, or A and B and C.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices, and magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

A number of implementations have been described. Nevertheless, it will be understood that various modifications may be made without departing from the spirit and scope of the techniques and devices described herein. For example, phase perturbation or variation methods discussed above may be implemented in diffractive structures to remove high frequency artifacts or medium frequency artifacts in interference patterns. Features shown in each of the implementations may be used independently or in combination with one another. Additional features and variations may be included in the implementations as well. Accordingly, other implementations are within the scope of the following claims.

What is claimed is:

1. A photonic system, comprising:
a plurality of photodetectors; and
a control circuitry coupled to the plurality of photodetectors,
wherein the plurality of photodetectors are configured to detect at least one modulated optical signal, the at least one modulated optical signal representing one or more input elements of an input matrix of a mathematical function, the plurality of photodetectors being configured to be modulated based on weight elements of a weight matrix of the mathematical function,
wherein the control circuitry is configured to generate electrical outputs based on outputs of the plurality of photodetectors, the electrical outputs representing a computation result of the mathematical function corresponding to a multiplication of the input matrix and the weight matrix, and
wherein the control circuitry comprises a digital-to-analog converter (DAC) circuit having a DAC output electrically coupled to a plurality of devices including one of (i) a plurality of optical sources, (ii) a plurality of optical modulators, or (iii) a subset of the plurality of photodetectors, wherein the DAC output provides a modulation signal configured to modulate the plurality of devices, and wherein the modulation signal represents (i) a particular input element of the input matrix or (ii) a particular weight element of the weight matrix.

2. The photonic system of claim 1, wherein the modulation signal represents the particular weight element of the weight matrix, wherein the DAC output is electrically coupled to the subset of the plurality of photodetectors, wherein an input element in the input matrix comprises multiple values, and wherein a number of the subset of the plurality of photodetectors correspond to a number of the multiple values in the input element, and
wherein the photonic system further comprises:
multiple optical sources or optical modulators configured to be modulated respectively with first electrical signals from the control circuitry to generate multiple modulated optical signals, wherein each of the multiple modulated optical signals represents a respective value of the multiple values of the particular input element in the input matrix, and
at least one optical element configured to direct the multiple modulated optical signals respectively to the subset of the plurality of photodetectors, each of the subset of the plurality of photodetectors being modulated by the modulation signal,
wherein the subset of the plurality of photodetectors is configured to generate outputs each corresponding to a multiplication of the particular weight element in the weight matrix and the respective value of the input element.

3. The photonic system of claim 2, wherein the control circuitry comprises an analog-to-digital converter (ADC) circuit configured to convert the outputs from the subset of the plurality of photodetectors into corresponding digital values, and
wherein the control circuitry is configured to generate a digital result corresponding to a multiplication of the input matrix and the weight matrix.

4. The photonic system of claim 2, wherein each of the multiple optical sources or the multiple optical modulators is formed on a same substrate.

5. The photonic system of claim 2, wherein the multiple optical sources or multiple optical modulators, the plurality of photodetectors, the control circuitry, one or more processors, one or more memory devices are integrated on an interposer.

6. The photonic system of claim 1, wherein the plurality of photodetectors comprises multiple photodetector arrays, and
wherein the DAC output is electrically coupled to each of the multiple photodetector arrays.

7. The photonic system of claim 1, wherein the plurality of optical sources or the plurality of optical modulators are formed on separate substrates.

8. The photonic system of claim 1, wherein the plurality of optical sources or plurality of optical modulators, the plurality of photodetectors, the control circuitry, one or more processing units, and one or more memory units are integrated on an interposer.

9. The photonic system of claim 1, wherein the modulation signal represents the particular input element of the input matrix, wherein the DAC output is electrically coupled to the plurality of optical sources or the plurality of optical modulators, and
wherein the photonic system is configured to perform operations comprising:
modulating the plurality of optical sources or the plurality of optical modulators with the modulation signal from the control circuitry to generate multiple modulated optical signals each representing the particular input element of the input matrix;
directing the multiple modulated optical signals respectively to the subset of photodetectors of the plurality of photodetectors, each of the subset of photodetectors being modulated based on a respective weight element in the weight matrix corresponding to the particular input element in the input matrix; and
generating outputs by the subset of photodetectors, the outputs from the subset of photodetectors corresponding to a multiplication of the particular input element and the weight elements associated with the particular input element.

10. The photonic system of claim 9, wherein the DAC circuit is configured to generate, at the DAC output, the modulation signal based on a digital value corresponding to the particular input element of the input matrix.

11. The photonic system of claim 9, wherein the control circuitry comprises an analog-to-digital converter (ADC) circuit configured to convert the outputs from the subset of the plurality of photodetectors into corresponding digital values, and the control circuitry is configured to generate a digital result corresponding to a multiplication of the input matrix and the weight matrix.

12. The photonic system of claim 9, further comprising
at least one optical element configured to direct the multiple modulated optical signals respectively to the subset of the plurality of photodetectors, wherein the at least one optical element comprises an optical dot projector or an optical diffuser, and the subset of the plurality of photodetectors comprise a microlens array.

13. The photonic system of claim 9, wherein the plurality of photodetectors form a photodetector array, and
wherein the subset of the plurality of photodetectors are formed in a same area of the photodetector array.

14. A method for performing computations using a photonic system, the method comprising:
providing, by a first output of a digital-to-analog converter (DAC) circuitry to a plurality of photodetectors, first input electrical signals representing a first weight value of a weight matrix of a mathematic function;
providing, by a plurality of outputs of the DAC circuitry to a plurality of optical emitters, second input electrical signals representing input elements of an input matrix of the mathematical function;
generating, by the plurality of optical emitters and based on the second input electrical signals, optical signals towards the plurality of photodetectors to perform matrix computations;
generating, by the plurality of photodetectors in response to receiving the optical signals, output electrical signals representing results of the matrix computations; and
providing, by the plurality of photodetectors to an analog-to-digital converter (ADC) circuitry, the output electrical signals.

15. The method of claim 14, wherein each of the plurality of photodetectors is formed in a different pixel array.

16. The method of claim 14, wherein each of the plurality of optical emitters is formed on a different substrate.

17. The method of claim 14, wherein the plurality of photodetectors are formed in a pixel array.

18. The method of claim 14, wherein the plurality of photodetectors, the plurality of optical emitters, the DAC circuitry, the ADC circuitry, one or more processors, and one or more memory elements are formed on an interposer.

19. A method for performing computations using a photonic system, the method comprising:
providing, by a first output of a digital-to-analog converter (DAC) circuitry to a plurality of optical emitters, first input electrical signals representing a first input value of an input matrix of a mathematic function;
providing, by a plurality of outputs of the DAC circuitry to a plurality of photodetectors, second input electrical signals representing weight elements of a weight matrix of the mathematical function;
generating, by the plurality of optical emitters and based on the first input electrical signals, optical signals towards the plurality of photodetectors to perform matrix computations;
generating, by the plurality of photodetectors in response to receiving the optical signals, output electrical signals representing results of the matrix computations; and
providing, by the plurality of photodetectors to an analog-to-digital converter (ADC) circuitry, the output electrical signals.

20. The method of claim 19, wherein the plurality of photodetectors, the plurality of optical emitters, the DAC circuitry, and the ADC circuitry are formed on an interposer.
